(19) United States
(12) Patent Application Publication
(10) Pub. No.: US 2016/0058001 A1
(43) Pub. Date: Mar. 3, 2016

(54) METHOD FOR IMPROVED UTILIZATION OF THE PRODUCTION POTENTIAL OF TRANSGENIC PLANTS

(71) Applicant: BAYER CROPSCIENCE AKTIENGESELLSCHAFT, Monheim am Rhein (DE)

(72) Inventors: Koen VAN DEN EYNDE, Beijing (CN); Wolfgang THIELERT, Odenthal (DE)

(21) Appl. No.: 14/784,047

(22) PCT Filed: Apr. 15, 2014
(86) PCT No.: PCT/EP2014/057667

§ 371 Date: Oct. 13, 2015

(30) Foreign Application Priority Data
Apr. 19, 2013 (EP) 13164466.8

(51) Int. Cl. A01N 37/34; A01N 63/02

(52) U.S. Cl. CPC A01N 37/34; A01N 63/02

(57) ABSTRACT

The invention relates to a method for improving the utilization of the production potential of transgenic plants by treating the plant with an effective amount of at least one compound of the formula (I) as described herein.

The invention relates to a method for improving the utilization of the production potential of transgenic plants and for controlling pests such as insects and/or nematodes.

In recent years, there has been a marked increase in the proportion of transgenic plants in agriculture.

Transgenic plants are employed mainly to utilize the production potential of respective plant varieties in the most favourable manner, at the lowest possible input of production means. The aim of the genetic modification of the plants is in particular the generation of resistance in the plants to certain pests or harmful organisms or else herbicides and also to abiotic stress (for example drought, heat or elevated salt levels). It is also possible to modify a plant genetically to increase certain quality or product features, such as, for example, the content of selected vitamins or oils, or to improve certain fibre properties.

Herbicide resistance or tolerance can be achieved, for example, by incorporating genes into the useful plant for expressing enzymes to detoxify certain herbicides, so that a relatively unimpeded growth of these plants is possible even in the presence of these herbicides for controlling broad-leaved weeds and weed grasses. Examples which may be mentioned are cotton varieties or maize varieties which tolerate the herbicidally active compound glyphosate (Roundup®), (Roundup Ready®, Monsanto) or the herbicides glufosinate or oxynil.

There has also been the development of useful plants comprising two or more genetic modifications (“stacked transgenic plants” or multiply transgenic crops). Thus, for example, Monsanto has developed multiply transgenic maize varieties which are resistant to the European corn borer (Ostrinia nubilalis) and the Western corn rootworm (Diabrotica virgifera). Also known are maize and cotton crops which are both resistant to the Western corn rootworm and the cotton bollworm and tolerant to the herbicide Roundup®.

It has now been found that the utilization of the production potential of transgenic useful plants can be improved even more by treating the plants with one or more compounds of the formula (I) defined below. Here, the term “treatment” includes all measures resulting in a contact between these active compounds and at least one plant part. “Plant parts” are to be understood as meaning all above-ground and below-ground parts and organs of plants, such as shoot, leaf, flower and root, by way of example leaves, needles, stalks, stems, flowers, fruit bodies, fruits and seed, and also roots, tubers and rhizomes. The plant parts also include harvested material and also vegetative and generative propagation material, for example cuttings, tubers, rhizomes, slips and seed.

### SUMMARY OF THE INVENTION

One aspect refers to a method for improving the utilization of the production potential of a transgenic plant and/or for controlling/combating/treating pests, characterized in that the plant is treated with an effective amount of at least one compound of the formula (I)

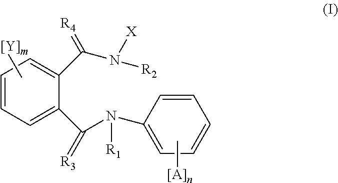

wherein
A represents individually halogen, cyano, nitro, hydroxyl, amino, C₁-C₈ alkyl group, substituted C₁-C₈ alkyl group having at least one substituent elected from the group consisting of halogen, hydroxy, cyano, nitro, amino, halo C₁-C₃ alkyl group, C₁-C₃ alkoxy group, halo C₁-C₃ alkoxy group, C₁-C₃ alkylthio group, halo C₁-C₃ alkylthio group, C₁-C₃ alkylsulfinyl group, halo C₁-C₃ alkylsulfinyl group, C₁-C₃ alkylsulfonyl group, halo C₁-C₃ alkylsulfonyl group and C₁-C₃ alkylthio, C₁-C₃ alkyl group; further, an arbitrary saturated carbon atom in said optionally substituted C₁-C₈ alkyl group;
n represents 0, 1, 2, 3 or 4, preferably 0, 1 or 2;
R₁ represents hydrogen, halogen, cyano C₁-C₈ alkyl or C₁-C₈ haloalkyl;
R₂ represents hydrogen, halogen, cyano C₁-C₈ alkyl or C₁-C₈ haloalkyl;
R₃ represents O or S;
R₄ represents O or S;
Y represents individually hydrogen, halogen, cyano, nitro, C₁-C₆ alkyl group, halo C₁-C₆ alkyl group, C₂-C₆ alkenyl group, halo C₂-C₆ alkenyl group, C₂-C₆ alkynyl group, halo C₂-C₆ alkynyl group, C₃-C₆ cycloalkyl group, halo C₃-C₆ cycloalkyl group, C₁-C₆ alkoxy group, halo C₁-C₆ alkoxy group, C₁-C₆ alkylthio group, halo C₁-C₆ alkylthio group, C₁-C₆ alkylsulfinyl group, halo C₁-C₆ alkylsulfinyl group, C₁-C₆ alkylsulfonyl group, or halo C₁-C₆ alkylsulfonyl group;
m represents 0, 1, 2, 3, or 4;
X represents a C₁-C₈ alkyl group or a substituted C₁-C₈ alkyl group having at least one substituent selected from the group consisting of halogen, hydroxy, cyano, nitro, amino, halo C₁-C₃ alkyl group, C₁-C₃ alkoxy group, halo C₁-C₃ alkoxy group

One preferred embodiment refers to the method described above, characterized in that the compound of the formula (I) is formula (I-1):

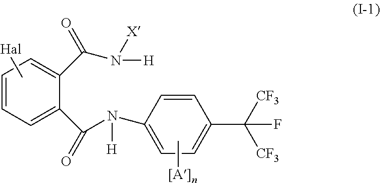

wherein
Hal represents F, Cl, I or Br; and
X′ represents C₁-C₆ alkyl or substituted C₁-C₆ alkyl having at least one substituent selected from the group consisting of halogen, hydroxy, cyano, nitro, amino, halo C₁-C₃ alkyl group, preferably a C₁-C₆ cyanoalkyl;
A′ represents C₁-C₃ alkyl, C₁-C₃ haloalkyl, halogen, preferably methyl, halomethyl, ethyl or haloethyl, more preferably methyl or ethyl;
n represents 0, 1, 2, 3 or 4, preferably 0, 1 or 2, more preferably 1.

One preferred embodiment refers to the method described above, characterized in that the compound of the formula (I) is selected from the group consisting of compound (I-2), (I-3), (I-4) or (I-5):

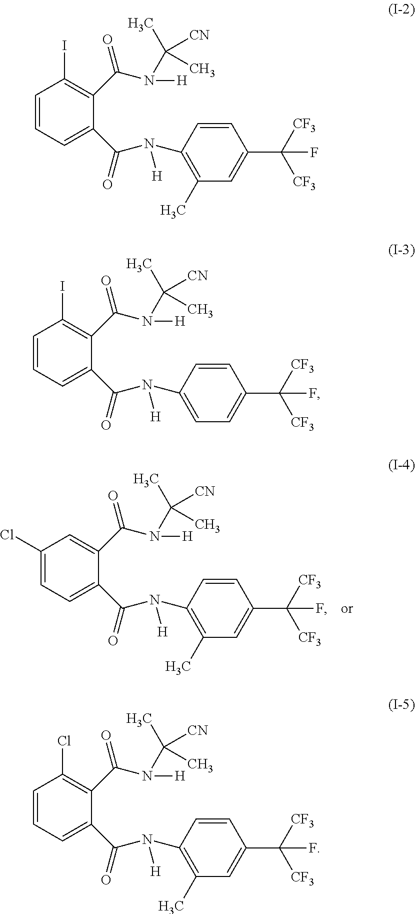 [SMILES: Cc1cc(C(F)(C(F)(F)F)C(F)(F)F)ccc1NC(=O)c1cccc(I)c1C(=O)NC(C)(C)C#N ; CC(C)(C#N)NC(=O)c1c(I)cccc1C(=O)Nc1ccc(C(F)(C(F)(F)F)C(F)(F)F)cc1 ; Cc1cc(C(F)(C(F)(F)F)C(F)(F)F)ccc1NC(=O)c1ccc(Cl)cc1C(=O)NC(C)(C)C#N ; "or" ; Cc1cc(C(F)(C(F)(F)F)C(F)(F)F)ccc1NC(=O)c1cccc(Cl)c1C(=O)NC(C)(C)C#N]

One preferred embodiment refers to the method described above, characterized in that the compound of the formula (I) is compound (I-5).

Further preferred embodiments refer to the method described above, characterized in that the plant has at least one genetically modified structure or a tolerance according to Table A or Table B or Table C.

Further preferred embodiments refer to the method described above, characterized in that the transgenic plant contains at least one cry-gene or a cry-gene fragment coding for a Bt toxin.

One preferred embodiment refers to the method described above, characterized in that the transgenic plant is a vegetable plant, maize plant, soya bean plant, cotton plant, tobacco plant, rice plant, sugar beet plant, oilseed rape plant or potato plant.

One preferred embodiment refers to the method described above, characterized in that the use form of the compound of the formula (I) is present in a mixture with at least one mixing partner.

One preferred embodiment refers to the method described above, characterized in that the Bt toxin of a Bt-plant is encoded by a bt-gene or fragment thereof comprising event MON87701.

Another aspect refers to a synergistic composition comprising a Bt toxin and a compound of formula (I) as described above.

One preferred embodiment refers to said synergistic composition, characterized in that the Bt toxin is encoded by a cry gene or a cry-gene fragment selected from the group consisting of cry1, cry2, cry3, cry5 and cry9.

One preferred embodiment refers to said synergistic composition, characterized in that the Bt toxin is encoded by a cry gene or a cry-gene fragment selected from the group consisting of especially preferred are cry1Ab, cry1Ac, cry3A, cry3B and cry9C.

One preferred embodiment refers to said synergistic composition, characterized in that the Bt toxin is encoded by a cry gene or a cry-gene fragment selected from the subgroup cry1A, preferably cry1Aa, cry1Ab, cry1Ac or a hybrid thereof (e.g., a hybrid of cry1Ac and cry1Ab).

One preferred embodiment refers to said synergistic composition, characterized in that the Bt toxin is encoded by a bt-gene or fragment thereof comprising event MON87701.

A Bt plant, preferably a Bt-soybean plant comprising event MON87701 or a Bt-soybean plant comprising event MON87701 and MON89788, characterized in that at least 0.00001 g of a compound of formula (I) is attached to it.

The preferred embodiments may be combined as long as such a combination would not contravene existing natural laws.

### DETAILED DESCRIPTION

Compounds of the formula (I)

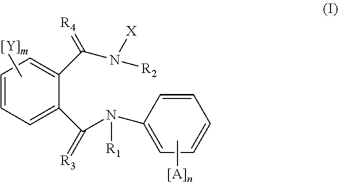

wherein
A represents individually halogen, cyano, nitro, hydroxyl, amino, C₁-C₈ alkyl group, substituted C₁-C₈ alkyl group having at least one substituent elected from the group consisting of halogen, hydroxy, cyano, nitro, amino, halo C₁-C₃ alkyl group, C₁-C₃ alkoxy group, halo C₁-C₃ alkoxy group, C₁-C₃ alkylthio group, halo C₁-C₃ alkylthio group, C₁-C₃ alkylsulfinyl group, halo C₁-C₃ alkylsulfinyl group, C₁-C₃ alkylsulfonyl group, halo C₁-C₃ alkylsulfonyl group and C₁-C₃ alkylthio, C₁-C₃ alkyl group; further, an arbitrary saturated carbon atom in said optionally substituted C₁-C₈ alkyl group;
n represents 0, 1, 2, 3 or 4, preferably 0, 1 or 2;
R₁ represents hydrogen, halogen, cyano C₁-C₈ alkyl or C₁-C₈ haloalkyl;
R₂ represents hydrogen, halogen, cyano C₁-C₈ alkyl or C₁-C₈ haloalkyl;
R₃ represents O or S;
R₄ represents O or S;
Y represents individually hydrogen, halogen, cyano, nitro, C₁-C₆ alkyl group, halo C₁-C₆ alkyl group, C₂-C₆ alkenyl group, halo C₂-C₆ alkenyl group, C₂-C₆ alkynyl group, halo C₂-C₆ alkynyl group, C₃-C₆ cycloalkyl group, halo C₃-C₆ cycloalkyl group, C₁-C₆ alkoxy group, halo C₁-C₆ alkoxy group, C₁-C₆ alkylthio group, halo C₁-C₆ alkylthio group, C₁-C₆ alkylsulfinyl group, halo C₁-C₆ alkylsulfinyl group, C₁-C₆ alkylsulfonyl group, or halo C₁-C₆ alkylsulfonyl group;
m represents 0, 1, 2, 3, or 4;
X represents a C₁-C₈ alkyl group or a substituted C₁-C₈ alkyl group having at least one substituent selected from the group consisting of halogen, hydroxy, cyano, nitro, amino, halo C₁-C₃ alkyl group, C₁-C₃ alkoxy group, halo C₁-C₃ alkoxy group
and their insecticidal action are known from the prior art (see, e.g., EP 0 919 542, W0 2004/018410, W0 2010/012442 or WO 2012/034472).

From these documents, the person skilled in the art will be familiar with processes for preparing and methods for using compounds of the formula (I) and with the action of compounds of the formula (I).

Preferred sub-groups and compounds of formula (I) mentioned above are listed below.

In a preferred embodiment of the present invention, the compounds of the general formula (I) is represented by compounds of formula (I-1):

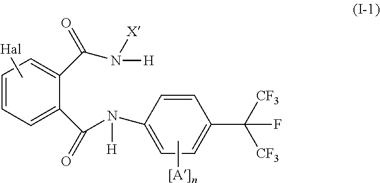

wherein
Hal represents F, Cl, I or Br; and
X′ represents C₁-C₆ alkyl or substituted C₁-C₆ alkyl having at least one substituent selected from the group consisting of halogen, hydroxy, cyano, nitro, amino, halo C₁-C₃ alkyl group, preferably a C₁-C₆ cyanoalkyl;
A′ represents C₁-C₃ alkyl, C₁-C₃ haloalkyl, halogen, preferably methyl, halomethyl, ethyl or haloethyl, more preferably methyl or ethyl;
n represents 0, 1, 2, 3 or 4, preferably 0, 1 or 2, more preferably 1.

In a more preferred embodiment of the present invention, a composition comprises at least one compound of the general formula (I) selected from the group consisting of compound (I-2), (I-3), (I-4) or (I-5):

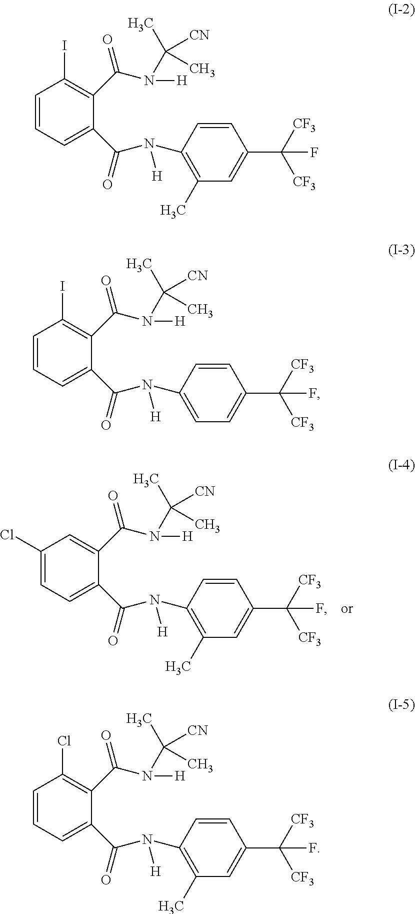

Even more preferably, a compound of formula (I) is selected from the group consisting of compound (I-2) or compound (I-5).

In one preferred embodiment, the compound of formula (I) is compound (I-5).

According to the invention, “alkyl” represents straight-chain or branched aliphatic hydrocarbons having 1 to 8, preferably 1 to 6, more preferably 1 to 3, carbon atoms. Suitable alkyl groups are, for example, methyl, ethyl, n-propyl, i-propyl, n-, iso-, sec- or tert-butyl, pentyl or hexyl. The alkyl group may be unsubstituted or is substituted by at least one of the substituents mentioned here.

According to the invention, “halogen” or “Hal” represents fluorine, chlorine, bromine or iodine, preferably fluorine, chlorine or bromine.

According to the invention, “haloalkyl” represents alkyl groups having up to 8 carbon atoms in which at least one hydrogen atom has been replaced by a halogen. Suitable haloalkyl groups are, for example, CH₂F, CHF₂, CF₃, CF₂Cl, CFCl₂, CCl₃, CF₂Br, CF₂CF₃, CFHCF₃, CH₂CF₃, CH₂CH₂F, CH₂CHF₂, CFClCF₃, CCl₂CF₃, CF₂CH₃, CF₂CH₂F, CF₂CHF₂, CF₂CF₂Cl, CF₂CF₂Br, CFHCH₃, CFHCHF₂, CHFCF₃, CHFCF₂Cl, CHFCF₂Br, CFClCF₃, CCl₂CF₃, CF₂CF₂CF₃, CH₂CH₂CH₂F, CH₂CHFCH₃, CH₂CF₂CF₃, CF₂CH₂CF₃, CF₂CF₂CH₃, CHFCF₂CF₃, CF₂CHFCF₃, CF₂CF₂CHF₂, CF₂CF₂CH₂F, CF₂CF₂CF₂Cl, CF₂CF₂CF₂Br, 1,2,2,2-tetrafluoro-1-(trifluoromethyl)ethyl, 2,2,2-trifluoro-1-(trifluoromethyl)ethyl, pentafluoroethyl, 1-(difluoromethyl)-1,2,2,2-tetrafluoroethyl, 2-bromo-1,2,2-trifluoro-1-(trifluoromethyl)ethyl, 1-(difluoromethyl)-2,2,2-trifluoroethyl. The haloalkyl group may be unsubstituted or is substituted by at least one of the substituents mentioned here.

“Production potential” as used herein refers to the yield of a transgenic plant under specific conditions. “Improving the utilization of the production potential of transgenic plants” thus refers to an increase of yield under unfavorable environmental conditions such as use of herbicides, drought stress, cold stress, stress induced by insects, nematodes, or fungus etc. compared to the yield of such plants under the same conditions without the use of the compounds of formula (I) as described herein.

The method can also be used for an increased control/an increased treatment of pests such as insects and/or nematodes. Thus, the combination of a transgenic plant such as a Bt-plant and a compound of formula (I) can show better treatment/control/combating of insects and/or nematodes compared to the expected effect.

According to the method proposed according to the invention, transgenic plants, in particular useful plants, are treated with compounds of the formula (I) to increase agricultural productivity and/or to control and/or to combat pests, especially nematodes and insects. Preferably, the invention refers to a method for combating pests by treating transgenic plants, preferably insect-resistant transgenic plant such as Bt-plants or Vip-plants with a compound of formula (I), preferably with a compound of formula (I-5).

For the purpose of the invention, genetically modified organisms (GMOs), e.g. plants or seeds, are genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology, RNA interference—RNAi—technology or microRNA—miRNA—technology). A heterologous gene that is located in the genome is also called a transgene. A transgene that is defined by its particular location in the plant genome is called a transformation or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability, increased combating of pests, especially nematodes and insects and/or processability of the harvested products are possible, which exceed the effects which were actually to be expected.

At certain application rates, the active compound combinations according to the invention may also have a strengthening effect in plants. Accordingly, they are also suitable for mobilizing the defense system of the plant against attack by unwanted microorganisms. This may, if appropriate, be one of the reasons of the enhanced activity of the combinations according to the invention, for example against fungi. Plant-strengthening (resistance-inducing) substances are to be understood as meaning, in the present context, those substances or combinations of substances which are capable of stimulating the defense system of plants in such a way that, when subsequently inoculated with unwanted microorganisms, the treated plants display a substantial degree of resistance to these microorganisms. In the present case, unwanted microorganisms are to be understood as meaning phytopathogenic fungi, bacteria and viruses. Thus, the substances according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active compounds.

Plants and plant cultivars which are preferably to be treated according to the invention include all plants which have genetic modified material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against nematodes, insects, mites, phytopathogenic fungi, bacteria, viruses and/or viroids.

Examples of nematode or insect resistant plants are described in e.g. U.S. patent application Ser. Nos. 11/765,491, 11/765,494, 10/926,819, 10/782,020, 12/032,479, 10/783,417, 10/782,096, 11/657,964, 12/192,904, 11/396,808, 12/166,253, 12/166,239, 12/166,124, 12/166,209, 11/762,886, 12/364,335, 11/763,947, 12/252,453, 12/209,354, 12/491,396, 12/497,221, 12/644,632, 12/646,004, 12/701,058, 12/718,059, 12/721,595, 12/638,591, and in WO 11/002992, WO 11/014749, WO 11/103247, WO 11/103248, WO 12/135436, WO 12/135501.

Examples of plants resistant to other types of pathogens are described in e.g. WO13/050410.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency, improved combating of insects and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Examples of plants with the above-mentioned traits are non-exhaustively listed in Table A.

TABLE A

| Event | Company | Description | Crop | Patent Ref |
|---|---|---|---|---|
| ASR36 | Scotts | Glyphosate tolerance derived by inserting a | Agrostis | US 2006- |
| 8 | Seeds | modified 5-enolpyruvylshikimate-3- | stolonifera | 162007 |
| | | phosphate synthase (EPSPS) encoding gene | Creeping | |
| | | from Agrobacterium tumefaciens, parent | Bentgrass | |
| | | line B99061 | | |
| GT200 | Monsanto | Glyphosate herbicide tolerant canola | Brassica | |
| | Company | produced by inserting genes encoding the | napus | |
| | | enzymes 5-enolypyruvylshikimate-3- | (Argentine | |
| | | phosphate synthase (EPSPS) from the CP4 | Canola) | |
| | | strain of Agrobacterium tumefaciens and | | |
| | | glyphosate oxidase from Ochrobactrum | | |
| | | anthropi. | | |
| B, Da, | Zeneca | Delayed softening tomatoes produced by | Lycopersicon | |
| F | Seeds | inserting a truncated version of the | esculentum | |
| | | polygalacturonase (PG) encoding gene in the | (Tomato) | |
| | | sense or anti-sense orientation in order to | | |
| | | reduce expression of the endogenous PG | | |
| | | gene, and thus reduce pectin degradation. | | |
| FLAVR | Calgene | Delayed softening tomatoes produced by | Lycopersicon | |
| SAVR | Inc. | inserting an additional copy of the | esculentum | |
| | | polygalacturonase (PG) encoding gene in the | (Tomato) | |
| | | anti-sense orientation in order to reduce | | |
| | | expression of the endogenous PG gene and | | |
| | | thus reduce pectin degradation. | | |
| J101, | Monsanto | Glyphosate herbicide tolerant alfalfa | Medicago | |
| J163 | Company | (lucerne) produced by inserting a gene | sativa (Alfalfa) | |
| | and Forage | encoding the enzyme 5- | | |
| | Genetics | enolypyruvylshikimate-3-phosphate | | |
| | International | synthase (EPSPS) from the CP4 strain of | | |
| | | Agrobacterium tumefaciens. | | |
| C/F/93/ | Societe | Tolerance to the herbicides bromoxynil and | Nicotiana | |
| 08-02 | National | ioxynil by incorporation of the nitrilase gene | tabacum | |
| | d'Exploitation | from Klebsiella pneumoniae. | L. (Tobacco) | |
| | des | | | |
| | Tabacs et | | | |
| | Allumettes | | | |
| Vector | Vector | Reduced nicotine content through | Nicotiana | |
| 21-41 | Tobacco | introduction of a second copy of the tobacco | tabacum | |
| | Inc. | quinolinic acid phosphoribosyltransferase | L. (Tobacco) | |
| | | (QTPase) in the antisense orientation. The | | |
| | | NPTII encoding gene from E. coli was | | |
| | | introduced as a selectable marker to identify | | |
| | | transformants. | | |
| CL121, | BASF Inc. | Tolerance to the imidazolinone herbicide, | Oryza | |
| CL141, | | imazethapyr, induced by chemical | sativa (Rice) | |
| CFX51 | | mutagenesis of the acetolactate synthase | | |
| | | (ALS) enzyme using ethyl methanesulfonate | | |
| | | (EMS). | | |
| GAT- | AVENTIS | Glufosinate tolerance; WO 01/83818 | Oryza | WO 01/83818 |
| OS2 | CROPSCIENCE | | sativa (Rice) | |
| | NV | | | |
| GAT- | BAYER | Glufosinate tolerance; US 2008-289060 | Oryza | US 2008- |
| OS3 | BIOSCIENCE | | sativa (Rice) | 289060 |
| | NV | | | |
| | [BE] | | | |
| IMINT | BASF Inc. | Tolerance to imidazolinone herbicides | Oryza | |
| A-1, | | induced by chemical mutagenesis of the | sativa (Rice) | |
| IMINT | | acetolactate synthase (ALS) enzyme using | | |
| A-4 | | sodium azide. | | |
| LLRIC | Aventis | Glufosinate ammonium herbicide tolerant | Oryza | |
| E06, | CropSience | rice produced by inserting a modified | sativa (Rice) | |
| LLRIC | | phosphinothricin acetyltransferase (PAT) | | |
| E62 | | encoding gene from the soil bacterium | | |
| | | Streptomyces hygroscopicus). | | |
| GT73, | Monsanto | Glyphosate herbicide tolerant canola | Brassica | |
| RT73 | Company | produced by inserting genes encoding the | napus | |
| | | enzymes 5-enolypyruvylshikimate-3- | (Argentine | |
| | | phosphate synthase (EPSPS) from the CP4 | Canola) | |
| | | strain of Agrobacterium tumefaciens and | | |
| | | glyphosate oxidase from Ochrobactrum | | |
| | | anthropi. | | |
| LLRIC | Bayer | Glufosinate ammonium herbicide tolerant | Oryza | |
| E601 | CropScience | rice produced by inserting a modified | sativa (Rice) | |
| | (Aventis | phosphinothricin acetyltransferase (PAT) | | |
| | CropScience | encoding gene from the soil bacterium | | |
| | (AgrEvo)) | Streptomyces hygroscopicus). | | |
| PE-7 | MAHARA | Insect resistance (Cry1Ac); WO | Oryza | WO |
| | SHTRA | 2008/114282 | sativa (Rice) | 2008/114282 |
| | HYBRID | | | |
| | SEEDS | | | |
| | COMPA | | | |
| PWC16 | BASF Inc. | Tolerance to the imidazolinone herbicide, | Oryza | |
| | | imazethapyr, induced by chemical | sativa (Rice) | |
| | | mutagenesis of the acetolactate synthase | | |
| | | (ALS) enzyme using ethyl methanesulfonate | | |
| | | (EMS). | | |
| TT51 | ZHEJIANG | Insect resistance (Cry1Ab/Cry1Ac); | Oryza | CN1840655 |
| | UNIVERSITY | CN1840655 | sativa (Rice) | |
| C5 | United | Plum pox virus (PPV) resistant plum tree | Prunus | |
| | States | produced through Agrobacterium-mediated | domestica | |
| | Department | transformation with a coat protein (CP) gene | (Plum) | |
| | of | from the virus. | | |
| | Agriculture | | | |
| | Agricultural | | | |
| | Research | | | |
| | Service | | | |
| ATBT0 | Monsanto | Colorado potato beetle resistant potatoes | Solanum | |
| 4-6, | Company | produced by inserting the cry3A gene from | tuberosum | |
| ATBT0 | | Bacillus thuringiensis (subsp. Tenebrionis). | L. (Potato) | |
| 4-27, | | | | |
| ATBT0 | | | | |
| 4-30, | | | | |
| ATBT0 | | | | |
| 4-31, | | | | |
| ATBT0 | | | | |
| 4-36, | | | | |
| SPBT0 | | | | |
| 2-5, | | | | |
| SPBT0 | | | | |
| 2-7 | | | | |
| BT6, | Monsanto | Colorado potato beetle resistant potatoes | Solanum | |
| BT10, | Company | produced by inserting the cry3A gene from | tuberosum | |
| BT12, | | Bacillus thuringiensis (subsp. Tenebrionis). | L. (Potato) | |
| BT16, | | | | |
| BT17, | | | | |
| BT18, | | | | |
| BT23 | | | | |
| RBMT | Monsanto | Colorado potato beetle and potato virus Y | Solanum | |
| 15-101, | Company | (PVY) resistant potatoes produced by | tuberosum | |
| SEMT1 | | inserting the cry3A gene from Bacillus | L. (Potato) | |
| 5-02, | | thuringiensis (subsp. Tenebrionis) and the | | |
| SEMT1 | | coat protein encoding gene from PVY. | | |
| 5-15 | | | | |
| RBMT | Monsanto | Colorado potato beetle and potato leafroll | Solanum | |
| 21-129, | Company | virus (PLRV) resistant potatoes produced by | tuberosum | |
| RBMT | | inserting the cry3A gene from Bacillus | L. (Potato) | |
| 21-350, | | thuringiensis (subsp. Tenebrionis) and the | | |
| RBMT | | replicase encoding gene from PLRV. | | |
| 22-082 | | | | |
| HCN10 | Aventis | Introduction of the PPT-acetyltransferase | Brassica | |
| | CropScience | (PAT) encoding gene from Streptomyces | napus | |
| | | viridochromogenes, an aerobic soil bacteria. | (Argentine | |
| | | PPT normally acts to inhibit glutamine | Canola) | |
| | | synthetase, causing a fatal accumulation of | | |
| | | ammonia. Acetylated PPT is inactive. | | |
| AP205 | BASF Inc. | Selection for a mutagenized version of the | Triticum | |
| CL | | enzyme acetohydroxyacid synthase (AHAS) | aestivum | |
| | | also known as acetolactate synthase (ALS) (AHAS), | (Wheat) | |
| | | or acetolactate pyruvate-lyase. | | |
| AP602 | BASF Inc. | Selection for a mutagenized version of the | Triticum | |
| CL | | enzyme acetohydroxyacid synthase (AHAS) , | aestivum | |
| | | also known as acetolactate synthase (ALS) | (Wheat) | |
| | | or acetolactate pyruvate-lyase. | | |
| BW255- | BASF Inc. | Selection for a mutagenized version of the | Triticum | |
| 2, | | enzyme acetohydroxyacid synthase (AHAS), | aestivum | |
| BW238- | | also known as acetolactate synthase (ALS) | (Wheat) | |
| 3 | | or acetolactate pyruvate-lyase. | | |
| BW7 | BASF Inc. | Tolerance to imidazolinone herbicides | Triticum | |
| | | induced by chemical mutagenesis of the | aestivum | |
| | | acetohydroxyacid synthase (AHAS) gene | (Wheat) | |
| | | using sodium azide. | | |
| Event 1 | Syngenta | Fusarium resistance (trichothecene 3-O- | Triticum | CA 2561992 |
| | Participations | acetyltransferase); CA 2561992 | aestivum | |
| | AG | | (Wheat) | |
| JOPLI | Syngenta | disease (fungal) resistance (trichothecene 3- | Triticum | US |
| N1 | Participations | O-acetyltransferase); US 2008064032 | aestivum | 2008064032 |
| | AG | | (Wheat) | |
| MON7 | Monsanto | Glyphosate tolerant wheat variety produced | Triticum | |
| 1800 | Company | by inserting a modified 5- | aestivum | |
| | | enolpyruvylshikimate-3-phosphate synthase | (Wheat) | |
| | | (EPSPS) encoding gene from the soil | | |
| | | bacterium Agrobacterium tumefaciens, | | |
| | | strain CP4. | | |
| SWP96 | Cyanamid | Selection for a mutagenized version of the | Triticum | |
| 5001 | Crop | enzyme acetohydroxyacid synthase (AHAS), | aestivum | |
| | Protection | also known as acetolactate synthase (ALS) | (Wheat) | |
| | | or acetolactate pyruvate-lyase. | | |
| Teal | BASF Inc. | Selection for a mutagenized version of the | Triticum | |
| 11A | | enzyme acetohydroxyacid synthase (AHAS) , | aestivum | |
| | | also known as acetolactate synthase (ALS) | (Wheat) | |
| | | or acetolactate pyruvate-lyase. | | |
| 176 | Syngenta | Insect-resistant maize produced by inserting | Zea mays | |
| | Seeds, Inc. | the cry1Ab gene from Bacillus thuringiensis | L. (Maize) | |
| | | subsp. kurstaki. The genetic modification | | |
| | | affords resistance to attack by the European | | |
| | | corn borer (ECB). | | |
| HCN92 | Bayer | Introduction of the PPT-acetyltransferase | Brassica | |
| | CropScience | (PAT) encoding gene from Streptomyces | napus | |
| | (Aventis | viridochromogenes, an aerobic soil bacteria. | (Argentine | |
| | CropScience | PPT normally acts to inhibit glutamine | Canola) | |
| | (AgrEvo)) | synthetase, causing a fatal accumulation of | | |
| | | ammonia. Acetylated PPT is inactive. | | |
| 3272 | Syngenta | Self processing corn (alpha-amylase); US | Zea mays | US 2006- |
| | Participations | 2006-230473 | L. (Maize) | 230473, |
| | AG | | | US2010063265 |
| 3751IR | Pioneer | Selection of somaclonal variants by culture | Zea mays | |
| | Hi-Bred | of embryos on imidazolinone containing | L. (Maize) | |
| | International | media. | | |
| | Inc. | | | |
| 676, | Pioneer | Male-sterile and glufosinate ammonium | Zea mays | |
| 678, | Hi-Bred | herbicide tolerant maize produced by | L. (Maize) | |
| 680 | International | inserting genes encoding DNA adenine | | |
| | Inc. | methylase and phosphinothricin | | |
| | | acetyltransferase (PAT) from Escherichia | | |
| | | coli and Streptomyces viridochromogenes, | | |
| | | respectively. | | |
| ACS- | Bayer | Stacked insect resistant and herbicide | Zea mays | |
| ZMØØ | CropScience | tolerant corn hybrid derived from | L. (Maize) | |
| 3-2 x | (Aventis | conventional cross-breeding of the parental | | |
| ØØ81Ø- | MON- | lines T25 (OECD identifier: ACS-ZMØØ3- | | |
| 6 | CropScience | 2) and MON810 (OECD identifier:MON- | | |
| | (AgrE vo)) | ØØ81Ø-6). | | |
| B16 | DEKALB | Glufosinate resistance; US 2003-126634 | Zea mays | US 2003- |
| | GENETICS | | L. (Maize) | 126634 |
| | CORP | | | |
| B16 | Dekalb | Glufosinate ammonium herbicide tolerant | Zea mays | |
| (DLL25) | Genetics | maize produced by inserting the gene | L. (Maize) | |
| | Corporation | encoding phosphinothricin acetyltransferase | | |
| | | (PAT) from Streptomyces hygroscopicus. | | |
| BT11 | Syngenta | Insect-resistant and herbicide tolerant maize | Zea mays | WO |
| (X4334 | Seeds, Inc. | produced by inserting the cry1Ab gene from | L. (Maize) | 2010148268 |
| CBR, | | Bacillus thuringiensis subsp. kurstaki, and | | |
| X4734 | | the phosphinothricin N-acetyltransferase | | |
| CBR) | | (PAT) encoding gene from S. | | |
| | | viridochromogenes. | | |
| BT11 x | Syngenta | Stacked insect resistant and herbicide | Zea mays | |
| GA21 | Seeds, Inc. | tolerant maize produced by conventional | L. (Maize) | |
| | | cross breeding of parental lines BT11 | | |
| | | (OECD unique identifier: SYN-BTØ11-1) | | |
| | | and GA21 (OECD unique identifier: MON- | | |
| | | ØØØ21-9). | | |
| BT11 x | Syngenta | Stacked insect resistant and herbicide | Zea mays | |
| MIR16 | Seeds, Inc. | tolerant maize produced by conventional | L. (Maize) | |
| 2 | | cross breeding of parental lines BT11 | | |
| | | (OECD unique identifier: SYN-BTØ11-1) | | |
| | | and MIR162 (OECD unique identifier: | | |
| | | SYN-IR162-4). Resistance to the European | | |
| | | Corn Borer and tolerance to the herbicide | | |
| | | glufosinate ammonium (Liberty) is derived | | |
| | | from BT11, which contains the cry1Ab gene | | |
| | | from Bacillus thuringiensis subsp. kurstaki, | | |
| | | and the phosphinothricin N-acetyltransferase | | |
| | | (PAT) encoding gene from S. | | |
| | | viridochromogenes. Resistance to other | | |
| | | lepidopteran pests, including H. zea, S. | | |
| | | frugiperda, A. ipsilon, and S. albicosta, is | | |
| | | derived from MIR162, which contains the | | |
| | | vip3Aa gene from Bacillus thuringiensis | | |
| | | strain AB88. | | |
| BT11 x | Syngenta | Bacillus thuringiensis Cry1Ab delta- | Zea mays | |
| MIR16 | Seeds, Inc. | endotoxin protein and the genetic material | L. (Maize) | |
| 2 x | | necessary for its production (via elements of | | |
| MIR60 | | vector pZO1502) in Event Bt11 corn | | |
| 4 | | (OECD Unique Identifier: SYN-BTØ11-1) x | | |
| | | Bacillus thuringiensis Vip3Aa20 insecticidal | | |
| | | protein and the genetic material necessary | | |
| | | for its production (via elements of vector | | |
| | | pNOV1300) in Event MIR162 maize | | |
| | | (OECD Unique Identifier: SYN-IR162-4) x | | |
| | | modified Cry3A protein and the genetic | | |
| | | material necessary for its production (via | | |
| | | elements of vector pZM26) in Event | | |
| | | MIR604 corn (OECD Unique Identifier: | | |
| | | SYN-IR6Ø4-5). | | |
| MS1, | Aventis | Male-sterility, fertility restoration, | Brassica | |
| RF1 | CropScience | pollination control system displaying | napus | |
| =>PGS | (formerly | glufosinate herbicide tolerance. MS lines | (Argentine | |
| 1 | Plant | contained the barnase gene from Bacillus | Canola) | |
| | Genetic | amyloliquefaciens, RF lines contained the | | |
| | Systems) | barstar gene from the same bacteria, and | | |
| | | both lines contained the phosphinothricin N- | | |
| | | acetyltransferase (PAT) encoding gene from | | |
| | | Streptomyces hygroscopicus. | | |
| BT11 x | Syngenta | Stacked insect resistant and herbicide | Zea mays | |
| MIR60 | Seeds, Inc. | tolerant maize produced by conventional | L. (Maize) | |
| 4 | | cross breeding of parental lines BT11 | | |
| | | (OECD unique identifier: SYN-BTØ11-1) | | |
| | | and MIR604 (OECD unique identifier: | | |
| | | SYN-IR6Ø5-5). Resistance to the European | | |
| | | Corn Borer and tolerance to the herbicide | | |
| | | glufosinate ammonium (Liberty) is derived | | |
| | | from BT11, which contains the cry1Ab gene | | |
| | | from Bacillus thuringiensis subsp. kurstaki, | | |
| | | and the phosphinothricin N-acetyltransferase | | |
| | | (PAT) encoding gene from S. | | |
| | | viridochromogenes. Corn rootworm- | | |
| | | resistance is derived from MIR604 which | | |
| | | contains the mcry3A gene from Bacillus | | |
| | | thuringiensis. | | |
| BT11 x | Syngenta | Stacked insect resistant and herbicide | Zea mays | |
| MIR60 | Seeds, Inc. | tolerant maize produced by conventional | L. (Maize) | |
| 4 x | | cross breeding of parental lines BT11 | | |
| GA21 | | (OECD unique identifier: SYN-BTØ11-1), | | |
| | | MIR604 (OECD unique identifier: SYN- | | |
| | | IR6Ø5-5) and GA21 (OECD unique | | |
| | | identifier: MON-ØØØ21-9). Resistance to | | |
| | | the European Corn Borer and tolerance to | | |
| | | the herbicide glufosinate ammonium | | |
| | | (Liberty) is derived from BT11, which | | |
| | | contains the cry1Ab gene from Bacillus | | |
| | | thuringiensis subsp. kurstaki, and the | | |
| | | phosphinothricin N-acetyltransferase (PAT) | | |
| | | encoding gene from S. viridochromogenes. | | |
| | | Corn rootworm-resistance is derived from | | |
| | | MIR604 which contains the mcry3A gene | | |
| | | from Bacillus thuringiensis. Tolerance to | | |
| | | glyphosate herbcicide is derived from GA21 | | |
| | | which contains a a modified EPSPS gene | | |
| | | from maize | | |
| CBH- | Aventis | Insect-resistant and glufosinate ammonium | Zea mays | |
| 351 | CropScience | herbicide tolerant maize developed by | L. (Maize) | |
| | | inserting genes encoding Cry9C protein | | |
| | | from Bacillus thuringiensis subsp tolworthi | | |
| | | and phosphinothricin acetyltransferase | | |
| | | (PAT) from Streptomyces hygroscopicus. | | |
| DAS- | DOW | Lepidopteran insect resistant and glufosinate | Zea mays | |
| 06275- | AgroSciences | ammonium herbicide-tolerant maize variety | L. (Maize) | |
| 8 | LLC | produced by inserting the cry1F gene from | | |
| | | Bacillus thuringiensis var aizawai and the | | |
| | | phosphinothricin acetyltransferase (PAT) | | |
| | | from Streptomyces hygroscopicus. | | |
| DAS- | DOW | Corn rootworm-resistant maize produced by | Zea mays | US 2006- |
| 59122- | AgroSciences | inserting the cry34Ab1 and cry35Ab1 genes | L. (Maize) | 070139, US |
| 7 | LLC | from Bacillus thuringiensis strain PS149B1. | | 2011030086 |
| | and | The PAT encoding gene from Streptomyces | | |
| | Pioneer | viridochromogenes was introduced as a | | |
| | Hi-Bred | selectable marker; US 2006-070139 | | |
| | International | | | |
| | Inc. | | | |
| DAS- | DOW | Stacked insect resistant and herbicide | Zea mays | |
| 59122- | AgroSciences | tolerant maize produced by conventional | L. (Maize) | |
| 7 x | LLC | cross breeding of parental lines DAS-59122- | | |
| NK603 | and | 7 (OECD unique identifier: DAS-59122-7) | | |
| | Pioneer | with NK603 (OECD unique identifier: | | |
| | Hi-Bred | MON-ØØ6Ø3-6). Corn rootworm-resistance | | |
| | International | is derived from DAS-59122-7 which | | |
| | Inc. | contains the cry34Ab1 and cry35Ab1 genes | | |
| | | from Bacillus thuringiensis strain PS149B1. | | |
| | | Tolerance to glyphosate herbcicide is | | |
| | | derived from NK603. | | |
| DAS | DOW | Stacked insect resistant and herbicide | Zea mays | |
| 59122- | AgroSciences | tolerant maize produced by conventional | L. (Maize) | |
| 7 x | LLC | cross breeding of parental lines DAS-59122- | | |
| TC1507 | and | 7 (OECD unique identifier: DAS-59122-7) | | |
| x | Pioneer | and TC1507 (OECD unique identifier: DAS- | | |
| NK603 | Hi-Bred | Ø15Ø7-1) with NK603 (OECD unique | | |
| | International | identifier: MON-ØØ6Ø3-6). Corn | | |
| | Inc. | rootworm-resistance is derived from DAS- | | |
| | | 59122-7 which contains the cry34Ab1 and | | |
| | | cry35Ab1 genes from Bacillus thuringiensis | | |
| | | strain PS149B1. Lepidopteran resistance and | | |
| | | toleraance to glufosinate ammonium | | |
| | | herbicide is derived from TC1507. | | |
| | | Tolerance to glyphosate herbcicide is | | |
| | | derived from NK603. | | |
| DAS- | DOW | Stacked insect resistant and herbicide | Zea mays | |
| Ø15Ø7- | AgroSciences | tolerant corn hybrid derived from | L. (Maize) | |
| 1 x | LLC | conventional cross-breeding of the parental | | |
| MON- | | lines 1507 (OECD identifier: DAS-Ø15Ø7- | | |
| ØØ6Ø3- | | 1) and NK603 (OECD identifier: MON- | | |
| 6 | | ØØ6Ø3-6). | | |
| DB T41 | Dekalb | Insect-resistant and glufosinate ammonium | Zea mays | |
| 8 | Genetics | herbicide tolerant maize developed by | L. (Maize) | |
| | Corporation | inserting genes encoding Cry1AC protein | | |
| | | from Bacillus thuringiensis subsp kurstaki | | |
| | | and phosphinothricin acetyltransferase | | |
| | | (PAT) from Streptomyces hygroscopicus | | |
| DK404 | BASF Inc. | Somaclonal variants with a modified acetyl- | Zea mays | |
| SR | | CoA-carboxylase (ACCase) were selected | L. (Maize) | |
| | | by culture of embryos on sethoxydim | | |
| | | enriched medium. | | |
| MS1, | Aventis | Male-sterility, fertility restoration, | Brassica | |
| RF2 | CropScience | pollination control system displaying | napus | |
| =>PGS | (formerly | glufosinate herbicide tolerance. MS lines | (Argentine | |
| 2 | Plant | contained the barnase gene from Bacillus | Canola) | |
| | Genetic | amyloliquefaciens, RF lines contained the | | |
| | Systems) | barstar gene from the same bacteria, and | | |
| | | both lines contained the phosphinothricin N- | | |
| | | acetyltransferase (PAT) encoding gene from | | |
| | | Streptomyces hygroscopicus. | | |
| DP- | Pioneer | Corn line 98140 was genetically engineered | Zea mays | |
| Ø9814 | Hi-Bred | to express the GAT4621 (glyphosate | L. (Maize) | |
| Ø-6 | International | acetyltransferase) and ZM-HRA (modified | | |
| (Event | Inc. | version of a maize acetolactate synthase) | | |
| 98140) | | proteins. The GAT4621 protein, encoded by | | |
| | | the gat4621 gene, confers tolerance to | | |
| | | glyphosate-containing herbicides by | | |
| | | acetylating glyphosate and thereby rendering | | |
| | | it non-phytotoxic. The ZM-HRA protein, | | |
| | | encoded by the zm-hra gene, confers | | |
| | | tolerance to the ALS-inhibiting class of | | |
| | | herbicides. | | |
| Event | Syngenta | Maize line expressing a heat stable alpha- | Zea mays | |
| 3272 | Seeds, Inc. | amylase gene amy797E for use in the dry- | L. (Maize) | |
| | | grind ethanol process. The phosphomannose | | |
| | | isomerase gene from E.coli was used as a | | |
| | | selectable marker. | | |
| Event | Pioneer | Maize event expressing tolerance to | Zea mays | |
| 98140 | Hi-Bred | glyphosate herbicide, via expression of a | L. (Maize) | |
| | International | modified bacterial glyphosate N- | | |
| | Inc. | acetlytransferase, and ALS-inhibiting | | |
| | | herbicides, vial expression of a modified | | |
| | | form of the maize acetolactate synthase | | |
| | | enzyme. | | |
| EXP19 | Syngenta | Tolerance to the imidazolinone herbicide, | Zea mays | |
| 10IT | Seeds, Inc. | imazethapyr, induced by chemical | L. (Maize) | |
| | (formerly | mutagenesis of the acetolactate synthase | | |
| | Zeneca | (ALS) enzyme using ethyl methanesulfonate | | |
| | Seeds) | (EMS). | | |
| FI117 | | Glyphosate resistance; U.S. Pat. No. 6,040,497 | Zea mays | |
| | | | L. (Maize) | |
| GA21 | Monsanto | Introduction, by particle bombardment, of a | Zea mays | U.S. Pat. No. |
| | Company | modified 5-enolpyruvyl shikimate-3- | L. (Maize) | 6,040,497 |
| | | phosphate synthase (EPSPS), an enzyme | | |
| | | involved in the shikimate biochemical | | |
| | | pathway for the production of the aromatic | | |
| | | amino acids; U.S. Pat. No. 6,040,497 | | |
| GA21 x | Monsanto | Stacked insect resistant and herbicide | Zea mays | U.S. Pat. No. |
| MON8 | Company | tolerant corn hybrid derived from | L. (Maize) | 6,040,497 |
| 10 | | conventional cross-breeding of the parental | | |
| | | lines GA21 (OECD identifider: MON- | | |
| | | ØØØ21-9) and MON810 (OECD identifier: | | |
| | | MON-ØØ81Ø-6). | | |
| GAT- | AVENTIS | Glufosinate tolerance; WO 01/51654 | Zea mays | |
| ZM1 | CROPSCIENCE | | L. (Maize) | |
| | NV | | | |
| GG25 | DEKALB | Glyphosate resistance; U.S. Pat. No. 6,040,497 | Zea mays | WO 01/51654 |
| | GENETICS | | L. (Maize) | |
| | CORP | | | |
| MS8xR | Bayer | Male-sterility, fertility restoration, | Brassica | U.S. Pat. No. |
| F3 | CropScience | pollination control system displaying | napus | 6,040,497 |
| | (Aventis | glufosinate herbicide tolerance. MS lines | (Argentine | |
| | CropScience | contained the barnase gene from Bacillus | Canola) | |
| | (AgrEvo)) | amyloliquefaciens, RF lines contained the | | |
| | | barstar gene from the same bacteria, and | | |
| | | both lines contained the phosphinothricin N- | | |
| | | acetyltransferase (PAT) encoding gene from | | |
| | | Streptomyces hygroscopicus. | | |
| GJ11 | DEKALB | Glyphosate resistance; U.S. Pat. No. 6,040,497 | Zea mays | |
| | GENETICS | | L. (Maize) | |
| | CORP | | | |
| IT | Pioneer | Tolerance to the imidazolinone herbicide, | Zea mays | U.S. Pat. No. |
| | Hi-Bred | imazethapyr, was obtained by in vitro | L. (Maize) | 6,040,497 |
| | International | selection of somaclonal variants. | | |
| | Inc. | | | |
| LY038 | Monsanto | Altered amino acid composition, specifically | Zea mays | |
| | Company | elevated levels of lysine, through the | L. (Maize) | |
| | | introduction of the cordapA gene, derived | | |
| | | from Corynebacterium glutamicum, | | |
| | | encoding the enzyme dihydrodipicolinate | | |
| | | synthase (cDHDPS) ; U.S. Pat. No. 7,157,281 | | |
| MIR16 | | Insect resistance; WO 2007142840 | Zea mays | U.S. Pat. No. |
| 2 | | | L. (Maize) | 7,157,281, |
| | | | | US2010212051 |
| MIR60 | Syngenta | Corn rootworm resistant maize produced by | Zea mays | WO |
| 4 | Seeds, Inc. | transformation with a modified cry3A gene. | L. (Maize) | 2007142840 |
| | | The phosphomannose isomerase gene from | | |
| | | E.coli was used as a selectable marker; | | |
| | | (Cry3a055); EP 1 737 290 | | |
| MIR60 | Syngenta | Stacked insect resistant and herbicide | Zea mays | EP 1 737 290 |
| 4 x | Seeds, Inc. | tolerant maize produced by conventional | L. (Maize) | |
| GA21 | | cross breeding of parental lines MIR604 | | |
| | | (OECD unique identifier: SYN-IR6Ø5-5) | | |
| | | and GA21 (OECD unique identifier: MON- | | |
| | | ØØØ21-9). Corn rootworm-resistance is | | |
| | | derived from MIR604 which contains the | | |
| | | mcry3A gene from Bacillus thuringiensis. | | |
| | | Tolerance to glyphosate herbcicide is | | |
| | | derived from GA21. | | |
| MON8 | Monsanto | Insect-resistant maize produced by inserting | Zea mays | |
| 0100 | Companpy | the cry1Ab gene from Bacillus thuringiensis | L. Maize ) | |
| | | subsp. kurstaki. The genetic modification | | |
| | | affords resistance to attack by the European | | |
| | | corn borer (ECB). | | |
| MON8 | Monsanto | Insect-resistant and glyphosate herbicide | Zea mays | |
| 02 | Company | tolerant maize produced by inserting the | L. (Maize) | |
| | | genes encoding the Cry1Ab protein from | | |
| | | Bacillus thuringiensis and the 5- | | |
| | | enolpyruvylshikimate-3-phosphate synthase | | |
| | | (EPSPS) from A. tumefaciens strain CP4. | | |
| MON8 | Pioneer | Resistance to European corn borer (Ostrinia | Zea mays | |
| 09 | Hi-Bred | nubilalis) by introduction of a synthetic | L. (Maize) | |
| | Internation | cry1Ab gene. Glyphosate resistance via | | |
| | al Inc. | introduction of the bacterial version of a | | |
| | | plant enzyme, 5-enolpyruvyl shikimate-3- | | |
| | | phosphate synthase (EPSPS). | | |
| MON8 | Monsanto | Insect-resistant maize produced by inserting | Zea mays | |
| 10 | Company | a truncated form of the cry1Ab gene from | L. (Maize) | |
| | | Bacillus thuringiensis subsp. kurstaki HD-1. | | |
| | | The genetic modification affords resistance | | |
| | | to attack by the European corn borer (ECB); | | |
| | | US 2004-180373 | | |
| MS-B2 | AVENTIS | Male sterility; WO 01/31042 | Brassica | US 2004- |
| | CROPSCIENCE | | napus | 180373 |
| | NV | | (Argentine | |
| | | | Canola) | |
| MON8 | Monsanto | Stacked insect resistant and glyphosate | Zea mays | WO 01/31042 |
| 10 x | Company | tolerant maize derived from conventional | L. (Maize) | |
| MON8 | | cross-breeding of the parental lines | | |
| 8017 | | MON810 (OECD identifier: MON-ØØ81Ø- | | |
| | | 6) and MON88017 (OECD identifier:MON- | | |
| | | 88Ø17-3). European corn borer (ECB) | | |
| | | resistance is derived from a truncated form | | |
| | | of the cry1Ab gene from Bacillus | | |
| | | thuringiensis subsp. kurstaki HD-1 present | | |
| | | in MON810. Corn rootworm resistance is | | |
| | | derived from the cry3Bb1 gene from | | |
| | | Bacillus thuringiensis subspecies | | |
| | | kumamotoensis strain EG4691 present in | | |
| | | MON88017. Glyphosate tolerance is derived | | |
| | | from a 5-enolpyruvylshikimate-3-phosphate | | |
| | | synthase (EPSPS) encoding gene from | | |
| | | Agrobacterium tumefaciens strain CP4 | | |
| | | present in MON88017. | | |
| MON8 | Monsanto | Introduction, by particle bombardment, of | Zea mays | |
| 32 | Company | glyphosate oxidase (GOX) and a modified | L. (Maize) | |
| | | 5-enolpyruvyl shikimate-3-phosphate | | |
| | | synthase (EPSPS), an enzyme involved in | | |
| | | the shikimate biochemical pathway for the | | |
| | | production of the aromatic amino acids. | | |
| MON8 | Monsanto | Corn root worm resistant maize produced by | Zea mays | |
| 63 | Company | inserting the cry3Bb1 gene from Bacillus | L. (Maize) | |
| | | thuringiensis subsp. kumamotoensis. | | |
| MON8 | Monsanto | Stacked insect resistant corn hybrid derived | Zea mays | |
| 63 x | Company | from conventional cross-breeding of the | L. (Maize) | |
| MON8 | | parental lines MON863 (OECD identifier: | | |
| 10 | | MON-ØØ863-5) and MON810 (OECD | | |
| | | identifier: MON-ØØ81Ø-6) | | |
| MON8 | Monsanto | Stacked insect resistant and herbicide | Zea mays | |
| 63 x | Company | tolerant corn hybrid derived from | L. (Maize) | |
| MON8 | | conventional cross-breeding of the stacked | | |
| 10 x | | hybrid MON-ØØ863-5 x MON-ØØ81Ø-6 | | |
| NK603 | | and NK603 (OECD identifier:MON- | | |
| | | ØØ6Ø3-6). | | |
| MON8 | Monsanto | Stacked insect resistant and herbicide | Zea mays | |
| 63 x | Company | tolerant corn hybrid derived from | L. (Maize) | |
| NK603 | | conventional cross-breeding of the parental | | |
| | | lines MON863 (OECD identifier:MON- | | |
| | | ØØ863-5) and NK603 (OECD identifier: | | |
| | | MON-ØØ6Ø3-6). | | |
| MON8 | MONSANTO | Drought tolerance; Water deficit tolerance; | Zea mays | |
| 7460 | TECHNOLOGY | WO 2009/111263 | L. (Maize) | |
| | LLC | | | |
| MON8 | Monsanto | Corn rootworm-resistant maize produced by | Zea mays | WO |
| 8017 | Company | inserting the cry3Bb1 gene from Bacillus | L. (Maize) | 2009111263 |
| | | thuringiensis subspecies kumamotoensis | | |
| | | strain EG4691. Glyphosate tolerance derived | | |
| | | by inserting a 5-enolpyruvylshikimate-3- | | |
| | | phosphate synthase (EPSPS) encoding gene | | |
| | | from Agrobacterium tumefaciens strain | | |
| | | CP4; WO2005059103 | | |
| MON8 | Monsanto | Maize event expressing two different | Zea mays | WO |
| 9034 | Company | insecticidal proteins from Bacillus | L. (Maize) | 2005/059103 |
| | | thuringiensis providing resistance to number | | |
| | | of lepidopteran pests; nsect resistance | | |
| | | (Lepidoptera-Cry1A.105-Cry2Ab); WO | | |
| | | 2007140256 | | |
| MON8 | Monsanto | Stacked insect resistant and glyphosate | Zea mays | WO |
| 9034 x | Company | tolerant maize derived from conventional | L. (Maize) | 2007140256 |
| MON8 | | cross-breeding of the parental lines | | |
| 8017 | | MON89034 (OECD identifier: MON- | | |
| | | 89Ø34-3) and MON88017 (OECD | | |
| | | identifier:MON-88Ø17-3). Resistance to | | |
| | | Lepiopteran insects is derived from two | | |
| | | crygenes present in MON89043. Corn | | |
| | | rootworm resistance is derived from a single | | |
| | | cry genes and glyphosate tolerance is | | |
| | | derived from the 5-enolpyruvylshikimate-3- | | |
| | | phosphate synthase (EPSPS) encoding gene | | |
| | | from Agrobacterium tumefaciens present in | | |
| | | MON88017. | | |
| MS- | AVENTIS | Male sterility/restoration; WO 01/41558 | Brassica | |
| BN1/R | CROPSCIENCE | | napus | |
| F-BN1 | NV | | (Argentine | |
| | | | Canola) | |
| MON8 | Monsanto | Stacked insect resistant and herbicide | Zea mays | WO 01/41558 |
| 9034 x | Company | tolerant maize produced by conventional | L. (Maize) | |
| NK603 | | cross breeding of parental lines MON89034 | | |
| | | (OECD identifier: MON-89Ø34-3) with | | |
| | | NK603 (OECD unique identifier: MON- | | |
| | | ØØ6Ø3-6). Resistance to Lepiopteran | | |
| | | insects is derived from two crygenes present | | |
| | | in MON89043. Tolerance to glyphosate | | |
| | | herbcicide is derived from NK603. | | |
| MON8 | Monsanto | Stacked insect resistant and herbicide | Zea mays | |
| 9034 x | Company | tolerant maize produced by conventional | L. (Maize) | |
| TC1507 | | cross breeding of parental lines: | | |
| x | | MON89034, TC1507, MON88017, and | | |
| MON8 | | DAS-59122. Resistance to the above-ground | | |
| 8017 x | | and below-ground insect pests and tolerance | | |
| DAS- | | to glyphosate and glufosinate-ammonium | | |
| 59122- | | containing herbicides. | | |
| 7 | | | | |
| MON- | Monsanto | Stacked insect resistant and herbicide | Zea mays | |
| ØØ6Ø-6 | Company | tolerant corn hybrid derived from | L. (Maize) | |
| x | | conventional cross-breeding of the parental | | |
| MON- | | lines NK603 (OECD identifier: MON- | | |
| ØØ81Ø-6 | | ØØ6Ø3-6) and MON810 (OECD identifier: | | |
| | | MON-ØØ81Ø-6). | | |
| MON- | Monsanto | Stacked insect resistant and enhanced lysine | Zea mays | |
| ØØ81Ø- | Company | content maize derived from conventional | L. (Maize) | |
| 6 x | | cross-breeding of the parental lines | | |
| LY038 | | MON810 (OECD identifier: MON-ØØ81Ø- | | |
| | | 6) and LY038 (OECD identifier: REN- | | |
| | | ØØØ38-3). | | |
| MON- | Monsanto | Stacked insect resistant and herbicide | Zea mays | |
| 00863- | Company | tolerant corn hybrid derived from | L. (Maize) | |
| 5 x | | conventional cross-breeding of the parental | | |
| MON- | | lines MON863 (OECD identifier:MON- | | |
| ØØ6Ø3- | | ØØ863-5) and NK603 (OECD identifier: | | |
| 6 | | MON-ØØ6Ø3-6). | | |
| MON | Monsanto | Stacked insect resistant corn hybrid derived | Zea mays | |
| ØØ863- | Company | from conventional cross-breeding of the | L. (Maize) | |
| 5 x | | parental lines MON863 (OECD identifier: | | |
| MON- | | MON-ØØ863-5) and MON810 (OECD | | |
| ØØ81Ø- | | identifier: MON-ØØ81Ø-6) | | |
| 6 | | | | |
| MON- | Monsanto | Stacked insect resistant and herbicide | Zea mays | |
| ØØ863- | Company | tolerant corn hybrid derived from | L. (Maize) | |
| 5 x | | conventional cross-breeding of the stacked | | |
| MON | | hybrid MON-ØØ863-5 x MON-ØØ81Ø-6 | | |
| ØØ81Ø | | and NK603 (OECD identifier:MON- | | |
| -6 x | | ØØ6Ø3-6). | | |
| MON- | | | | |
| ØØ6Ø3- | | | | |
| 6 | | | | |
| MON- | Monsanto | Stacked insect resistant and herbicide | Zea mays | |
| ØØ21- | Company | tolerant corn hybrid derived from | L. (Maize) | |
| 9 x | | conventional cross-breeding of the parental | | |
| MON- | | lines GA21 (OECD identifider: MON- | | |
| ØØ81Ø- | | ØØØ21-9) and MON810 (OECD identifier: | | |
| 6 | | MON-ØØ81Ø-6). | | |
| MS3 | Bayer | Male sterility caused by expression of the | Zea mays | |
| | CropScience | barnase ribonuclease gene from Bacillus | L. (Maize) | |
| | (Aventis | amyloliquefaciens; PPT resistance was via | | |
| | CropScience | PPT-acetyltransferase (PAT). | | |
| | (AgrEvo)) | | | |
| MS6 | Bayer | Male sterility caused by expression of the | Zea mays | |
| | CropScience | barnase ribonuclease gene from Bacillus | L. (Maize) | |
| | (Aventis | amyloliquefaciens; PPT resistance was via | | |
| | CropScience | PPT-acetyltransferase (PAT). | | |
| | (AgrEvo)) | | | |
| NS738, | Pioneer | Selection of somaclonal variants with altered | Brassica | |
| NS1471, | Hi-Bred | acetolactate synthase (ALS) enzymes, | napus | |
| NS1473 | International | following chemical mutagenesis. Two lines | (Argentine | |
| | Inc. | (P1,P2) were initially selected with | Canola) | |
| | | modifications at different unlinked loci. | | |
| | | NS738 contains the P2 mutation only. | | |
| NK603 | Monsanto | Introduction, by particle bombardment, of a | Zea mays | |
| | Company | modified 5-enolpyruvyl shikimate-3- | L. (Maize) | |
| | | phosphate synthase (EPSPS), an enzyme | | |
| | | involved in the shikimate biochemical | | |
| | | pathway for the production of the aromatic | | |
| | | amino acids. | | |
| NK603 | Monsanto | Stacked insect resistant and herbicide | Zea mays | |
| x | Company | tolerant corn hybrid derived from | L. (Maize) | |
| MON8 | | conventional cross-breeding of the parental | | |
| 10 | | lines NK603 (OECD identifier: MON- | | |
| | | ØØ6Ø3-6) and MON810 (OECD identifier: | | |
| | | MON-ØØ81Ø-6). | | |
| NK603 | Monsanto | Stacked glufosinate ammonium and | Zea mays | |
| x T25 | Company | glyphosate herbicide tolerant maize hybrid | L. (Maize) | |
| | | derived from conventional cross-breeding of | | |
| | | the parental lines NK603 (OECD identifier: | | |
| | | MON-ØØ6Ø3-6) and T25 (OECD | | |
| | | identifier: ACS-ZMO03-2). | | |
| PV- | MONSANTO | Glyphosate tolerance; US 2007-056056 | Zea mays | |
| ZMGT | TECHNOL- | | L. (Maize) | |
| 32 | OGY | | | |
| (NK603) | LLC | | | |
| PV- | MONSANTO | Glyphosate tolerance; US 2007292854 | Zea mays | US 2007- |
| ZMGT | TECHNOL- | | L. (Maize) | 056056 |
| 32(nk6 | OGY | | | |
| 03) | LLC | | | |
| PV- | MONSANTO | Insect resistance (Cry3Bb); US 2006- | Zea mays | US |
| ZMIR1 | TECHNOL- | 095986 | L. (Maize) | 2007292854 |
| 3 | LOGY | | | |
| (MON8 | LLC | | | |
| 63) | | | | |
| SYN- | Syngenta | Stacked insect resistant and herbicide | Zea mays | US 2006- |
| BTØ11- | Seeds, Inc. | tolerant maize produced by conventional | L. (Maize) | 095986 |
| 1 x | | cross breeding of parental lines BT11 | | |
| MON- | | (OECD unique identifier: SYN-BTØ11-1) | | |
| ØØØ21- | | and GA21 (OECD unique identifier: MON- | | |
| 9 | | ØØØ21-9). | | |
| T14 | Bayer | Glufosinate herbicide tolerant maize | Zea mays | |
| | CropScience | produced by inserting the phosphinothricin | L. (Maize) | |
| | (Aventis | N-acetyltransferase (PAT) encoding gene | | |
| | CropScience | from the aerobic actinomycete Streptomyces | | |
| | (AgrEvo)) | viridochromogenes. | | |
| T14, | Bayer | Glufosinate herbicide tolerant maize | Zea mays | |
| T25 | CropScience | produced by inserting the phosphinothricin | L. (Maize) | |
| | (Aventis | N-acetyltransferase (PAT) encoding gene | | |
| | CropScience | from the aerobic actinomycete Streptomyces | | |
| | (AgrEvo)) | viridochromogenes. | | |
| T25 x | Bayer | Stacked insect resistant and herbicide | Zea mays | |
| MON8 | CropScience | tolerant corn hybrid derived from | L. (Maize) | |
| 10 | (Aventis | conventional cross-breeding of the parental | | |
| | CropScience | lines T25 (OECD identifier: ACS-ZMØØ3- | | |
| | (AgrEvo)) | 2) and MON810 (OECD identifier:MON- | | |
| | | ØØ81Ø-6). | | |
| OXY- | Aventis | Tolerance to the herbicides bromoxynil and | Brassica | |
| 235 | CropScience | ioxynil by incorporation of the nitrilase gene | napus | |
| | (formerly | from Klebsiella pneumoniae. | (Argentine | |
| | Rhone | | Canola) | |
| | Poulenc | | | |
| | Inc.) | | | |
| TC1507 | Mycogen | Insect-resistant and glufosinate ammonium | Zea mays | |
| | (c/o Dow | herbicide tolerant maize produced by | L. (Maize) | |
| | AgroSciences); | inserting the cry1F gene from Bacillus | | |
| | Pioneer | thuringiensis var.aizawai and the | | |
| | (c/o | phosphinothricin N-acetyltransferase | | |
| | Dupont) | encoding gene from Streptomyces | | |
| | | viridochromogenes; Insect resistance | | |
| | | (Cry1F); U.S. Pat. No. 7,435,807 | | |
| TC1507 | DOW | Stacked insect resistant and herbicide | Zea mays | U.S. Pat. No. |
| x DAS- | AgroSciences | tolerant maize produced by conventional | L. (Maize) | 7,435,807 |
| 59122- | LLC | cross breeding of parental lines TC1507 | | |
| 7 | and | (OECD unique identifier: DAS-Ø15Ø7-1) | | |
| | Pioneer | with DAS-59122-7 (OECD unique | | |
| | Hi-Bred | identifier: DAS-59122-7). Resistance to | | |
| | International | lepidopteran insects is derived from TC1507 | | |
| | Inc. | due the presence of the cry1F gene from | | |
| | | Bacillus thuringiensis var. aizawai. Corn | | |
| | | rootworm-resistance is derived from DAS- | | |
| | | 59122-7 which contains the cry34Ab1 and | | |
| | | cry35Ab1 genes from Bacillus thuringiensis | | |
| | | strain PS149B1. Tolerance to glufosinate | | |
| | | ammonium herbcicide is derived from | | |
| | | TC1507 from the phosphinothricin N- | | |
| | | acetyltransferase encoding gene from | | |
| | | Streptomyces viridochromogenes. | | |
| VIP103 | Syngenta | Insect resistance; WO 03/052073 | Zea mays | |
| 4 | Participations | | L. (Maize) | |
| | AG | | | |
| EH92- | BASF | Cropcomposition; Amflora; Unique EU | | WO 03/052073 |
| 527 | Plant | identifier: BPS-25271-9 | | |
| | Science | | | |
| PHY14, | Aventis | Male sterility was via insertion of the | Brassica | |
| PHY35 | CropScience | barnase ribonuclease gene from Bacillus | napus | |
| | (formerly | amyloliquefaciens; fertility restoration by | (Argentine | |
| | Plant | insertion of the barstar RNase inhibitor; PPT | Canola) | |
| | Genetic | resistance was via PPT-acetyltransferase | | |
| | Systems) | (PAT) from Streptomyces hygroscopicus. | | |
| PHY36 | Aventis | Male sterility was via insertion of the | Brassica | |
| | CropScience | barnase ribonuclease gene from Bacillus | napus | |
| | (formerly | amyloliquefaciens; fertility restoration by | (Argentine | |
| | Plant | insertion of the barstar RNase inhibitor; PPT | Canola) | |
| | Genetic | resistance was via PPT-acetyltransferase | | |
| | Systems) | (PAT) from Streptomyces hygroscopicus. | | |
| RT73 | MONSANTO | Glyphosate resistance; WO 02/36831 | Brassica | |
| | TECHNOL- | | napus | |
| | OGY | | (Argentine | |
| | LLC | | Canola) | |
| T45 | Bayer | Introduction of the PPT-acetyltransferase | Brassica | WO 02/36831 |
| (HCN2 | CropScience | (PAT) encoding gene from Streptomyces | napus | |
| 8) | (Aventis | viridochromogenes, an aerobic soil bacteria. | (Argentine | |
| | CropScience | PPT normally acts to inhibit glutamine | Canola) | |
| | (AgrEvo)) | synthetase, causing a fatal accumulation of | | |
| | | ammonia. Acetylated PPT is inactive. | | |
| HCR-1 | Bayer | Introduction of the glufosinate ammonium | Brassica | |
| | CropScience | herbicide tolerance trait from transgenic B. | rapa (Polish | |
| | (Aventis | napus line T45. This trait is mediated by the | Canola) | |
| | CropScience | phosphinothricin acetyltransferase (PAT) | | |
| | (AgrEvo)) | encoding gene from S. viridochromogenes. | | |
| ZSR50 | Monsanto | Introduction of a modified 5-enol- | Brassica | |
| 0/502 | Company | pyruvylshikimate-3-phosphate synthase | rapa (Polish | |
| | | (EPSPS) and a gene from Achromobacter sp | Canola) | |
| | | that degrades glyphosate by conversion to | | |
| | | aminomethylphosphonic acid (AMPA) and | | |
| | | glyoxylate by interspecific crossing with | | |
| | | GT73. | | |
| EE-1 | MAHARA | Insect resistance (Cry1Ac); WO | Brinjal | |
| | SHTRA | 2007/091277 | | |
| | HYBRID | | | |
| | SEEDS | | | |
| | COMPA | | | |
| 55- | Cornell | Papaya ringspot virus (PRSV) resistant | Carica | WO |
| 1/63-1 | University | papaya produced by inserting the coat | papaya | 2007/091277 |
| | | protein (CP) encoding sequences from this | (Papaya) | |
| | | plant potyvirus. | | |
| X17-2 | University | Papaya ringspot virus (PRSV) resistant | Carica | |
| | of Florida | papaya produced by inserting the coat | papaya | |
| | | protein (CP) encoding sequences from | (Papaya) | |
| | | PRSV isolate H1K with a thymidine inserted | | |
| | | after the initiation codon to yield a | | |
| | | frameshift. Also contains nptII as a | | |
| | | selectable marker. | | |
| H7-1 | Monsanto | Glyphosate herbicide tolerant sugar beet | Beta vulgaris | |
| | Company | produced by inserting a gene encoding the | (sugar beet) | |
| | | enzyme 5-enolypyruvylshikimate-3- | | |
| | | phosphate synthase (EPSPS) from the CP4 | | |
| | | strain of Agrobacterium tumefaciens,; WO | | |
| | | 2004-074492 | | |
| RM3-3, | Bejo | Male sterility was via insertion of the | Cichorium | WO 2004- |
| RM3-4 | Zaden BV | barnase ribonuclease gene from Bacillus | intybus | 074492 |
| RM3-6 | | amyloliquefaciens; PPT resistance was via | (Chicory) | |
| | | the bar gene from S. hygroscopicus, which | | |
| | | encodes the PAT enzyme. | | |
| DP- | PIONEER | Glyphosate tolerance/ALS inhibitor | Zea mays | |
| 098140- | HI-BRED | tolerance | L. (Maize) | |
| 6 | INTERNA- | | | |
| | TIONAL | | | |
| | INC, E.I | | | |
| | DU PONT | | | |
| | DE | | | |
| | NEMOURS | | | |
| | AND | | | |
| | COMPANY | | | |
| A, B | Agritope | Reduced accumulation of S- | Cucumis | WO |
| | Inc. | adenosylmethionine (SAM), and | melo (Melon) | 2008/112019, |
| | | consequently reduced ethylene synthesis, by | | US2010240059 |
| | | introduction of the gene encoding S- | | |
| | | adenosylmethionine hydrolase. | | |
| CZW-3 | Asgrow | Cucumber mosiac virus (CMV), zucchini | Cucurbita | |
| | (USA); | yellows mosaic (ZYMV) and watermelon | pepo (Squash) | |
| | Seminis | mosaic virus (WMV) 2 resistant squash | | |
| | Vegetable | (Curcurbita pepo) produced by inserting the | | |
| | Inc. | coat protein (CP) encoding sequences from | | |
| | (Canada) | each of these plant viruses into the host | | |
| | | genome. | | |
| ZW20 | Upjohn | Zucchini yellows mosaic (ZYMV) and | Cucurbita | |
| | (USA); | watermelon mosaic virus (WMV) 2 resistant | pepo (Squash) | |
| | Seminis | squash (Curcurbita pepo) produced by | | |
| | Vegetable | inserting the coat protein (CP) encoding | | |
| | Inc. | sequences from each of these plant | | |
| | (Canada) | potyviruses into the host genome. | | |
| 66 | Florigene | Delayed senescence and sulfonylurea | Dianthus | |
| | Pty Ltd. | herbicide tolerant carnations produced by | caryophyllus | |
| | | inserting a truncated copy of the carnation | (Carnation) | |
| | | aminocyclopropane cyclase (ACC) synthase | | |
| | | encoding gene in order to suppress | | |
| | | expression of the endogenous unmodified | | |
| | | gene, which is required for normal ethylene | | |
| | | biosynthesis. Tolerance to sulfonyl urea | | |
| | | herbicides was via the introduction of a | | |
| | | chlorsulfuron tolerant version of the | | |
| | | acetolactate synthase (ALS) encoding gene | | |
| | | from tobacco. | | |
| 4, 11, | Florigene | Modified colour and sulfonylurea herbicide | Dianthus | |
| 15, 16 | Pty Ltd. | tolerant carnations produced by inserting | caryophyllus | |
| | | two anthocyanin biosynthetic genes whose | (Carnation) | |
| | | expression results in a violet/mauve | | |
| | | colouration.Tolerance to sulfonyl urea | | |
| | | herbicides was via the introduction of a | | |
| | | chlorsulfuron tolerant version of the | | |
| | | acetolactate synthase (ALS) encoding gene | | |
| | | from tobacco. | | |
| 959A, | Florigene | Introduction of two anthocyanin | Dianthus | |
| 988A, | Pty Ltd. | biosynthetic genes to result in a | caryophyllus | |
| 1226A, | | violet/mauve colouration; Introduction of a | (Carnation) | |
| 1351A, | | variant form of acetolactate synthase (ALS). | | |
| 1363A, | | | | |
| 1400A | | | | |
| 3560.4. | Pioneer | Glyphosate/ALS inhibitor-tolerance; WO | Glycine max | |
| 3.5 | Hi-Bred | 2008002872 | L. (Soybean) | |
| | International | | | |
| | Inc. | | | |
| A2704- | Bayer | Glufosinate ammonium herbicide tolerant | Glycine max | WO |
| 12, | CropScience | soybean produced by inserting a modified | L. (Soybean) | 2008002872 |
| A2704- | (Aventis | phosphinothricin acetyltransferase (PAT) | | |
| 21 | CropScience | encoding gene from the soil bacterium | | |
| | (AgrEvo)) | Streptomyces viridochromogenes.; WO | | |
| | | 2006/108674 | | |
| T120-7 | Bayer | Introduction of the PPT-acetyltransferase | Beta vulgaris | WO |
| | CropScience | (PAT) encoding gene from Streptomyces | (sugar beet) | 2006/108674 |
| | (Aventis | viridochromogenes, an aerobic soil bacteria. | | |
| | CropScience | PPT normally acts to inhibit glutamine | | |
| | (AgrEvo)) | synthetase, causing a fatal accumulation of | | |
| | | ammonia. Acetylated PPT is inactive. | | |
| A5547- | Bayer | Glufosinate ammonium herbicide tolerant | Glycine max | |
| 127 | CropScience | soybean produced by inserting a modified | L. (Soybean) | |
| | (Aventis | phosphinothricin acetyltransferase (PAT) | | |
| | CropScience | encoding gene from the soil bacterium | | |
| | (AgrEvo)) | Streptomyces viridochromogenes. | | |
| A5547- | Bayer | Glufosinate tolerance; WO 2006/108675 | Glycine max | |
| 35 | CropScience | | L. (Soybean) | |
| | (Aventis | | | |
| | CropScience | | | |
| | (AgrEvo)) | | | |
| DP- | Pioneer | High oleic acid/ALS inhibitor tolerance; | Glycine max | WO |
| 305423- | Hi-Bred | WO 2008/054747 | L. (Soybean) | 2006/108675 |
| 1 | International | | | |
| | Inc. | | | |
| DP3560 | Pioneer | Soybean event with two herbicide tolerance | Glycine max | WO |
| 43 | Hi-Bred | genes: glyphosate N-acetlytransferase, | L. (Soybean) | 2008/054747 |
| | International | which detoxifies glyphosate, and a modified | | |
| | Inc. | acetolactate synthase (A | | |
| G94-1, | DuPont | High oleic acid soybean produced by | Glycine max | |
| G94- | Canada | inserting a second copy of the fatty acid | L. (Soybean) | |
| 19, | Agricultural | desaturase (GmFad2-1) encoding gene from | | |
| G168 | Products | soybean, which resulted in “silencing” of the | | |
| | | endogenous host gene. | | |
| GTS | Monsanto | Glyphosate tolerant soybean variety | Glycine max | |
| 40-3-2 | Company | produced by inserting a modified 5- | L. (Soybean) | |
| | | enolpyruvylshikimate-3-phosphate synthase | | |
| | | (EPSPS) encoding gene from the soil | | |
| | | bacterium Agrobacterium tumefaciens. | | |
| GU262 | Bayer | Glufosinate ammonium herbicide tolerant | Glycine max | |
| | CropScience | soybean produced by inserting a modified | L. (Soybean) | |
| | (Aventis | phosphinothricin acetyltransferase (PAT) | | |
| | CropScience | encoding gene from the soil bacterium | | |
| | (AgrEvo)) | Streptomyces viridochromogenes. | | |
| MON8 | Monsanto | insect resistance (CryIac); WO 2009064652 | Glycine max | |
| 7701 | Company | | L. (Soybean) | |
| MON8 | Monsanto | altered fatty acid levels (mid-oleic and low | Glycine max | WO |
| 7705 | Company | saturate); WO 2010037016 | L. (Soybean) | 2009064652 |
| MON8 | Monsanto | increased oil content; WO 2010024976 | Glycine max | WO |
| 7754 | Company | | L. (Soybean) | 2010037016 |
| GTSB7 | Novartis | Glyphosate herbicide tolerant sugar beet | Beta vulgaris | WO |
| 7 | Seeds; | produced by inserting a gene encoding the | (sugar beet) | 2010024976 |
| | Monsanto | enzyme 5-enolypyruvylshikimate-3- | | |
| | Company | phosphate synthase (EPSPS) from the CP4 | | |
| | | strain of Agrobacterium tumefaciens. | | |
| MON8 | Monsanto | stearidonic acid (SDA) comprising oil ; WO | Glycine max | |
| 7769 | Company | 2009102873 | L. (Soybean) | |
| MON8 | Monsanto | Glyphosate-tolerant soybean produced by | Glycine max | WO |
| 9788, | Company | inserting a modified 5- | L. (Soybean) | 2009102873 |
| MON1 | | enolpyruvylshikimate-3-phosphate synthase | | |
| 9788 | | (EPSPS) encoding aroA (epsps) gene from | | |
| | | Agrobacterium tumefaciens CP4; | | |
| | | WO2006130436 | | |
| OT96- | Agriculture | Low linolenic acid soybean produced | Glycine max | — |
| 15 | & Agri- | through traditional cross-breeding to | L. (Soybean) | |
| | Food | incorporate the novel trait from a naturally | | |
| | Canada | occurring fanl gene mutant that was selected | | |
| | | for low linolenic acid. | | |
| W62, | Bayer | Glufosinate ammonium herbicide tolerant | Glycine max | |
| W98 | CropScience | soybean produced by inserting a modified | L. (Soybean) | |
| | (Aventis | phosphinothricin acetyltransferase (PAT) | | |
| | CropScience | encoding gene from the soil bacterium | | |
| | (AgrEvo)) | Streptomyces hygroscopicus. | | |
| 15985 | Monsanto | Insect resistant cotton derived by | Gossypium | |
| | Company | transformation of the DP5OB parent variety, | hirsutum | |
| | | which contained event 531 (expressing | L. (Cotton) | |
| | | Cry1Ac protein), with purified plasmid | | |
| | | DNA containing the cry2Ab gene from B. | | |
| | | thuringiensis subsp. kurstaki. | | |
| 1143- | Syngenta | Insect resistance (Cry1Ab); WO | Gossypium | |
| 14A | Participations | 2006/128569 | hirsutum | |
| | AG | | L. (Cotton) | |
| 1143- | Syngenta | Insect resistance (Cry1Ab); WO | Gossypium | WO |
| 51B | Participations | 2006/128570 | hirsutum | 2006/128569 |
| | AG | | L. (Cotton) | |
| 19-51A | DuPont | Introduction of a variant form of acetolactate | Gossypium | WO |
| | Canada | synthase (ALS). | hirsutum | 2006/128570 |
| | Agricultural | | L. (Cotton) | |
| | Products | | | |
| 281-24- | DOW | Insect-resistant cotton produced by inserting | Gossypium | |
| 236 | AgroSciences | the cry1F gene from Bacillus | hirsutum | |
| | LLC | thuringiensisvar. aizawai. The PAT | L. (Cotton) | |
| | | encoding gene from Streptomyces | | |
| | | viridochromogenes was introduced as a | | |
| | | selectable marker. | | |
| T227-1 | SES | Glyphosate tolerance; US 2004-117870 | Beta vulgaris | |
| | EUROPE | | (sugar beet) | |
| | N.V./S.A | | | |
| 3006- | DOW | Insect-resistant cotton produced by inserting | Gossypium | US 2004- |
| 210-23 | AgroSciences | the cry1Ac gene from Bacillus | hirsutum | 117870 |
| | LLC | thuringiensissubsp. kurstaki. The PAT | L. (Cotton) | |
| | | encoding gene from Streptomyces | | |
| | | viridochromogenes was introduced as a | | |
| | | selectable marker. | | |
| 31807/3 | Calgene | Insect-resistant and bromoxynil herbicide | Gossypium | |
| 1808 | Inc. | tolerant cotton produced by inserting the | hirsutum | |
| | | cry1Ac gene from Bacillus thuringiensis and | L. (Cotton) | |
| | | a nitrilase encoding gene from Klebsiella | | |
| | | pneumoniae. | | |
| BXN | Calgene | Bromoxynil herbicide tolerant cotton | Gossypium | |
| | Inc. | produced by inserting a nitrilase encoding | hirsutum | |
| | | gene from Klebsiella pneumoniae. | L. (Cotton) | |
| CE43- | Syngenta | Insect resistance (Cry1Ab); WO | Gossypium | |
| 67B | Participations | 2006/128573 | hirsutum | |
| | AG | | L. (Cotton) | |
| CE44- | Syngenta | Insect resistance (Cry1Ab); WO | Gossypium | WO |
| 69D | Participations | 2006/128571 | hirsutum | 2006/128573, |
| | AG | | L. (Cotton) | US |
| | | | | 2011020828 |
| CE46- | Syngenta | Insect resistance (Cry1Ab); WO | Gossypium | WO |
| 02A | Participations | 2006/128572 | hirsutum | 2006/128571 |
| | AG | | L. (Cotton) | |
| Cot102 | Syngenta | Insect-resistant cotton produced by inserting | Gossypium | WO |
| | Seeds, Inc. | the vip3A(a) gene from Bacillus | hirsutum | 2006/128572 |
| | | thuringiensisAB88. The APH4 encoding | L. (Cotton) | |
| | | gene from E. coli was introduced as a | | |
| | | selectable marker.; US 2006-130175 | | |
| COT20 | Syngenta | Insect resistance (VIP3A); US2009181399 | Gossypium | US 2006- |
| 2 | Seeds, Inc. | | hirsutum | 130175, |
| | | | L. (Cotton) | WO2004039986, |
| | | | | US |
| | | | | 2010298553 |
| Cot67B | Syngenta | Insect-resistant cotton produced by inserting | Gossypium | — |
| | Seeds, Inc. | a full-length cry1Ab gene from Bacillus | hirsutum | |
| | | thuringiensis. The APH4 encoding gene | L. (Cotton) | |
| | | from E. coli was introduced as a selectable | | |
| | | marker. | | |
| 23-18- | Monsanto | High laurate (12:0) and myristate (14:0) | Brassica | |
| 17, 23- | Company | canola produced by inserting a thioesterase | napus | |
| 198 | (formerly | encoding gene from the California bay laurel | (Argentine | |
| | Calgene) | (Umbellularia californica). | Canola) | |
| DAS- | DOW | WideStrike ™, a stacked insect-resistant | Gossypium | |
| 21Ø23- | AgroSciences | cotton derived from conventional cross- | hirsutum | |
| 5 x | LLC | breeding of parental lines 3006-210-23 | L. (Cotton) | |
| DAS- | | (OECD identifier: DAS-21Ø23-5) and 281- | | |
| 24236- | | 24-236 (OECD identifier: DAS-24236-5). | | |
| 5 | | | | |
| DAS- | DOW | Stacked insect-resistant and glyphosate- | Gossypium | |
| 21023- | AgroSciences | tolerant cotton derived from conventional | hirsutum | |
| 5 x | LLC | cross-breeding of WideStrike cotton (OECD | L. (Cotton) | |
| DAS- | and | identifier: DAS-21Ø23-5 x DAS-24236-5) | | |
| 24236- | Pioneer | with MON88913, known as RoundupReady | | |
| 5 x | Hi-Bred | Flex (OECD identifier: MON-88913-8). | | |
| MON8 | International | | | |
| 8913 | Inc. | | | |
| DAS- | DOW | WideStrikeT ™/Roundup Ready ® cotton, a | Gossypium | |
| 21Ø23- | AgroSciences | stacked insect-resistant and glyphosate- | hirsutum | |
| 5 x | LLC | tolerant cotton derived from conventional | L. (Cotton) | |
| DAS- | | cross-breeding of WideStrike cotton (OECD | | |
| 24236- | | identifier: DAS-21Ø23-5 x DAS-24236-5) | | |
| 5 x | | with MON1445 (OECD identifier: MON- | | |
| MON- | | Ø1445-2). | | |
| Ø1445- | | | | |
| 2 | | | | |
| EE- | BAYER | Glyphosate tolerance; WO 2007/017186 | Gossypium | |
| GH3 | BIOSCIENCE | | hirsutum | |
| | NV | | L. (Cotton) | |
| EE- | BAYER | Insect resistance (Cry1Ab); WO | Gossypium | WO |
| GH5 | BIOSCIENCE | 2008/122406 | hirsutum | 2007/017186 |
| | NV | | L. (Cotton) | |
| EE- | BAYER | Insect resistance (cry2Ae); WO2008151780 | Gossypium | WO |
| GH6 | BIOSCIENCE | | hirsutum | 2008/122406 |
| | NV | | L. (Cotton) | |
| event | DOW | Insect resistance (Cry1F); WO 2005/103266 | Gossypium | WO2008151780, |
| 281-24- | AgroSciences | | hirsutum | US2010218281 |
| 236 | LLC | | L. (Cotton) | |
| Event-1 | JK Agri | Insect-resistant cotton produced by inserting | Gossypium | WO |
| | Genetics | the cry1Ac gene from Bacillus thuringiensis | hirsutum | 2005/103266 |
| | Ltd (India) | subsp. kurstaki HD-73 (B.t.k.). | L. (Cotton) | |
| event30 | DOW | Insect resistance (Cry1Ac); WO | Gossypium | |
| 06-210- | AgroSciences | 2005/103266 | hirsutum | |
| 23 | LLC | | L. (Cotton) | |
| GBH61 | Bayer | Glyphosate herbicide tolerant cotton | Gossypium | WO |
| 4 | CropScience | produced by inserting 2mepsps gene into | hirsutum | 2005/103266 |
| | (Avents | variety Coker312 by Agrobacterium under | L. (Cotton) | |
| | CropSciience | the control of Ph4a748At and TPotpC | | |
| | (AgrEvo)) | | | |
| 45A37, | Pioneer | High oleic acid and low linolenic acid | Brassica | |
| 46A40 | Hi-Bred | canola produced through a combination of | napus | |
| | International | chemical mutagenesis to select for a fatty | (Argentine | |
| | Inc. | acid desaturase mutant with elevated oleic | Canola) | |
| | | acid, and traditional back-crossing to | | |
| | | introduce the low linolenic acid trait. | | |
| LLCott | Bayer | Glufosinate ammonium herbicide tolerant | Gossypium | |
| on25 | CropScience | cotton produced by inserting a modified | hirsutum | |
| | (Aventis | phosphinothricin acetyltransferase (PAT) | L. (Cotton) | |
| | CropScience | encoding gene from the soil bacterium | | |
| | (AgrEvo)) | Streptomyces hygroscopicus; WO | | |
| | | 2003013224, WO 2007/017186 | | |
| LLCott | Bayer | Stacked herbicide tolerant and insect | Gossypium | WO |
| on25 x | CropScience | resistant cotton combining tolerance to | hirsutum | 2003013224, |
| MON1 | (Aventis | glufosinate ammonium herbicide from | L. (Cotton) | WO |
| 5985 | CropScience | LLCotton25 (OECD identifier: ACS- | | 2007/017186 |
| | (AgrEvo)) | GHØØ1-3) with resistance to insects from | | |
| | | MON15985 (OECD identifier: MON- | | |
| | | 15985-7) | | |
| MON | MONSANTO | Insect resistance (Cry1A/Cry2Ab); US | Gossypium | |
| 15985 | TECHNOL- | 2004-250317 | hirsutum | |
| | OGY | | L. (Cotton) | |
| | LLC | | | |
| MON1 | Monsanto | Glyphosate herbicide tolerant cotton | Gossypium | US 2004- |
| 445/169 | Company | produced by inserting a naturally glyphosate | hirsutum | 250317 |
| 8 | | tolerant form of the enzyme 5-enolpyruvyl | L. (Cotton) | |
| | | shikimate-3-phosphate synthase (EPSPS) | | |
| | | from A. tumefaciens strain CP4. | | |
| MON1 | Monsanto | Stacked insect resistant and glyphosate | Gossypium | |
| 5985 x | Company | tolerant cotton produced by conventional | hirsutum | |
| MON8 | | cross-breeding of the parental lines | L. (Cotton) | |
| 8913 | | MON88913 (OECD identifier: MON- | | |
| | | 88913-8) and 15985 (OECD identifier: | | |
| | | MON-15985-7). Glyphosate tolerance is | | |
| | | derived from MON88913 which contains | | |
| | | two genes encoding the enzyme 5- | | |
| | | enolypyruvylshikimate-3-phosphate | | |
| | | synthase (EPSPS) from the CP4 strain of | | |
| | | Agrobacterium tumefaciens. Insect | | |
| | | resistance is derived MON15985 which was | | |
| | | produced by transformation of the DP50B | | |
| | | parent variety, which contained event 531 | | |
| | | (expressing Cry1Ac protein), with purified | | |
| | | plasmid DNA containing the cry2Ab gene | | |
| | | from B. thuringiensis subsp. kurstaki. | | |
| MON- | Monsanto | Stacked insect resistant and herbicide | Gossypium | |
| 15985- | Company | tolerant cotton derived from conventional | hirsutum | |
| 7 x | | cross-breeding of the parental lines 15985 | L. (Cotton) | |
| MON- | | (OECD identifier: MON-15985-7) and | | |
| Ø1445- | | MON1445 (OECD identifier: MON-Ø1445- | | |
| 2 | | 2). | | |
| MONS | Monsanto | Insect-resistant cotton produced by inserting | Gossypium | |
| 31/757/ | Company | the cry1Ac gene from Bacillus thuringiensis | hirsutum | |
| 1076 | | subsp. kurstaki HD-73 (B.t.k.). | L. (Cotton) | |
| MON8 | Monsanto | Glyphosate herbicide tolerant cotton | Gossypium | |
| 8913 | Company | produced by inserting two genes encoding | hirsutum | |
| | | the enzyme 5-enolypyruvylshikimate-3- | L. (Cotton) | |
| | | phosphate synthase (EPSPS) from the CP4 | | |
| | | strain of Agrobacterium tumefaciens,; WO | | |
| | | 2004/072235 | | |
| MON- | Monsanto | Stacked insect resistant and herbicide | Gossypium | WO |
| ØØ531- | Company | tolerant cotton derived from conventional | hirsutum | 2004/072235 |
| 6 x | | cross-breeding of the parental lines | L. (Cotton) | |
| MON- | | MON531 (OECD identifier: MON-00531- | | |
| Ø1445- | | 6) and MON1445 (OECD identifier: MON- | | |
| 2 | | Ø1445-2). | | |
| 46A12, | Pioneer | Combination of chemical mutagenesis, to | Brassica | |
| 46A16 | Hi-Bred | achieve the high oleic acid trait, and | napus | |
| | International | traditional breeding with registered canola | (Argentine | |
| | Inc. | varieties. | Canola) | |
| PV- | MONSANTO | Glyphosate tolerance; US 2004-148666 | Gossypium | |
| GHGT0 | TECHNOL- | | hirsutum | |
| 7 | OGY | | L. (Cotton) | |
| (1445) | LLC | | | |
| T304- | BAYER | Insect-resistance (Cry1Ab); | Gossypium | US 2004- |
| 40 | BIOSCIENCE | WO2008/122406 | hirsutum | 148666 |
| | NV | | L. (Cotton) | |
| T342- | Syngenta | Insect resistance (Cry1Ab); WO | Gossypium | WO2008/122406, |
| 142 | Participations | 2006/128568 | hirsutum | US2010077501 |
| | AG | | L. (Cotton) | |
| X81359 | BASF Inc. | Tolerance to imidazolinone herbicides by | Helianthus | WO |
| | | selection of a naturally occurring mutant. | annuus | 2006/128568 |
| | | | (Sunflower) | |
| RH44 | BASF Inc. | Selection for a mutagenized version of the | Lens | |
| | | enzyme acetohydroxyacid synthase (AHAS)(AHAS), | culinaris | |
| | | also known as acetolactate synthase (ALS) | (Lentil) | |
| | | or acetolactate pyruvate-lyase. | | |
| FP967 | University | A variant form of acetolactate synthase | Linum | |
| | of | (ALS) was obtained from a chlorsulfuron | usitatissimum | |
| | Saskatchewan, | tolerant line of A. thaliana and used to | L. (Flax, | |
| | Crop | transform flax. | Linseed) | |
| | Dev. | | | |
| | Centre | | | |
| 5345 | Monsanto | Resistance to lepidopteran pests through the | Lycopersicon | |
| | Company | introduction of the cry1Ac gene from | esculentum | |
| | | Bacillus thuringiensis subsp. Kurstaki. | (Tomato) | |
| 8338 | Monsanto | Introduction of a gene sequence encoding | Lycopersicon | |
| | Company | the enzyme 1-amino-cyclopropane-1- | esculentum | |
| | | carboxylic acid deaminase (ACCd) that | (Tomato) | |
| | | metabolizes the precursor of the fruit | | |
| | | ripening hormone ethylene. | | |
| 1345-4 | DNA Plant | Delayed ripening tomatoes produced by | Lycopersicon | |
| | Technology | inserting an additional copy of a truncated | esculentum | |
| | Corporation | gene encoding 1-aminocyclopropane-1- | (Tomato) | |
| | | carboxyllic acid (ACC) synthase, which | | |
| | | resulted in downregulation of the | | |
| | | endogenous ACC synthase and reduced | | |
| | | ethylene accumulation. | | |
| 35 1 N | Agritope | Introduction of a gene sequence encoding | Lycopersicon | |
| | Inc. | the enzyme S-adenosylmethionine hydrolase | esculentum | |
| | | that metabolizes the precursor of the fruit | (Tomato) | |
| | | ripening hormone ethylene | | |
| 127 | BASF | ALS/AHAS inhibitor-tolerance | Glycine max | |
| | AGROCHE- | | L. (Soybean) | |
| | MICAL | | | |
| | PRODUCTS | | | |
| | B.V. | | | |
| 5307 | Syngenta | Insect (corn rootworm) resistance (FR8a) | Zea mays | WO2010080829 |
| | Participations | | L. (Maize) | |
| | AG | | | |
| 17053 | MONSANTO | Glyphosate tolerance | Oryza | WO2010077816 |
| | TECHNOL- | | sativa (Rice) | |
| | OGY | | | |
| | LLC | | | |
| 17314 | BAYER | Glyphosate tolerance | Oryza | WO2010117737 |
| | BIOSCIENCE | | sativa (Rice) | |
| | NV | | | |
| 3560.4. | Pioneer | Glyphosate/ALS inhibitor-tolerance | Glycine max | WO2010117735 |
| 3.5 | Hi-Bred | | L. (Soybean) | |
| | International | | | |
| | Inc. | | | |
| A2704- | BAYER | Glufosinate tolerance | Glycine max | WO |
| 12 | BIOSCIENCE | | L. (Soybean) | 2008002872, |
| | NV | | | US2010184079 |
| A5547- | BAYER | Glufosinate tolerance | Glycine max | WO |
| 35 | BIOSCIENCE | | L. (Soybean) | 2006/108674 |
| | NV | | | |
| GM | Syngenta | Beet Necrotic Yellow Vein Virus (BNYVV) | Beta vulgaris | WO |
| RZ13 | Participations | resistance | (sugar beet) | 2006/108675 |
| | AG | | | |
| JOPLI | Syngenta | disease (fungal) resistance (trichothecene 3- | Wheat | WO2010076212 |
| N1 | Participations | O-acetyltransferase) | | |
| | AG | | | |
| LLcotto | BAYER | Glufosinate resistance | Gossypium | US |
| n25 | BIOSCIENCE | | hirsutum | 2008064032 |
| | NV | | L. (Cotton) | |
| MS-B2 | AVENTIS | Male sterility | Brassica (A | WO |
| | CROPSCIENCE | | genome) | 2003013224 |
| | N.V. | | | |
| MS- | AVENTIS | Male sterility/restoration | Brassica | WO 01/31042 |
| BN1/R | CROPSCIENCE | | (napus) | |
| F-BN1 | N.V. | | | |
| RT73 | MONSANTO | Glyphosate resistance | Brassica | WO 01/41558 |
| | TECHNOL- | | (napus) | |
| | OGY | | | |
| | LLC | | | |
| Kefeng | CHINA | Transgenic rice Kefeng 6 is a transformation | Oryza | WO 02/36831 |
| No. 6 | NAT | event containing two insect-resistant genes, | sativa (Rice) | |
| | RICE RES | cry1Ac and SCK (modified CpTI gene) in | | |
| | INST | China. | | |
| E6611. | Pioneer | 1) MS45: anther-specific 5126 (Zea mays) | zea mays | CN 101824411 |
| 32.1.38/ | Hi-Bred | promoter > fertility restoration Ms45 (Zea | L. (Maize) | |
| DP- | International | mays) coding sequence > fertility restoration | | |
| 32138- | Inc. | Ms45 (Zea mays) 3′-untranslated region 2) | | |
| 1/ | | ZM-AA1: polygalacturonase 47 (Zea mays) | | |
| 32138 | | promoter > brittle-1 (Zea mays) chloroplast | | |
| | | transit peptide > alpha-amylase-1 (Zea | | |
| | | mays) truncated coding sequence >> In2-1 | | |
| | | (Zea mays) 3′-untranslated region 3) | | |
| | | DSRED2: 35S (Cauliflower Mosaic Virus) | | |
| | | enhancer > lipid transfer protein-2 | | |
| | | (Hordeum vulgare) promoter > red | | |
| | | fluorescent protein (Dicosoma sp.) variant | | |
| | | coding sequence > protein inhibitor II | | |
| | | (Solanum tuberosum) 3′-untranslated region | | |
| DAS- | DOW | RB7 MARv3 > zmUbiquitin 1 | Zea mays | WO |
| 40278- | AgroSciences | promoter > aad1 > zmPER5 3′UTR > RB 7 | L. (Maize) | 2009103049, |
| 9 | LLC | MARv4. The aad-1 gene confers tolerance | | MX |
| | | to 2,4-dichlorophenoxyacetic acid and | | 2010008977 |
| | | aryloxyphenoxypropionate (commonly | | |
| | | referred to as “fop” herbicides such as | | |
| | | quizalofop) herbicides | | |
| MIR60 | Syngenta | 1) CRY3A: metallotionin-like gene (Zea | Zea mays | WO 2011022469 |
| 4 | Participations | mays) promoter > delta-endotoxin cry3a | L. (Maize) | |
| | AG | (Bacillus thuringiensis subsp. tenebrionis) | | |
| | | coding sequence, modified to include a | | |
| | | cathepsin-G protease recognition site and | | |
| | | maize codon optimized > nopaline synthase | | |
| | | (Agrobacterium tumefaciens) 3′-untranslated | | |
| | | region 2) PMI: polyubiquitin (Zea mays) | | |
| | | promoter (incl. first intron) > mannose-6- | | |
| | | phosphate isomerase (Escherichia coli) | | |
| | ′ | coding sequence > nopaline synthase | | |
| | | (Agrobacterium tumefaciens) 3′-untranslated | | |
| | | region | | |
| MON | MONSANTO | Dicamba herbicide tolerance, transformation | Glycine max | US |
| 87708 | TECHNOL- | vector PV-GMHT4355 1) DMO: full length | L. (Soybean) | 2005216970, |
| | OGY | transcript (Peanut Chlorotic Streak Virus) | | US |
| | LLC | promoter > tobacco Etch Virus leader > | | 2008167456, |
| | | ribulose 1,5-biphosphate carboxylase small | | US |
| | | subunit (Pisum sativum) chloroplast transit | | 2011111420 |
| | | peptide > dicamba mono-oxygenase | | |
| | | (Stenotrophomonas maltophilia) coding | | |
| | | sequence > ribulose-1,5-bisphosphate | | |
| | | carboxylase small subunit E9 (Pisum | | |
| | | sativum) 3′-untranslated region. A CP4 | | |
| | | epsps chimeric gene contained within a | | |
| | | second T-DNA on the transformation vector | | |
| | | used was segregated away. | | |
| MON | MONSANTO | The transgene insert and expression cassette | Zea mays | WO 2011034704 |
| 87427 | TECHNOL- | of MON 87427 comprises the promoter and | L. (Maize) | |
| | OGY | leader from the cauliflower mosaic virus | | |
| | LLC | (CaMV) 35 S containing a duplicated | | |
| | | enhancer region (P-e35S); operably linked to | | |
| | | a DNA leader derived from the first intron | | |
| | | from the maize heat shock protein 70 gene | | |
| | | (I-HSP70); operably linked to a DNA | | |
| | | molecule encoding an N-terminal | | |
| | | chloroplast transit peptide from the shkG | | |
| | | gene from Arabidopsis thaliana EPSPS (Ts- | | |
| | | CTP2); operably linked to a DNA molecule | | |
| | | derived from the aroA gene from the | | |
| | | Agrobacterium sp. strain CP4 and encoding | | |
| | | the CP4 EPSPS protein; operably linked to a | | |
| | | 3′ UTR DNA molecule derived from the | | |
| | | nopaline synthase (T-NOS) gene from | | |
| | | Agrobacterium tumefaciens . | | |
| EE- | BAYER | 1) Ph4a748 ABBC: sequence including the | Glycine max | WO |
| GM3/ | BIOSCIENCE | promoter region of the histone H4 gene of | L. (Soybean) | 2011062904 |
| FG72 | NV | Arabidopsis thaliana, containing an internal | | |
| | [BE]; MS | duplication > 5′tev: sequence including the | | |
| | TECHNOL- | leader sequence of the tobacco etch | | |
| | OGIES | virus > TPotp Y: coding sequence of an | | |
| | LLC [US] | optimized transit peptide derivative (position | | |
| | | 55 changed into Tyrosine), containing | | |
| | | sequence of the RuBisCO small subunit | | |
| | | genes of Zea mays (corn) and Helianthus | | |
| | | annuus (sunflower) > hppdPf W336: the | | |
| | | coding sequence of the 4- | | |
| | | hydroxyphenylpyruvate dioxygenase of | | |
| | | Pseudomonas fluorescens strain A32 | | |
| | | modified by the replacement of the amino | | |
| | | acid Glycine 336 with a Tryptophane > 3′nos: | | |
| | | sequence including the 3′ untranslated | | |
| | | region of the nopaline synthase gene from | | |
| | | the T-DNA of pTiT37 of Agrobacterium | | |
| | | tumefaciens. 2) Ph4a748: sequence | | |
| | | including the promoter region of the histone | | |
| | | H4 gene of Arabidopsis thaliana > intron1 | | |
| | | h3At: first intron of gene II of the histone | | |
| | | H3.III variant of Arabidopsis thaliana | | |
| | | >TPotp C: coding sequence of the optimized | | |
| | | transit peptide, containing sequence of the | | |
| | | RuBisCO small subunit genes of Zea mays | | |
| | | (corn) and Helianthus annuus | | |
| | | (sunflower) > 2mepsps: the coding sequence | | |
| | | of the double-mutant 5-enol- | | |
| | | pyruvylshikimate-3-phosphate synthase | | |
| | | gene of Zea mays > 3′histonAt: sequence | | |
| | | including the 3′ untranslated region of the | | |
| | | histone H4 gene of Arabidopsis thaliana | | |
| 416/ | DOW | A novel aad-12 transformation event for | Glycine max | WO 2011063411 |
| pDAB4 | AGRO- | herbicide tolerance in soybean plants- | L. (Soybean) | |
| 468- | SCIENCES | referred to herein as pDAB4468-0416. The | | |
| 0416 | LLC | aad-12 gene (originally from Delftia | | |
| | | acidovorans) encodes the aryloxyalkanoate | | |
| | | dioxygenase (AAD-12) protein. The trait | | |
| | | confers tolerance to 2,4- | | |
| | | dichlorophenoxyacetic acid, for example, | | |
| | | and to pyridyloxyacetate herbicides. The | | |
| | | aad-12 gene, itself, for herbicide tolerance in | | |
| | | plants was first disclosed in WO | | |
| | | 2007/053482. | | |
| DP- | Pioneer | cry1F, cry34Ab1, cry35Ab1, and pat: | Zea mays | WO |
| 004114 | Hi-Bred | resistance to certain lepidopteran and | L. (Maize) | 2011066384 |
| 3 | International | coleopteran pests, as well as tolerance to | | |
| | Inc. | phosphinothricin. | | |
| DP- | Pioneer | Cry1F, cry34Ab1, cry35Ab1, pat: resistance | Zea mays | US 2011154523 |
| 032316- | Hi-Bred | to certain lepidopteran and coleopteran | L. (Maize) | |
| 8 | International | pests, as well as tolerance to | | |
| | Inc. | phosphinothricin | | |
| DP- | Pioneer | Cry1F, cry34Ab1, cry35Ab1, pat: resistance | Zea mays | US 2011154524 |
| 040416- | Hi-Bred | to certain lepidopteran and coleopteran | L. (Maize) | |
| 8 a | International | pests, as well as tolerance to | | |
| | Inc. | phosphinothricin | | |
| DP- | Pioneer | Cry1F, cry34Ab1, cry35Ab1, pat: resistance | Zea mays | US20110154525 |
| 043A47- | Hi-Bred | to certain lepidopteran and coleopteran | L. (Maize) | US20110154526 |
| 3 | International | pests, as well as tolerance to | | |
| | Inc. | phosphinothricin | | |
| DP- | PIONEER | The invention provides DNA compositions | maize | WO2011/08462 |
| 004114- | HI-BRED | that relate to transgenic insect resistant | | 1A1 |
| 3 | INTERNA- | maize plants. Also provided are assays for | | |
| | TIONAL, | detecting the presence of the maize DP- | | |
| | INC./E.I. | 004114-3 event based on the DNA sequence | | |
| | DU PONT | of the recombinant construct inserted into | | |
| | DE | the maize genome and the DNA sequences | | |
| | NEMOURS | flanking the insertion site. Kits and | | |
| | AND | conditions useful in conducting the assays | | |
| | COMPANY | are provided. | | |
| DP- | PIONEER | The invention provides DNA compositions | maize | WO2011/084632 |
| 032316- | HI-BRED | that relate to transgenic insect resistant | | |
| 8 | INTERNA- | maize plants. Also provided are assays for | | |
| | TIONAL, | detecting the presence of the maize DP- | | |
| | INC./E.I. | 032316-8 event based on the DNA sequence | | |
| | DU PONT | of the recombinant construct inserted into | | |
| | DE | the maize genome and the DNA sequences | | |
| | NEMOURS | flanking the insertion site. Kits and | | |
| | AND | conditions useful in conducting the assays | | |
| | COMPANY | are provided. | | |
| MON- | MONSANTO | The invention provides plants comprising | brassica | WO2011/153186 |
| 88302- | TECHNOL- | transgenic event MON 88302 that exhibit | | |
| 9 | OGY | tolerance to glyphosate herbicide. The | | |
| | LLC | invention also provides seeds, plant parts, | | |
| | | cells, commodity products, and methods | | |
| | | related to the event. The invention also | | |
| | | provides DNA molecules that are unique to | | |
| | | the event and were created by the insertion | | |
| | | of transgenic DNA into the genome of a | | |
| | | Brassica napus plant. | | |
| SYN- | SYNGENTA | Soybean plants comprising event | soybean | WO2012/08254 |
| 000H2- | PARTICI- | SYHT0H2, methods of detecting and using | | 8A2 |
| 5 | PATIONS | the same, and soybean plants comprising a | | |
| | AG | heterologous insert at the same site as | | |
| | | SYHT0H2. | | |
| DAS- | DOW | This invention relates to soybean event | soybean | WO2012/07542 |
| 14536- | AGRO- | pDAB8291.45.36.2, which includes a novel | | 9A1 |
| 7 | SCIENCES | expression cassette comprising multiple | | |
| | LLC; MS | traits conferring resistance to glyphosate, | | |
| | TECHNOL- | aryloxyalkanoate, and glufosinate | | |
| | OGIES | herbicides. This invention also relates in part | | |
| | LLC | to methods of controlling resistant weeds, | | |
| | | plant breeding, and herbicide tolerant plants. | | |
| | | In some embodiments, the event sequence | | |
| | | can be “stacked” with other traits, including, | | |
| | | for example, other herbicide tolerance | | |
| | | gene(s) and/or insect-inhibitory proteins. | | |
| | | This invention further relates in part to | | |
| | | detection methods, including endpoint | | |
| | | TaqMan PCR assays, for the detection of | | |
| | | Event pDAB8291.45.36.2 in soybeans and | | |
| | | related plant material. Some embodiments | | |
| | | can perform high throughput zygosity | | |
| | | analysis of plant material and other | | |
| | | embodiments can be used to uniquely | | |
| | | identify the zygosity of and breed soybean | | |
| | | lines comprising the event of the subject | | |
| | | invention. Kits and conditions useful in | | |
| | | conducting these assays are also provided. | | |
| DAS- | DOW | This invention relates in part to soybean | soybean | WO2012/07542 |
| 44406- | AGRO- | event pDAB8264.44.06.1 and includes a | | 6A1 |
| 6 | SCIENCES | novel expression cassettes and transgenic | | |
| | LLC; MS | inserts comprising multiple traits conferring | | |
| | TECHNOL- | resistance to glyphosate, aryloxyalkanoate, | | |
| | OGIES | and glufosinate herbicides. This invention | | |
| | LLC | also relates in part to methods of controlling | | |
| | | resistant weeds, plant breeding and herbicide | | |
| | | tolerant plants. In some embodiments, the | | |
| | | event sequence can be “stacked” with other | | |
| | | traits, including, for example, other | | |
| | | herbicide tolerance gene(s) and/or insect- | | |
| | | inhibitory proteins. This invention further | | |
| | | relates in part to endpoint TaqMan PCR | | |
| | | assays for the detection of Event | | |
| | | pDAB8264.44.06.1 in soybeans and related | | |
| | | plant material. Some embodiments can | | |
| | | perform high throughput zygosity analysis | | |
| | | of plant material and other embodiments can | | |
| | | be used to uniquely identify the zygosity of | | |
| | | and breed soybean lines comprising the | | |
| | | event of the subject invention. Kits and | | |
| | | conditions useful in conducting these assays | | |
| | | are also provided. | | |
| MON- | MONSANTO | The present invention provides a transgenic | soybean | WO2012/05119 |
| 87712- | TECHNOL- | soybean comprising event MON87712 that | | 9A2 |
| 4 | OGY | exhibits increased yield. The invention also | | |
| | LLC | provides cells, plant parts, seeds, plants, | | |
| | | commodity products related to the event, | | |
| | | and DNA molecules that are unique to the | | |
| | | event and were created by the insertion of | | |
| | | transgenic DNA into the genome of a | | |
| | | soybean plant. The invention further | | |
| | | provides methods for detecting the presence | | |
| | | of said soybean event nucleotide sequences | | |
| | | in a sample, probes and primers for use in | | |
| | | detecting nucleotide sequences that are | | |
| | | diagnostic for the presence of said soybean | | |
| | | event. | | |
| DAS | DOW | This invention relates to soybean event | soybean | WO2012/03379 |
| 21606- | AGRO- | pDAB4472-1606 (Event 1606). This | | 4A2 |
| 3 | SCIENCES | invention includes a novel aad-12 | | |
| | LLC | transformation event in soybean plants | | |
| | | comprising a polynucleotide sequence, as | | |
| | | described herein, inserted into a specific site | | |
| | | within the genome of a soybean cell. This | | |
| | | invention also relates in part to plant | | |
| | | breeding and herbicide tolerant plants. In | | |
| | | some embodiments, said event/ | | |
| | | polynucleotide sequence can be “stacked” | | |
| | | with other traits, including, for example, | | |
| | | other herbicide tolerance gene(s) and/or | | |
| | | insect-inhibitory proteins. | | |
| DP- | PIONEER | Compositions and methods related to | Brassica | WO201204926 |
| 061061- | HI-BRED | transgenic glyphosate tolerant Brassica | | 8A1 |
| 7 | INTERNA- | plants are provided. Specifically, the present | | |
| | TIONAL | invention provides Brassica plants having a | | |
| | INC. | DP-061061-7 event which imparts tolerance | | |
| | | to glyphosate. The Brassica plant harboring | | |
| | | the DP-061061-7 event at the recited | | |
| | | chromosomal location comprises | | |
| | | genomic/transgene junctions within SEQ ID | | |
| | | NO: 2 or with genomic/transgene transgene junctions | | |
| | | as set forth in SEQ ID NO: 12 and/or 13. | | |
| | | The characterization of the genomic | | |
| | | insertion site of events provides for an | | |
| | | enhanced breeding efficiency and enables | | |
| | | the use of molecular markers to track the | | |
| | | transgene insert in the breeding populations | | |
| | | and progeny thereof. Various methods and | | |
| | | compositions for the identification, | | |
| | | detection, and use of the events are | | |
| | | provided. | | |
| DP- | PIONEER | Compositions and methods related to | Brassica | WO201204966 |
| 073496- | HI-BRED | transgenic glyphosate tolerant Brassica | | 1A1 |
| 4 | INTERNA- | plants are provided. Specifically, the present | | |
| | TIONAL | invention provides Brassica plants having a | | |
| | INC. | DP-073496-4 event which imparts tolerance | | |
| | | to glyphosate. The Brassica plant harboring | | |
| | | the DP-073496-4 event at the recited | | |
| | | chromosomal location comprises | | |
| | | genomic/transgene junctions within SEQ ID | | |
| | | NO: 2 or with genomic/transgene junctions | | |
| | | as set forth in SEQ ID NO: 12 and/or 13. | | |
| | | The characterization of the genomic | | |
| | | insertion site of the event provides for an | | |
| | | enhanced breeding efficiency and enables | | |
| | | the use of molecular markers to track the | | |
| | | transgene insert in the breeding populations | | |
| | | and progeny thereof. Various methods and | | |
| | | compositions for the identification, | | |
| | | detection, and use of the event are provided. | | |
| 8264.44. | DOW | This invention relates in part to soybean | Soybean | WO201205246 |
| 06.1 | AGRO- | event pDAB8264.44.06.1 and includes a | | 8A2 |
| | SCIENCES | novel expression cassettes and transgenic | | |
| | LLC; MS | inserts comprising multiple traits conferring | | |
| | TECHNOL- | resistance to glyphosate, aryloxyalkanoate, | | |
| | OGIES | and glufosinate herbicides. This invention | | |
| | LLC | also relates in part to methods of controlling | | |
| | | resistant weeds, plant breeding and herbicide | | |
| | | tolerant plants. In some embodiments, the | | |
| | | event sequence can be “stacked” with other | | |
| | | traits, including, for example, other | | |
| | | herbicide tolerance gene(s) and/or insect- | | |
| | | inhibitory proteins. This invention further | | |
| | | relates in part to endpoint TaqMan PCR | | |
| | | assays for the detection of Event | | |
| | | pDAB8264.44.06.1 in soybeans and related | | |
| | | plant material. Some embodiments can | | |
| | | perform high throughput zygosity analysis | | |
| | | of plant material and other embodiments can | | |
| | | be used to uniquely identify the zygosity of | | |
| | | and breed soybean lines comprising the | | |
| | | event of the subject invention. Kits and | | |
| | | conditions useful in conducting these assays | | |
| | | are also provided. | | |
| 8291.45. | DOW | This invention relates to soybean event | Soybean | WO201205598 |
| 36.2 | AGRO- | pDAB8291.45.36.2, which includes a novel | | 2A2 |
| | SCIENCES | expression cassette comprising multiple | | |
| | LLC; MS | traits conferring resistance to glyphosate, | | |
| | TECHNOL- | aryloxyalkanoate, and glufosinate | | |
| | OGIES | herbicides. This invention also relates in part | | |
| | LLC | to methods of controlling resistant weeds, | | |
| | | plant breeding, and herbicide tolerant plants. | | |
| | | In some embodiments, the event sequence | | |
| | | can be “stacked” with other traits, including, | | |
| | | for example, other herbicide tolerance | | |
| | | gene(s) and/or insect-inhibitory proteins. | | |
| | | This invention further relates in part to | | |
| | | detection methods, including endpoint | | |
| | | TaqMan PCR assays, for the detection of | | |
| | | Event pDAB8291.45.36.2 in soybeans and | | |
| | | related plant material. Some embodiments | | |
| | | can perform high throughput zygosity | | |
| | | analysis of plant material and other | | |
| | | embodiments can be used to uniquely | | |
| | | identify the zygosity of and breed soybean | | |
| | | lines comprising the event of the subject | | |
| | | invention. Kits and conditions useful in | | |
| | | conducting these assays are also provided. | | |
| SYHT0 | SYNGENTA | Soybean plants comprising event | soybean | WO2012/08254 |
| H2 | PARTICIPA- | SYHTOH2, methods of detecting and using | | 8A2 |
| | TIONS | the same, and soybean plants comprising a | | |
| | AG | heterologous insert at the same site as | | |
| | | SYHT0H2. | | |
| MON8 | MONSANTO | The invention provides cotton event MON | cotton | WO2012/13480 |
| 8701 | TECHNOL- | 88701, and plants, plant cells, seeds, plant | | 8A1 |
| | OGY | parts, and commodity products comprising | | |
| | LLC | event MON 88701. The invention also | | |
| | | provides polynucleotides specific for event | | |
| | | MON 88701 and plants, plant cells, seeds, | | |
| | | plant parts, and commodity products | | |
| | | comprising polynucleotides specific for | | |
| | | event MON 88701. The invention also | | |
| | | provides methods related to event MON | | |
| | | 88701. | | |
| KK179- | MONSANTO | The present invention provides a transgenic | alfalfa | WO201300355 |
| 2 | TECHNOL- | alfalfa event KK179-2. The invention also | | 8A1 |
| | OGY | provides cells, plant parts, seeds, plants, | | |
| | LLC ; | commodity products related to the event, | | |
| | FORAGE | and DNA molecules that are unique to the | | |
| | GENETICS | event and were created by the insertion of | | |
| | INTERNA- | transgenic DNA into the genome of a alfalfa | | |
| | TIONAL | plant. The invention further provides | | |
| | LLC | methods for detecting the presence of said | | |
| | | alfalfa event nucleotide sequences in a | | |
| | | sample, probes and primers for use in | | |
| | | detecting nucleotide sequences that are | | |
| | | diagnostic for the presence of said alfalfa | | |
| | | event. | | |
| pDAB8 | DOW | This invention relates to soybean event | soybean | WO201301009 |
| 264.42. | AGRO- | pDAB8264.42.32.1 and includes novel | | 4A1 |
| 32.1 | SCIENCES | expression cassettes and transgenic inserts | | |
| | LLC ; MS | comprising multiple traits conferring | | |
| | TECHNOL- | resistance to glyphosate, aryloxyalkanoate, | | |
| | OGIES | and glufosinate herbicides. This invention | | |
| | LLC | also relates in part to methods of controlling | | |
| | | resistant weeds, plant breeding and herbicide | | |
| | | tolerant plants. In some embodiments, the | | |
| | | event sequence can be “stacked” with other | | |
| | | traits, including, for example, other | | |
| | | herbicide tolerance gene(s) and/or insect- | | |
| | | inhibitory proteins. This invention further | | |
| | | relates in part to endpoint TAQMAN PCR | | |
| | | assays for the detection of Event | | |
| | | pDAB8264.42.32.1 in soybeans and related | | |
| | | plant material. Some embodiments can | | |
| | | perform high throughput zygosity analysis | | |
| | | of plant material and other embodiments can | | |
| | | be used to uniquely identify the zygosity of | | |
| | | and breed soybean lines comprising the | | |
| | | event of the subject invention. Kits and | | |
| | | conditions useful in conducting these assays | | |
| | | are also provided. | | |
| MZDT | SYNGNETA | A transgenic corn event designated | maize | WO201301277 |
| 09Y | PARTICIPA- | MZDTO9Y is disclosed. The invention | | 5A1 |
| | TIONS | relates to nucleic acids that are unique to | | |
| | AG | event MZDTO9Y and to methods of | | |
| | | detecting the presence of event MZDTO9Y | | |
| | | based on DNA sequences of the recombinant | | |
| | | constructs inserted into the corn genome that | | |
| | | resulted in the MZDTO9Y event and of | | |
| | | genomic sequences flanking the insertion | | |
| | | site. The invention further relates to corn | | |
| | | plants comprising the transgenic genotype of | | |
| | | event MZDTO9Y and to methods for | | |
| | | producing a corn plant by cross [symbol] ing a corn | | |
| | | plant comprising the MZDTO9Y genotype | | |
| | | with itself or another corn variety. Seeds of | | |
| | | corn plants comprising the MZDTO9Y | | |
| | | genotype are also objects of the invention. | | |

Plants that may be treated according to the invention are hybrid plants that already express the characteristic of heterosis or hybrid vigor which results in generally higher yield, vigor, health and resistance towards biotic and abiotic stresses). Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species (WO 92/05251, WO 95/09910, WO 98/27806, WO 05/002324, WO 06/021972 and U.S. Pat. No. 6,229,072). However, genetic determinants for male sterility can also be located in the nuclear genome. Male sterile plants can also be obtained by plant biotechnology methods such as genetic engineering. A particularly useful means of obtaining male-sterile plants is described in WO 89/10396 in which, for example, a ribonuclease such as barnase is selectively expressed in the tapetum cells in the stamens. Fertility can then be restored by expression in the tapetum cells of a ribonuclease inhibitor such as barstar (e.g. WO 91/02069).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-resistant plants are for example glyphosate-tolerant plants, i.e. plants made tolerant to the herbicide glyphosate or salts thereof. Plants can be made tolerant to glyphosate through different means. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Science 1983, 221, 370-371), the CP4 gene of the bacterium Agrobacterium sp. (Curr. Topics Plant Physiol. 1992, 7, 139-145), the genes encoding a Petunia EPSPS (Science 1986, 233, 478-481), a Tomato EPSPS (J. Biol. Chem. 1988, 263, 4280-4289), or an Eleusine EPSPS (WO 01/66704). It can also be a mutated EPSPS as described in for example EP 0837944, WO 00/66746, WO 00/66747 or WO 02/26995, WO 11/000498. Glyphosate-tolerant plants can also be obtained by expressing a gene that encodes a glyphosate oxido-reductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described in for example WO 02/036782, WO 03/092360, WO 05/012515 and WO 07/024782. Glyphosate-tolerant plants can also be obtained by selecting plants containing naturally-occurring mutations of the above-mentioned genes, as described in for example WO 01/024615 or WO 03/013226. Plants expressing EPSPS genes that confer glyphosate tolerance are described in e.g. U.S. patent application Ser. Nos. 11/517,991, 10/739,610, 12/139,408, 12/352,532, 11/312,866, 11/315,678, 12/421,292, 11/400,598, 11/651,752, 11/681,285, 11/605,824, 12/468,205, 11/760,570, 11/762,526, 11/769,327, 11/769,255, 11/943,801 or 12/362,774. Plants comprising other genes that confer glyphosate tolerance, such as decarboxylase genes, are described in e.g. U.S. patent application Ser. Nos. 11/588,811, 11/185,342, 12/364,724, 11/185,560 or 12/423,926.

Other herbicide resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition, e.g. described in U.S. patent application Ser. No. 11/760,602. One such efficient detoxifying enzyme is an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665.

Further herbicide-tolerant plants are also plants that are made tolerant to the herbicides inhibiting the enzyme hydroxyphenylpyruvatedioxygenase (HPPD). HPPD is an enzyme that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated or chimeric HPPD enzyme as described in WO 96/38567, WO 99/24585, WO 99/24586, WO 09/144079, WO 02/046387, U.S. Pat. No. 6,768,044, WO 11/076877, WO 11/076882, WO 11/076885, WO 11/076889. WO 11/076892. WO13/026740, WO13/092552, WO13/092551 or WO12/092555. Tolerance to HPPD-inhibitors can also be obtained by transforming plants with genes encoding certain enzymes enabling the formation of homogentisate despite the inhibition of the native HPPD enzyme by the HPPD-inhibitor. Such plants and genes are described in WO 99/34008 and WO 02/36787. Tolerance of plants to HPPD inhibitors can also be improved by transforming plants with a gene encoding an enzyme having prephenate deshydrogenase (PDH) activity in addition to a gene encoding an HPPD-tolerant enzyme, as described in WO 04/024928. Further, plants can be made more tolerant to HPPD-inhibitor herbicides by adding into their genome a gene encoding an enzyme capable of metabolizing or degrading HPPD inhibitors, such as the CYP450 enzymes shown in WO 07/103567 and WO 08/150473.

Still further herbicide resistant plants are plants that are made tolerant to acetolactate synthase (ALS) inhibitors. Known ALS-inhibitors include, for example, sulfonylurea, imidazolinone, triazolo-pyrimidines, pyrimidinyoxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright (Weed Science 2002, 50, 700-712), but also, in U.S. Pat. Nos. 5,605,011, 5,378,824, 5,141,870, and 5,013,659. The production of sulfonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and WO 96/33270. Other imidazolinone-tolerant plants are also described in for example WO 04/040012, WO 04/106529, WO 05/020673, WO 05/093093, WO 06/007373, WO 06/015376, WO 06/024351, and WO 06/060634. Further sulfonylurea- and imidazolinone-tolerant plants are also described in for example WO 07/024782, WO 2011/076345, WO 2012058223, WO 2012150335 and U.S. Patent Application 61/288,958.

Other plants tolerant to imidazolinone and/or sulfonylurea can be obtained by induced mutagenesis, selection in cell cultures in the presence of the herbicide or mutation breeding as described for example for soybeans in U.S. Pat. No. 5,084,082, for rice in WO 97/41218, for sugar beet in U.S. Pat. No. 5,773,702 and WO 99/057965, for lettuce in U.S. Pat. No. 5,198,599, or for sunflower in WO 01/065922.

Plants tolerant to 2,4 D or dicamba are for example described in U.S. Pat. No. 6,153,401.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al. (Microbiology and Molecular Biology Reviews 1998, 62, 807-813), updated by Crickmore et al. (2005) at the Bacillus thuringiensis toxin nomenclature, online at: http://www.lifesci.sussex.ac.uk/Home/Neil_Crickmore/Bt/), or insecticidal portions thereof, e.g., proteins of the Cry protein classes Cry1Ab, Cry1Ac, Cry1B, Cry1C, Cry1D, Cry1F, Cry2Ab, Cry3Aa, or Cry3Bb or insecticidal portions thereof (e.g. EP-A 1 999 141 and WO 07/107302), or such proteins encoded by synthetic genes as e.g. described in and U.S. patent application Ser. No. 12/249,016; or
2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins (Nat. Biotechnol. 2001, 19, 668-72; Applied Environm. Microbiol. 2006, 71, 1765-1774) or the binary toxin made up of the Cry1A or Cry1F proteins and the Cry2Aa or Cry2Ab or Cry2Ae proteins (U.S. patent application Ser. No. 12/214,022 and EP-A 2 300 618); or
3) a hybrid insecticidal protein comprising parts of different insecticidal crystal proteins from Bacillus thuringiensis, such as a hybrid of the proteins of 1) above or a hybrid of the proteins of 2) above, e.g., the Cry1A.105 protein produced by corn event MON89034 (WO 07/027777); or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604; or
5) an insecticidal secreted protein from Bacillus thuringiensis or Bacillus cereus, or an insecticidal portion thereof, such as the vegetative insecticidal (VIP) proteins listed at:
   http://www.lifesci.sussex.ac.uk/home/Neil_Crickmore/Bt/vip.html, e.g., proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 94/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of 5) to 7) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102; or
9) a secreted protein from Bacillus thuringiensis or Bacillus cereus which is insecticidal in the presence of a crystal protein from Bacillus thuringiensis, such as the binary toxin made up of VIP3 and Cry1A or Cry1F (U.S. Patent Applications 61/126,083 and 61/195,019), or the binary toxin made up of the VIP3 protein and the Cry2Aa or Cry2Ab or Cry2Ae proteins (U.S. patent application Ser. No. 12/214,022 and EP-A 2 300 618).
10) a protein of 9) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein)

Of course, an insect-resistant transgenic plant, as used herein, also includes any plant comprising a combination of genes encoding the proteins of any one of the above classes 1 to 10. In one embodiment, an insect-resistant plant contains more than one transgene encoding a protein of any one of the above classes 1 to 10, to expand the range of target insect species affected when using different proteins directed at different target insect species, or to delay insect resistance development to the plants by using different proteins insecticidal to the same target insect species but having a different mode of action, such as binding to different receptor binding sites in the insect.

An “insect-resistant transgenic plant”, as used herein, further includes any plant containing at least one transgene comprising a sequence producing upon expression a double-stranded RNA which upon ingestion by a plant insect pest inhibits the growth of this insect pest, as described e.g. in WO 07/080126, WO 06/129204, WO 07/074405, WO 07/080127 and WO 07/035650.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance. Particularly useful stress tolerance plants include:
1) plants which contain a transgene capable of reducing the expression and/or the activity of poly(ADP-ribose) polymerase (PARP) gene in the plant cells or plants as described in WO 00/04173, WO 06/045633, EP-A 1 807 519, or EP-A 2 018 431.
2) plants which contain a stress tolerance enhancing transgene capable of reducing the expression and/or the activity of the PARG encoding genes of the plants or plants cells, as described e.g. in WO 04/090140.
3) plants which contain a stress tolerance enhancing transgene coding for a plant-functional enzyme of the nicotinamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphoribosyltransferase as described e.g. in EP-A 1 794 306, WO 06/133827, WO 07/107326, EP-A 1 999 263, or WO 07/107326.

Plants or plant cultivars (obtained by plant biotechnology methods such as genetic engineering) which may also be treated according to the invention show altered quantity, quality and/or storage-stability of the harvested product and/or altered properties of specific ingredients of the harvested product such as:
1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesised starch in wild type plant cells or plants, so that this is better suited for special applications. Said transgenic plants synthesizing a modified starch are disclosed, for example, in EP-A 0 571 427, WO 95/04826, EP-A 0 719 338, WO 96/15248, WO 96/19581, WO 96/27674, WO 97/11188, WO 97/26362, WO 97/32985, WO 97/42328, WO 97/44472, WO 97/45545, WO 98/27212, WO 98/40503, WO 99/58688, WO 99/58690, WO 99/58654, WO 00/08184, WO 00/08185, WO 00/08175, WO 00/28052, WO 00/77229, WO 01/12782, WO 01/12826, WO 02/101059, WO 03/071860, WO 04/056999, WO 05/030942, WO 05/030941, WO 05/095632, WO 05/095617, WO 05/095619, WO 2005/095618, WO 05/123927, WO 06/018319, WO 06/103107, WO 06/108702, WO 07/009823, WO 00/22140, WO 06/063862, WO 06/072603, WO 02/034923, WO 08/017518, WO 08/080630, WO 08/080631, WO 08/090008, WO 01/14569, WO 02/79410, WO 03/33540, WO 04/078983, WO 01/19975, WO 95/26407, WO 96/34968, WO 98/20145, WO 99/12950, WO 99/66050, WO 99/53072, U.S. Pat. No. 6,734,341, WO 00/11192, WO 98/22604, WO 98/32326, WO 01/98509, WO 01/98509, WO 05/002359, U.S. Pat. No. 5,824,790, U.S. Pat. No. 6,013,861, WO 94/04693, WO 94/09144, WO 94/11520, WO 95/35026, WO 97/20936, WO 10/012796, WO 10/003701, WO 13/053729, WO 13/053730,
2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, as disclosed in EP-A 0 663 956, WO 96/01904, WO 96/21023, WO 98/39460, and WO 99/24593, plants producing alpha-1,4-glucans as disclosed in WO 95/31553, US 2002031826, U.S. Pat. No. 6,284,479, U.S. Pat. No. 5,712,107, WO 97/47806, WO 97/47807, WO 97/47808 and WO 00/14249, plants producing alpha-1,6 branched alpha-1,4-glucans, as disclosed in WO 00/73422, plants producing alternan, as disclosed in e.g. WO 00/47727, WO 00/73422, U.S. Pat. No. 5,908,975 and EP-A 0 728 213,
3) transgenic plants which produce hyaluronan, as for example disclosed in WO 06/032538, WO 07/039314, WO 07/039315, WO 07/039316, JP-A 2006-304779, and WO 05/012529.
4) transgenic plants or hybrid plants, such as onions with characteristics such as ‘high soluble solids content’, low pungency′ (LP) and/or ‘long storage’ (LS), as described in U.S. patent application Ser. No. 12/020,360.
5) Transgenic plants displaying an increase yield as for example disclosed in WO 11/095528
   Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics and include:
a) Plants, such as cotton plants, containing an altered form of cellulose synthase genes as described in WO 98/00549.
b) Plants, such as cotton plants, containing an altered form of rsw2 or rsw3 homologous nucleic acids as described in WO 04/053219.
c) Plants, such as cotton plants, with increased expression of sucrose phosphate synthase as described in WO 01/17333.
d) Plants, such as cotton plants, with increased expression of sucrose synthase as described in WO 02/45485.
e) Plants, such as cotton plants, wherein the timing of the plasmodesmatal gating at the basis of the fiber cell is altered, e.g. through downregulation of fiber-selective β-1,3-glucanase as described in WO 05/017157, or as described in WO 09/143995.
f) Plants, such as cotton plants, having fibers with altered reactivity, e.g. through the expression of N-acetylglucosaminetransferase gene including nodC and chitin synthase genes as described in WO 06/136351, WO 11/089021, WO 11/089021, WO 12/074868.
   Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation, or by selection of plants contain a mutation imparting such altered oil profile characteristics and include:
a) Plants, such as oilseed rape plants, producing oil having a high oleic acid content as described e.g. in U.S. Pat. No. 5,969,169, U.S. Pat. No. 5,840,946 or U.S. Pat. No. 6,323,392 or U.S. Pat. No. 6,063,947
b) Plants such as oilseed rape plants, producing oil having a low linolenic acid content as described in U.S. Pat. No. 6,270,828, U.S. Pat. No. 6,169,190, U.S. Pat. No. 5,965,755 or WO 11/060946
c) Plant such as oilseed rape plants, producing oil having a low level of saturated fatty acids as described e.g. in U.S. Pat. No. 5,434,283 or U.S. patent application Ser. No. 12/668,303
d) Plants such as oilseed rape plants, producing oil having an alter glucosinolate content as described in WO 2012075426.

Plants or plant cultivars (that can be obtained by plant biotechnology methods such as genetic engineering) which may also be treated according to the invention are plants, such as oilseed rape or related Brassica plants, with altered seed shattering characteristics. Such plants can be obtained by genetic transformation, or by selection of plants contain a mutation imparting such altered seed shattering characteristics and include plants such as oilseed rape plants with delayed or reduced seed shattering as described in WO 2009/068313 and WO 2010/006732, WO 2012090499.

Plants or plant cultivars (that can be obtained by plant biotechnology methods such as genetic engineering) which may also be treated according to the invention are plants, such as Tobacco plants, with altered post-translational protein modification patterns, for example as described in WO 10/121818 and WO 10/145846.

Particularly useful transgenic plants which may be treated according to the invention are plants containing transformation events, or combination of transformation events, that are the subject of petitions for non-regulated status, in the United States of America, to the Animal and Plant Health Inspection Service (APHIS) of the United States Department of Agriculture (USDA) whether such petitions are granted or are still pending. At any time this information is readily available from APHIS (4700 River Road, Riverdale, Md. 20737, USA), for instance on its internet site (URL http://www.aphis.usda.gov/brs/not_reg.html). On the filing date of this application the petitions for nonregulated status that were pending with APHIS or granted by APHIS were those listed in Table B which contains the following information:
Petition: the identification number of the petition. Technical descriptions of the transformation events can be found in the individual petition documents which are obtainable from APHIS, for example on the APHIS website, by reference to this petition number. These descriptions are herein incorporated by reference.
Extension of Petition: reference to a previous petition for which an extension is requested.
Institution: the name of the entity submitting the petition.
Regulated article: the plant species concerned.
Transgenic phenotype: the trait conferred to the plants by the transformation event.
Transformation event or line: the name of the event or events (sometimes also designated as lines or lines) for which nonregulated status is requested.
APHIS documents: various documents published by APHIS in relation to the Petition and which can be requested with APHIS.

TABLE B

| Petition No. | Applicant | Crop | Phenotype/Event |
|---|---|---|---|
| 11-342-01p | Genective | Corn | Glyphosate Tolerant/ |
| | | | VCO-Ø1981-5 |
| 11-234-01p | Dow | Soybean | 2, 4-D, Glyphosate |
| | | | and Glufosinate |
| | | | Tolerant/DAS-444Ø6-6 |
| 11-202-01p | Monsanto | Soybean | Increased Yield/MON 87712 |
| 11-188-01p | Monsanto | Canola | Glyphosate Tolerant/ |
| | | | MON 88302 |
| 11-063-01p | Pioneer | Canola | Glyphosate Tolerant/73496 |
| 10-281-01p | Monsanto | Corn | Male Sterile/MON 87427 |
| 10-188-01p | Monsanto | Soybean | Dicamba Tolerant/MON 87708 |
| 10-161-01p | Okanagan | Apple | Non-Browning/GD743, GS784 |
| 09-015-01p | BASF | Soybean | Imadazolinone Tolerant/ |
| | | | BPS-CV127-9 |

The following pending petitions will proceed with the
previous process for soliciting public input (simultaneous notice of
availability of the petition and decisionmaking documents).

| | | | |
|---|---|---|---|
| 12-033-01p | Bayer | Cotton | Glufosinate Tolerant, |
| Extension of | | | Lepidopteran Resistant/T303-3 |
| 08-340-01p | | | |
| 11-244-01p | Pioneer | Corn | Insect Resistant and Glufosinate |
| | | | Tolerant/DP-ØØ4114-3 |
| 10-336-01p | Syngenta | Corn | Rootworm Resistant/ |
| | | | 5307 |
| 09-349-01p | Dow | Soybean | 2,4-D and Glufosinate Tolerant/ |
| | | | DAS-68416-4 |
| 09-328-01p | Bayer | Soybean | Glyphosate and Isoxaflutole |
| | | | Tolerant/FG72 |
| 09-233-01p | Dow | Corn | 2,4-D and ACCase-Inhibitor |
| | | | Tolerant/DAS-40278-9 |
| 03-104-01p | Scotts | Creeping | Glyphosate Tolerant/ |
| | | Bentgrass | ASR368 |

Determinations of Nonregulated Status

| | | | |
|---|---|---|---|
| 09-201-01p | Monsanto | Soybean | Improved Fatty Acid Profile/ |
| | | | MON 87705 |
| 09-183-01p | Monsanto | Soybean | Stearidonic Acid Produced/ |
| | | | MON 87769 |
| 09-082-01p | Monsanto | Soybean | Insect Resistant/ |
| | | | MON 87701 |
| 09-055-01p | Monsanto | Corn | Drought Tolerant/ |
| | | | MON 87460 |
| 08-340-01p | Bayer | Cotton | Glufosinate Tolerant, |
| | | | Lepidopteran Resistant/ |
| | | | T304-40 x GHB119 |
| 08-338-01p | Pioneer | Corn | Male Sterile, Fertility Restored, |
| | | | Visual Marker/ |
| | | | DP-32138-1 |
| 08-315-01p | Florigene | Rose | Altered Flower Color/ |
| | | | IFD-52401-4, |
| | | | IFD-52901-9 |
| 07-253-01p | Syngenta | Corn | Lepidopteran Resistant/ |
| | | | MIR 162 |
| 07-152-01p | Pioneer | Corn | Glyphosate & Imidazolinone |
| | | | Tolerant/98140 |
| 07-108-01p | Syngenta | Cotton | Lepidopteran Resistant/ |
| | | | COT67B |
| 06-354-01p | Pioneer | Soybean | High Oleic Acid/ |
| | | | Event 305423 |
| 06-332-01p | Bayer | Cotton | Glyphosate Tolerant/ |
| | CropScience | | GHB614 |
| 06-298-01p | Monsanto | Corn | European Corn Borer Resistant/ |
| | | | MON 89034 |
| 06-271-01p | Pioneer | Soybean | Glyphosate & Acetolactate |
| | | | Synthase Tolerant/ |
| | | | DP-356Ø43-5 |
| 06-234-01p | Bayer Crop | ScienceRice | Phosphinothricin Tolerant/ |
| Extension of | | | LLRICE601 |
| 98-329-01p | | | |
| 06-178-01p | Monsanto | Soybean | Glyphosate Tolerant/ |
| | | | MON 89788 |
| 05-280-01p | Syngenta | Corn | Thermostable Alpha-amylase/ |
| | | | 3272 |
| 04-362-01p | Syngenta | Corn | Corn Rootworm Protected/ |
| | | | MIR604 |
| 04-337-01p | University | Papaya | Papaya Ringspot Virus |
| | of | | Resistant/X17-2 |
| | Florida | | |
| 04-264-01p | ARS | Plum | Plum Pox Virus Resistant/ |
| | | | C5 |
| 04-229-01p | Monsanto | Corn | High Lysine/ |
| | | | LY038 |
| 04-125-01p | Monsanto | Corn | Corn Rootworm Resistant/ |
| | | | MON 88017 |
| 04-110- | Monsanto | Alfalfa | Glyphosate Tolerant/ |
| 01p_a1 | & Forage | | J101, J103 |
| 04-110-01p | Genetics | | |
| 04-086-01p | Monsanto | Cotton | Glyphosate Tolerant/ |
| | | | MON 88913 |
| 03-353-01p | Dow | Corn | Corn Rootworm Resistant/ |
| | | | 59122 |
| 03-323- | Monsanto | Sugar Beet | Glyphosate Tolerant/ |
| 01p_a1 | and | | H7-1 |
| 03-323-01p | KWS SAAT | | |
| | AG | | |
| 03-181-01p | Dow | Corn | Lepidopteran Resistant |
| Extension of | | | & Phosphinothricin |
| 00-136-01p | | | Tolerant/ |
| | | | 6275 |
| 03-155-01p | Syngenta | Cotton | Lepidopteran Resistant/ |
| | | | COT102 |
| 03-036-02p | Mycogen/ | Cotton | Lepidopteran Resistant/ |
| | Dow | | 3006-210-23 |
| 03-036-01p | Mycogen/ | Cotton | Lepidopteran Resistant/ |
| | Dow | | 281-24-236 |
| 02-042-01p | Aventis | Cotton | Phosphinothericin Tolerant/ |
| | | | LLCotton25 |
| 01-324-01p | Monsanto | Rapeseed | Glyphosate tolerant/ |
| Extension of | | | GT200 |
| 98-216-01p | | | |
| 01-206-02p | Aventis | Rapeseed | Phosphinothricin Tolerant |
| Extension of | | | & Pollination Control/ |
| 97-205-01p | | | Topas 19/2 |
| 01-206-01p | Aventis | Rapeseed | Phosphinothricin Tolerant/ |
| Extension of | | | MS1 |
| 98-T78-01p | | | |
| 01-137-01p | Monsanto | Corn | Corn Rootworm Resistant/ |
| | | | MON 863 |
| 01-121-01p | Vector | Tobacco | Reduced Nicotine/ |
| | | | Vector 21-41 |
| 00-342-01p | Monsanto | Cotton | Lepidopteran Resistant/ |
| | | | 15985 |
| 00-136-01p | Mycogen | Corn | Lepidopteran Resistant |
| | c/o Dow | | Phosphinothricin Tolerant/ |
| | & Pioneer | | 1507 |
| 00-011-01p | Monsanto | Corn | Glyphosate Tolerant/ |
| Extension of | | | NK603 |
| 97-099-01p | | | |
| 99-173-01p | Monsanto | Potato | Potato Leafroll Virus & |
| Extension of | | | Colorado Potato |
| 97-204-01p | | | Beetle Resistant/ |
| | | | RBMT22-82 |
| 98-349-01p | AgrEvo | Corn | Phosphinothricin Tolerant |
| Extension of | | | and Male Sterile/MS6 |
| 95-228-01p | | | |
| 98-335-01p | U. of | Flax | Tolerant to Soil Residues |
| | Saskat- | | of Sulfonylurea |
| | chewan | | Herbicide/ |
| | | | CDC Triffid |
| 98-329-01p | AgrEvo | Rice | Phosphinothricin Tolerant/ |
| | | | LLRICE06, LLRICE62 |
| 98-278-01p | AgrEvo | Rapeseed | Phosphinothricin Tolerant |
| | | | and Pollination |
| | | | Control/ |
| | | | MS8, RF3 |
| 98-238-01p | AgrEvo | Soybean | Phosphinothricin Tolerant/ |
| | | | GU262 |
| 98-216-01p | Monsanto | Rapeseed | Glyphosate Tolerant/ |
| | | | RT73 |
| 98-173-01p | Novartis | Beet | Glyphosate Tolerant/ |
| | Seeds & | | GTSB77 |
| | Monsanto | | |
| 98-014-01p | AgrEvo | Soybean | Phosphinothricin Tolerant/ |
| Extension of | | | A5547-127 |
| 96-068-01p | | | |
| 97-342-01p | Pioneer | Corn | Male Sterile and |
| | | | Phosphinothricin Tolerant/ |
| | | | 676, 678, 680 |
| 97-339-01p | Monsanto | Potato | Colorado Potato Beetle and |
| | | | Potato Virus Y Resistant/ |
| | | | RBMT15-101, SEMT15-02, |
| | | | SEMT15-15 |
| 97-336-01p | AgrEvo | Beet | Phosphinothricin Tolerant/ |
| | | | T120-7 |
| 97-287-01p | Monsanto | Tomato | Lepidopteran Resistant/ |
| | | | 5345 |
| 97-265-01p | AgrEvo | Corn | Phosphinothricin Tolerant |
| | | | and Lepidopteran |
| | | | Resistant/ |
| | | | CBH-351 |
| 97-205-01p | AgrEvo | Rapeseed | Phosphinothricin Tolerant/ |
| | | | T45 |
| 97-204-01p | Monsanto | Potato | Potato Leafroll Virus |
| | | | & Colorado Potato |
| | | | Beetle Resistant/ |
| | | | RBMT21-129, RBMT21-152, |
| | | | RBMT21-350, |
| | | | RBMT22-82, RBMT22-186, |
| | | | RBMT22-238, |
| | | | RBMT22-262 |
| 97-148-01p | Bejo | Cichorium | Male Sterile/ |
| | | intybus | RM3-3, RM3-4, RM3-6 |
| 97-099-01p | Monsanto | Corn | Glyphosate Tolerant/ |
| | | | GA21 |
| 97-013-01p | Calgene | Cotton | Bromoxynil Tolerant |
| | | | and Lepidopteran |
| | | | Resistant/ |
| | | | 31807, 31808 |
| 97-008-01p | Du Pont | Soybean | High Oleic Acid Oil/ |
| | | | G94-1, G94-19, G-168 |
| 96-317-01p | Monsanto | Corn | Glyphosate Tolerant and |
| | | | European Corn Borer |
| | | | Resistant/ |
| | | | MON 802 |
| 96-291-01p | DeKalb | Corn | European Corn Borer |
| | | | Resistant/DBT418 |
| 96-248-01p | Calgene | Tomato | Fruit Ripening Altered/ |
| Extension of | | | 532A 4109a 5166 |
| 92-196-01p | | | |
| 96-068-01p | AgrEvo | Soybean | Glufosinate Tolerant/ |
| | | | W62, W98, A2704-12, |
| | | | A2704-21, A5547-35 |
| 96-051-01p | Cornell U | Papaya | Papaya Ringspot Virus |
| | | | Resistant/55-1, 63-1 |
| 96-017-01p | Monsanto | Corn | European Corn |
| Extension of | | | Borer Resistant/ |
| 95-093-01p | | | MON 809, MON 810 |
| 95-352-01p | Asgrow | Squash | Cucumber Mosaic Virus, |
| | | | Watermelon Mosaic |
| | | | Virus 2, and Zucchini |
| | | | Yellow Mosaic Virus |
| | | | Resistant/ |
| | | | CZW-3 |
| 95-338-01p | Monsanto | Potato | Colorado Potato |
| | | | Beetle Resistant/ |
| | | | SPBT02-5, SPBT02-7, |
| | | | ATBT04-6, ATBT04- |
| | | | 27, ATBT04-30, ATBT04-31, |
| | | | ATBT04-36 |
| 95-324-01p | Agritope | Tomato | Fruit Ripening Altered/ |
| | | | 35-1-N |
| 95-256-01p | Du Pont | Cotton | Sulfonylurea Tolerant/ |
| | | | 19-51A |
| 95-228-01p | Plant Genetic | Corn | Male Sterile/MS3 |
| | Systems | | |
| 95-195-01p | Northrup | Corn | European Corn Borer Resistant/ |
| | King | | Bt11 |
| 95-179-01p | Calgene | Tomato | Fruit Ripening Altered/ |
| Extension of | | | 519a 4109a-4645, |
| 92-196-01p | | | 540a 4109a-1823 |
| 95-145-01p | DeKalb | Corn | Glufosinate Tolerant/ |
| | | | B16 |
| 95-093-01p | Monsanto | Corn | Lepidopteran Resistant/ |
| | | | MON 80100 |
| 95-053-01p | Monsanto | Tomato | Fruit Ripening Altered/ |
| | | | 8338 |
| 95-045-01p | Monsanto | Cotton | Glyphosate Tolerant/ |
| | | | 1445, 1698 |
| 95-030-01p | Calgene | Tomato | Fruit Ripening Altered/ |
| Extension of | | | 105F 1436 2018, 105F |
| 92-196-01p | | | 1436 2035, 105F 1436 |
| | | | 2049, 35F 4109a 3023, |
| | | | 84F 4109a 148, 88F |
| | | | 4109a 2797, 121F 4109a 333, |
| | | | 121F 4109a |
| | | | 1071, 121F 4109a 1120, |
| | | | 137F 4109a 71, 138F |
| | | | 4109a 164, 519A 4109a 4527, |
| | | | 519A 4109a |
| | | | 4621, 519A 4109a 4676, |
| | | | 531A 4109a 2105, |
| | | | 531A 4109a 2270, 532A |
| | | | 4109a 5097, 540A |
| | | | 4109a 1739, 585A 4109a |
| | | | 3604, 585A 4109a |
| | | | 3530 |
| 94-357-01p | AgrEvo | Corn | Glufosinate Tolerant/ |
| | | | T14, T25 |
| 94-319-01p | Ciba Seeds | Corn | Lepidopteran Resistant/ |
| | | | 176 |
| 94-308-01p | Monsanto | Cotton | Lepidopteran Resistant/ |
| | | | 531, 757, 1076 |
| 94-290-01p | Zeneca & | Tomato | Fruit Polygalacturonase |
| | Petoseed | | Level Decreased/ |
| | | | B, Da, F |
| 94-257-01p | Monsanto | Potato | Coleopteran Resistant/ |
| | | | BT6, BT10, BT12, BT16, |
| | | | BT17, BT18, BT23 |
| 94-230-01p | Calgene | Tomato | Fruit Ripening Altered/ |
| Extension of | | | 114F 4109a 26, |
| 92-196-01p | | | 114F 4109a 81 |
| 94-228-01p | DNA Plant | Tomato | Fruit Ripening Altered/ |
| | Tech | | 1345-4 |
| 94-227-01p | Calgene | Tomato | Fruit Ripening Altered/ |
| Extension of | | | pCGN1436, pCGN4109 |
| 92-196-01p | | | |
| 94-090-01p | Calgene | Rapeseed | Oil Profile Altered/ |
| | | | pCGN3828-212/86-18, |
| | | | pCGN3828-212/86-23 |
| 93-258-01p | Monsanto | Soybean | Glyphosate Tolerant/ |
| | | | 4-30-2 |
| 93-196-01p | Calgene | Cotton | Bromoxynil Tolerant/ |
| | | | BXN |
| 92-204-01p | Upjohn | Squash | Watermelon Mosaic |
| | | | Virus and Zucchini |
| | | | Yellow Mosaic Virus |
| | | | Resistant/ZW-20 |
| 92-196-01p | Calgene | Tomato | Fruit Ripening Altered/ |
| | | | pCGN1547, pCGN1548, |
| | | | pCGN1557, |
| | | | pCGN1559, pCGN1578 |

Additional particularly useful plants containing single transformation events or combinations of transformation events are listed for example in the databases from various national or regional regulatory agencies (see for example http://gmoinfo.jrc.it/gmp_browse.aspx and http://www.cera-gmc.org/?action=gm_crop_database).

Further particularly transgenic plants include plants containing a transgene in an agronomically neutral or beneficial position as described in any of the patent publications listed in Table C.

TABLE C

| Trait | Reference | Remarks |
|---|---|---|
| Water use efficiency | WO 2000/073475 | |
| | WO2009/150541 | |
| | WO2009/150541 | |
| | WO2012075429 | |
| | WO2012077020 | |
| | WO2012158594 | |
| Nitrogen use efficiency | WO 1995/009911 | |
| | WO 1997/030163 | |
| | WO 2007/092704 | |
| | WO 2007/076115 | |
| | WO 2005/103270 | |
| | WO 2002/002776 | |
| | WO2008/051608 | |
| | WO2008/112613 | |
| | WO2009/015096 | |
| | WO2009/061776 | |
| | WO2009/105492 | |
| | WO2009/105612 | |
| | WO2009/117853 | |
| | WO2010/006010 | |
| | WO2009/117853 | |
| | WO2009/061776 | |
| | WO2009/015096 | |
| | WO2009/105492 | |
| | WO2009/105612 | |
| | WO 2010/053621 | |
| | WO 2010/053867 | |
| | WO2010/077890 | |
| | WO 2010/086220 | |
| | WO 2010/111568 | |
| | WO 2010/140388 | |
| | WO2010/007496 | |
| | WO2011/022597 | |
| | WO2011/022608 | |
| | WO2012087140 | |
| Improved | WO 2008/056915 | |
| photosynthesis | WO 2004/101751 | |
| Nematode | WO 1995/020669 | |
| resistance | WO 2001/051627 | |
| | WO 2008/139334 | |
| | WO 2008/095972 | |
| | WO 2006/085966 | |
| | WO 2003/033651 | |
| | WO 1999/060141 | |
| | WO 1998/012335 | |
| | WO 1996/030517 | |
| | WO 1993/018170 | |
| | WO2008/095886 | |
| | WO2008/095887 | |
| | WO2008/095888 | |
| | WO2008/095889 | |
| | WO2008/095910 | |
| | WO2008/095911 | |
| | WO2008/095916 | |
| | WO2008/095919 | |
| | WO2008/095969 | |
| | WO2008/095970 | |
| | WO2008/095972 | |
| | WO2008/110522 | |
| | WO2008/139334 | — |
| | WO2008/152008 | — |
| | W02010/077858 | — |
| | WO 2010/091230 | — |
| | WO 2010/102172 | — |
| | WO 2010/106163 | |
| | WO2011/003783 | |
| | WO2011/082217 | |
| | WO2011/104153 | |
| | WO2012007916 | |
| | WO2012007919 | |
| | WO2012009551 | |
| | WO2012011034 | |
| | WO2012012403 | |
| | WO2012153274 | |
| | WO2012156902 | |
| Reduced pod | WO 2006/009649 | |
| dehiscence | WO 2004/113542 | |
| | WO 1999/015680 | |
| | WO 1999/000502 | |
| | WO 1997/013865 | |
| | WO 1996/030529 | |
| | WO 1994/023043 | |
| Aphid resistance | WO 2006/125065 | |
| | WO 1997/046080 | |
| | WO 2008/067043 | |
| | WO 2004/072109 | |
| | WO2009/091860 | |
| | WO2010036764 | |
| Sclerotinia resistance | WO 2006/135717 | |
| | WO 2006/055851 | |
| | WO 2005/090578 | |
| | WO 2005/000007 | |
| | WO 2002/099385 | |
| | WO 2002/061043 | |
| Botrytis resistance | WO 2006/046861 | |
| | WO 2002/085105 | |
| Bremia resistance | US 20070022496 | |
| | WO 2000/063432 | |
| | WO 2004/049786 | |
| | WO2009/111627 | |
| | WO2009/111627 | |
| Erwinia resistance | WO 2004/049786 | |
| Closterovirus resistance | WO 2007/073167 | |
| | WO 2007/053015 | |
| | WO 2002/022836 | |
| Stress tolerance | WO 2010/019838 | |
| (including | WO 2009/049110 | |
| drought tolerance) | WO2008/002480 | |
| | WO2005/033318 | |
| | WO2008/002480 | |
| | WO2008/005210 | |
| | WO2008/006033 | |
| | WO2008/008779 | |
| | WO2008/022486 | |
| | WO2008/025097 | |
| | WO2008/027534 | |
| | WO2008/027540 | |
| | WO2008/037902 | |
| | WO2008/046069 | |
| | WO2008/053487 | |
| | WO2008/057642 | |
| | WO2008/061240 | |
| | WO2008/064222 | |
| | WO2008/064341 | |
| | WO2008/073617 | |
| | WO2008/074025 | |
| | WO2008/076844 | |
| | WO2008/096138 | |
| | WO2008/110848 | |
| | WO2008/116829 | |
| | WO2008/117537 | |
| | WO2008/121320 | |
| | WO2008/125245 | |
| | WO2008/142034 | |
| | WO2008/142036 | |
| | WO2008/150165 | |
| | WO2008/092935 | |
| | WO2008/145675 | |
| | WO2009/010460 | |
| | WO2009/016240 | |
| | WO2009/031664 | |
| | WO2009/038581 | |
| | WO2009/049110 | |
| | WO2009/053511 | |
| | WO2009/054735 | |
| | WO2009/067580 | |
| | WO2009/073605 | |
| | WO2009/077611 | |
| | WO2009/079508 | Also yield |
| | WO2009/079529 | |
| | WO2009/083958 | Also yield |
| | WO2009/086229 | Also yield |
| | WO2009/092009 | |
| | WO2009/094401 | |
| | WO2009/094527 | |
| | WO2009/102965 | Also biomass/ |
| | | starch/oil |
| | WO2009/114733 | |
| | WO2009/117448 | |
| | WO2009/126359 | Also grain yield |
| | WO2009/126462 | |
| | WO2009/129162 | |
| | WO2009/132057 | |
| | WO2009/141824 | |
| | WO2009/148330 | |
| | WO 2010/055024 | |
| | WO 2010/058428 | |
| | WO 2010/064934 | |
| | WO2010/076756 | |
| | WO 2010/083178 | |
| | WO 2010/086221 | |
| | WO 2010/086277 | |
| | WO 2010/101818 | |
| | WO 2010/104848 | |
| | WO 2010/118338 | |
| | WO 2010/120017 | |
| | WO 2010/120054 | |
| | WO 2010/121316 | |
| | WO 2010/127579 | |
| | WO 2010/134654 | |
| | WO 2010/139993 | |
| | WO2010/039750 | |
| | WO2011/034968 | |
| | WO2011/001286 | |
| | WO2011/017492 | |
| | WO2011/018662 | |
| | WO2011/024065 | |
| | WO2011/038389 | |
| | WO2011/46772 | |
| | WO2011/053897 | |
| | WO2011/052169 | |
| | WO2011/063706 | |
| | WO2011/067745 | |
| | WO2011/079277 | |
| | WO2011/080674 | |
| | WO2011/083290 | |
| | WO2011/083298 | |
| | WO2011/091764 | |
| | WO2011/052169 | |
| | WO2011/053897 | |
| | WO2011/056769 | |
| | WO2011/063706 | |
| | WO2011/067745 | |
| | WO2011/083290 | |
| | WO2011/083298 | |
| | WO2011/091764 | |
| | WO2011/096609 | |
| | WO2011/122761 | |
| | WO2012176167 | |
| | WO2012139532 | |
| | WO2012159196 | |
| | WO2012162193 | |
| | WO2012167023 | |
| | WO2012172556 | |
| | WO2012116396 | |
| Tobamovirus resistance | WO 2006/038794 | |
| | WO2009086850 | |
| Yield | WO 2010/046221 | NUE |
| | WO 2010/046471 | |
| | WO 2010/049897 | |
| | WO 2010/055837 | |
| | WO 2010/065867 | ABST |
| | WO2010/069847 | |
| | WO2010/075143 | |
| | WO2010/075243 | |
| | WO 2010/100595 | |
| | WO 2010/102220 | NUE |
| | WO 2010/104092 | |
| | WO 2010/108836 | |
| | WO 2010/120862 | ABST |
| | WO 2010/123667 | |
| | WO 2010/124953 | |
| | WO 2010/125036 | |
| | WO 2010/127969 | |
| | WO 2010/129501 | |
| | WO 2010/140388 | |
| | WO 2010/140672 | |
| | WO2011/011273 | |
| | WO2011/000466 | |
| | WO2011/003800 | |
| | WO2011/006717 | |
| | WO2011/008510 | |
| | WO2011/009801 | |
| | WO2011/011412 | |
| | WO2011/015985 | |
| | WO2011/020746 | |
| | WO2011/021190 | |
| | WO2011/025514 | |
| | WO2011/025515 | |
| | WO2011/025516 | |
| | WO2011/025840 | |
| | WO2011/031680 | |
| | WO2011/036160 | |
| | WO2011/036232 | |
| | WO2011/041796 | |
| | WO2011/044254 | |
| | WO2011/048009 | |
| | WO2011/053898 | |
| | WO2011/051120 | |
| | WO2011/058029 | |
| | WO2011/061656 | |
| | WO2011/085062 | |
| | WO2011/088065 | |
| | WO2011/053898 | |
| | WO2011/058029 | |
| | WO2011/061656 | |
| | WO2011/085062 | |
| | WO2011/088065 | |
| | WO2011/095958 | |
| | WO2011/097215 | |
| | WO2011/099006 | |
| | WO2011/104128 | |
| | WO2011/104141 | |
| | WO2011/104143 | |
| | WO2011/104155 | |
| | WO2011/106734 | |
| | WO2011/106794 | |
| | WO2011/109661 | |
| | WO2011/114279 | |
| | WO2011/114305 | |
| | WO2011/114312 | |
| | WO2011/114313 | |
| | WO2011/117800 | |
| | WO2011/135527 | |
| | WO2011/136909 | |
| | WO2011/139431 | |
| | WO2011/140329 | |
| | WO2011/146754 | |
| | WO2011/147826 | |
| | WO2011/157976 | |
| | WO2011/161617 | |
| | WO2011/161620 | |
| | WO2011/109618 | |
| | WO2011/159452 | |
| | WO2012078949 | |
| | WO2012083219 | |
| | WO2012084742 | |
| | WO2012084756 | |
| | WO2012087903 | |
| | WO2012087940 | |
| | WO2012090500 | |
| | WO2012091939 | |
| | WO2012092106 | |
| | WO2012092327 | |
| | WO2012092573 | |
| | WO2012092580 | |
| | WO2012092596 | |
| | WO2012093032 | |
| | WO2012093833 | |
| | WO2012097720 | |
| | WO2012098517 | |
| | WO2012102999 | |
| | WO2012106321 | |
| | WO2012158630 | |
| | WO2012165678 | |
| | WO2012112518 | |
| | WO2012117324 | |
| | WO2012117330 | |
| | WO2012117368 | |
| | WO2012119152 | |
| | WO2012142106 | |
| | WO2012142116 | |
| | WO2012143830 | |
| | WO2012143865 | |
| | WO2012145269 | |
| | WO2012148121 | |
| | WO2012148122 | |
| | WO2012148835 | |
| | WO2012150598 | |
| | WO2012153267 | |
| | WO2012153277 | |
| | WO2012156865 | |
| | WO2012158926 | |
| Oil content/ | WO 2010/045324 | |
| composition | WO 2010/053541 | |
| | WO 2010/130725 | |
| | WO 2010/140682 | |
| | WO2011/006948 | |
| | WO2011/049627 | |
| | WO2011/060946 | |
| | W02011/062748 | |
| | WO2011/064181 | |
| | WO2011/064183 | |
| | WO2011/075716 | |
| | WO2011/079005 | |
| | WO2011/049627 | |
| | W02011/062748 | |
| | WO2011/064181 | |
| | WO2011/064183 | |
| | WO2011/079005 | |
| | WO2011/146524 | |
| | WO2011/161093 | |
| | WO2011/163557 | |
| | WO2011/163632 | |
| | WO2011/163632 | |
| | WO2012074385 | |
| | WO2012074386 | |
| | WO2012103452 | |
| | WO2012117256 | |
| Biopharmaceutical | WO 2010/121818 | |
| production | WO2011/119115 | |
| Improved recombination | WO2010/071418 | |
| | WO 2010/133616 | |
| plant appearance | WO 2010/069004 | |
| | WO2011/060552 | |
| Disease control (other) | WO 2010/059558 | fungi |
| | WO2010/075352 | Insects/non-Bt |
| | WO2010/075498 | insects/Bt |
| | WO 2010/085289 | insects/Bt |
| | WO 2010/085295 | insects/Bt |
| | WO 2010/085373 | insects/Bt |
| | WO2009/000736 | fungi |
| | WO2009/065863 | fungi |
| | WO2009/112505 | fungi |
| | WO 2010/089374 | bacteria |
| | WO 2010/120452 | insects/Bt |
| | WO 2010/123904 | virus |
| | WO 2010/135782 | fungi |
| | WO2011/025860 | fungi |
| | WO2011/041256 | Insects |
| | WO2011/031006 | Insects/Bt |
| | WO2011/031922 | Insects/Bt |
| | WO2011/075584 | Insects/Bt |
| | WO2011/075585 | Insects/Bt |
| | WO2011/075586 | Insects/Bt |
| | WO2011/075587 | Insects/Bt |
| | WO2011/075588 | Insects/Bt |
| | WO2011/084622 | Insects/Bt |
| | WO2011/084626 | Insects/Bt |
| | WO2011/084627 | Insects/Bt |
| | WO2011/084629 | Insects/Bt |
| | WO2011/084630 | Insects/Bt |
| | WO2011/084631 | Insects/Bt |
| | WO2011/084314 | Insects/Bt |
| | WO2011/084324 | Insects/Bt |
| | WO2011/023571 | Insects/Bt |
| | WO2011/040880 | |
| | WO2011/082304 | |
| | WO2011/003783 | |
| | WO2011/020797 | |
| | WO2011/069953 | fungi |
| | WO2011/075584 | Insects/Bt |
| | WO2011/075585 | Insects/Bt |
| | WO2011/075586 | Insects/Bt |
| | WO2011/075587 | Insects/Bt |
| | WO2011/075588 | Insects/Bt |
| | WO2011/084314 | Insects/Bt |
| | WO2011/084324 | Insects/Bt |
| | WO2011/084622 | Insects/Bt |
| | WO2011/084626 | Insects/Bt |
| | WO2011/084627 | Insects/Bt |
| | WO2011/084629 | Insects/Bt |
| | WO2011/084630 | Insects/Bt |
| | WO2011/084631 | Insects/Bt |
| | WO2011/133892 | Insects/Bt |
| | WO2011/133895 | Insects/Bt |
| | WO2011/133896 | Insects/Bt |
| | WO2011/082304 | |
| | WO2011/100650 | |
| | WO2011/158242 | |
| | WO2012003207 | Bacteria |
| | WO2012004013 | Fungi |
| | WO2012004401 | Fungi |
| | WO2012006271 | Fungi |
| | WO2012006426 | Fungi |
| | WO2012006439 | Fungi |
| | WO2012006443 | Fungi |
| | WO2012006622 | General |
| | WO2012015039 | |
| | WO2012058266 | Insects/Coleoptera |
| | WO2012058458 | Insects/Coleoptera |
| | WO2012058528 | Insects/Lepidoptera |
| | WO2012058730 | Insects/Lepidoptera |
| | WO2012061513 | Insects/Lepidoptera |
| | WO2012063200 | Insects/Lepidoptera |
| | WO2012065166 | Insects/Lepidoptera |
| | WO2012065219 | Insects/Lepidoptera |
| | WO2012066008 | Insects/non-Bt |
| | WO2012067127 | Insects/non-Bt |
| | WO2012068966 | Insects/non-Bt |
| | WO2012071039 | Insects/non-Bt |
| | WO2012071040 | Insects/non-Bt |
| | WO2012117406 | Bacteria |
| | WO2012116938 | Fungi |
| | WO2012147635 | Fungi |
| | WO2012160528 | Fungi |
| | WO2012172498 | Fung |
| | WO2012178154 | Fungi |
| | WO2012149316 | Fungi |
| | WO2012175420 | — |
| | WO2012109515A1 | Insects/Coleoptera |
| | WO2012109430A2 | Insects and |
| | | nematodes |
| | WO2012122369A1 | Insects/Lepidoptera |
| | WO2012131619A1 | Insects/Lepidoptera |
| | WO2012139004A2 | Insects/Lepidoptera |
| | WO2012143542A1 | Insects/Non-Bt |
| | WO2012165961A1 | Insects/Non-Bt |
| Herbicide tolerance | U.S. Pat. No. 4761373 | imidazolinone |
| | U.S. Pat. No. 5304732 | Imidazolinone |
| | U.S. Pat. No. 5331107 | Imidazolinone |
| | U.S. Pat. No. 5718079 | Imidazolinone |
| | U.S. Pat. No. 6211438 | Imidazolinone |
| | U.S. Pat. No. 6211439 | Imidazolinone |
| | U.S. Pat. No. 6222100 | Imidazolinone |
| | U.S. Pat. No. 2003/0217381 | Imidazolinone |
| | U.S. Pat. No. 2003/0217381 | Imidazolinone |
| | WO2004/106529 | Imidazolinone |
| | WO2000/27182 | Imidazolinone |
| | WO2005/20673 | imidazolinone |
| | WO 2001/85970 | Imidazolinone |
| | U.S. Pat. No. 5545822 | Imidazolinone |
| | U.S. Pat. No. 5736629 | Imidazolinone |
| | U.S. Pat. No. 5773703, | Imidazolinone |
| | U.S. Pat. No. 5773704 | Imidazolinone |
| | U.S. Pat. No. 5952553 | Imidazolinone |
| | U.S. Pat. No. 6274796 | Imidazolinone |
| | WO 2004/106529 | Imidazolinone |
| | WO2004/16073 | Imidazolinone |
| | WO 2003/14357 | Imidazolinone |
| | WO 2003/13225 | imidazolinone |
| | WO 2003/14356 | imidazolinone |
| | U.S. Pat. No. 5188642 | glyphosate |
| | U.S. Pat. No. 4940835 | glyphosate |
| | U.S. Pat. No. 5633435 | glyphosate |
| | U.S. Pat. No. 5804425 | glyphosate |
| | U.S. Pat. No. 5627061. | glyphosate |
| | U.S. Pat. No. 5646024 | glufosinate |
| | U.S. Pat. No. 5561236 | glufosinate |
| | U.S. Pat. No. 6333449 | glufosinate |
| | U.S. Pat. No. 6933111 | glufosinate |
| | U.S. Pat. No. 6468747. | glufosinate |
| | U.S. Pat. No. 6376754 | glufosinate |
| | U.S. Pat. No. 7105724 | dicamba |
| | U.S. Pat. No. 7105724 | dicamba |
| | WO 2008/051633 | dicamba |
| | U.S. Pat. No. 7105724 | dicamba |
| | U.S. Pat. No. 5670454 | dicamba |
| | U.S. Pat. No. 7105724 | dicamba |
| | U.S. Pat. No. 7105724 | dicamba |
| | U.S. Pat. No. 7105724 | dicamba |
| | U.S. Pat. No. 7105724 | dicamba |
| | U.S. Pat. No. 5670454 | dicamba |
| | U.S. Pat. No. 7105724 | dicamba |
| | U.S. Pat. No. 7105724 | dicamba |
| | U.S. Pat. No. 7105724 | dicamba |
| | U.S. Pat. No. 5670454 | dicamba |
| | U.S. Pat. No. 7105724 | dicamba |
| | U.S. Pat. No. 7105724 | dicamba |
| | U.S. Pat. No. 7105724 | dicamba |
| | U.S. Pat. No. 7105724 | dicamba |
| | U.S. Pat. No. 6153401 | 2,4-D |
| | U.S. Pat. No. 6100446 | 2,4-D |
| | WO 2005/107437 | 2,4-D |
| | U.S. Pat. No. 5670454 | 2,4-D |
| | U.S. Pat. No. 5608147 | 2,4-D |
| | U.S. Pat. No. 5670454 | 2,4-D |
| | WO 2004/055191 | HPPD-inhibitor |
| | WO 199638567 | HPPD-inhibitor |
| | U.S. Pat. No. 6791014 | HPPD-inhibitor |
| | U.S. Pat. No. 2002/0073443, | Protox-inhibitor |
| | U.S. Pat. No. 20080052798 | Protox-inhibitor |
| | WO2011/022470 | |
| | WO2011/034936 | |
| | WO2011/028832 | |
| | WO2011/028833 | |
| | WO2011/028836 | |
| | WO2011/068567 | HPPD-inhibitor |
| | WO2011/076345 | HPPD-inhibitor |
| | WO2011/085221 | HPPD-inhibitor |
| | WO2011/094199 | |
| | WO2011/094205 | HPPD-inhibitor |
| | WO2011/068567 | HPPD-inhibitor |
| | WO2011/085221 | saflufenacil |
| | WO2011/094199 | HPPD-inhibitor |
| | WO2011/094205 | HPPD-inhibitor |
| | WO2011/145015 | HPPD-inhibitor |
| | WO2012047595 | 2,4-D |
| | WO2012048124 | ACCase-inhibotor |
| | WO2012048136 | Glyphosate |
| | WO2012048807 | Glyphosate |
| | WO2012049663 | Glyphosate |
| | WO2012050962 | Glyphosate |
| | WO2012056401 | HPPD-inhibitor |
| | WO2012057466 | PPX |
| | WO2012057465 | Protox-inhibitor |
| | WO2012058223 | ALS/SU |
| | WO2012115968 | ,4-D |
| | WO2012148818 | 2,4-D |
| | WO2012148820 | 2,4-D |
| | WO2012106321 | ACC-ase |
| | WO2012124808 | Dicamba |
| | WO2012148275 | Glyphosate |
| plant metabolism | WO2011/060920 | |
| | WO2011/119115 | |
| | WO2011/102394 | |
| reproduction/pollination | WO2011/113839 | |
| control | WO2012142311 | |
| | WO2012163389 | |
| Biofuels | WO2012073493 | |
| Fruit ripening | WO2012073494 | |
| Fiber quality | WO2012074386 | |
| Carbohydrates | WO2012115697 | |
| | WO2012132348 | |
| | WO2012134906 | |
| | WO2012174462 | |

Additional particularly useful plants containing single transformation events or combinations of transformation events are listed for example in the databases from various national or regional regulatory agencies (see for example http://gmoinfo.jrc.it/gmp_browse.aspx and http://www.cera-gmc.org/?action=gm_crop_database).

Particularly useful transgenic plants which may be treated according to the invention are plants containing transformation events, or a combination of transformation events, and that are listed for example in the databases for various national or regional regulatory agencies including Event 531/PV-GHBK04 (cotton, insect control, described in WO 2002/040677), Event 1143-14A (cotton, insect control, not deposited, described in WO 06/128569); Event 1143-51B (cotton, insect control, not deposited, described in WO 06/128570); Event 1445 (cotton, herbicide tolerance, not deposited, described in US-A 2002-120964 or WO 02/034946Event 17053 (rice, herbicide tolerance, deposited as PTA-9843, described in WO 10/117737); Event 17314 (rice, herbicide tolerance, deposited as PTA-9844, described in WO 10/117735); Event 281-24-236 (cotton, insect control—herbicide tolerance, deposited as PTA-6233, described in WO 05/103266 or US-A 2005-216969); Event 3006-210-23 (cotton, insect control—herbicide tolerance, deposited as PTA-6233, described in US-A 2007-143876 or WO 05/103266); Event 3272 (corn, quality trait, deposited as PTA-9972, described in WO 06/098952 or US-A 2006-230473); Event 33391 (wheat, herbicide tolerance, deposited as PTA-2347, described in WO 2002/027004), Event 40416 (corn, insect control—herbicide tolerance, deposited as ATCC PTA-11508, described in WO 11/075593); Event 43A47 (corn, insect control—herbicide tolerance, deposited as ATCC PTA-11509, described in WO 11/075595); Event 5307 (corn, insect control, deposited as ATCC PTA-9561, described in WO 10/077816); Event ASR-368 (bent grass, herbicide tolerance, deposited as ATCC PTA-4816, described in US-A 2006-162007 or WO 04/053062); Event B16 (corn, herbicide tolerance, not deposited, described in US-A 2003-126634); Event BPS-CV127-9 (soybean, herbicide tolerance, deposited as NCIMB No. 41603, described in WO 10/080829); Event BLR1 (oilseed rape, restoration of male sterility, deposited as NCIMB 41193, described in WO 2005/074671), Event CE43-67B (cotton, insect control, deposited as DSM ACC2724, described in US-A 2009-217423 or WO 06/128573); Event CE44-69D (cotton, insect control, not deposited, described in US-A 2010-0024077); Event CE44-69D (cotton, insect control, not deposited, described in WO 06/128571); Event CE46-02A (cotton, insect control, not deposited, described in WO 06/128572); Event COT102 (cotton, insect control, not deposited, described in US-A 2006-130175 or WO 04/039986); Event COT202 (cotton, insect control, not deposited, described in US-A 2007-067868 or WO 05/054479); Event COT203 (cotton, insect control, not deposited, described in WO 05/054480); Event DAS21606-3/1606 (soybean, herbicide tolerance, deposited as PTA-11028, described in WO 012/033794), Event DAS40278 (corn, herbicide tolerance, deposited as ATCC PTA-10244, described in WO 11/022469); Event DAS-44406-6/pDAB8264.44.06.1 (soybean, herbicide tolerance, deposited as PTA-11336, described in WO 2012/075426), Event DAS-14536-7/pDAB8291.45.36.2 (soybean, herbicide tolerance, deposited as PTA-11335, described in WO 2012/075429), Event DAS-59122-7 (corn, insect control—herbicide tolerance, deposited as ATCC PTA 11384, described in US-A 2006-070139); Event DAS-59132 (corn, insect control—herbicide tolerance, not deposited, described in WO 09/100188); Event DAS68416 (soybean, herbicide tolerance, deposited as ATCC PTA-10442, described in WO 11/066384 or WO 11/066360); Event DP-098140-6 (corn, herbicide tolerance, deposited as ATCC PTA-8296, described in US-A 2009-137395 or WO 08/112019); Event DP-305423-1 (soybean, quality trait, not deposited, described in US-A 2008-312082 or WO 08/054747); Event DP-32138-1 (corn, hybridization system, deposited as ATCC PTA-9158, described in US-A 2009-0210970 or WO 09/103049); Event DP-356043-5 (soybean, herbicide tolerance, deposited as ATCC PTA-8287, described in US-A 2010-0184079 or WO 08/002872); Event EE-1 (brinjal, insect control, not deposited, described in WO 07/091277); Event FI117 (corn, herbicide tolerance, deposited as ATCC 209031, described in US-A 2006-059581 or WO 98/044140); Event FG72 (soybean, herbicide tolerance, deposited as PTA-11041, described in WO 2011/063413), Event GA21 (corn, herbicide tolerance, deposited as ATCC 209033, described in US-A 2005-086719 or WO 98/044140); Event GG25 (corn, herbicide tolerance, deposited as ATCC 209032, described in US-A 2005-188434 or WO 98/044140); Event GHB119 (cotton, insect control—herbicide tolerance, deposited as ATCC PTA-8398, described in WO 08/151780); Event GHB614 (cotton, herbicide tolerance, deposited as ATCC PTA-6878, described in US-A 2010-050282 or WO 07/017186); Event GJ11 (corn, herbicide tolerance, deposited as ATCC 209030, described in US-A 2005-188434 or WO 98/044140); Event GM RZ13 (sugar beet, virus resistance, deposited as NCIMB-41601, described in WO 10/076212); Event H7-1 (sugar beet, herbicide tolerance, deposited as NCIMB 41158 or NCIMB 41159, described in US-A 2004-172669 or WO 04/074492); Event JOPLIN1 (wheat, disease tolerance, not deposited, described in US-A 2008-064032); Event LL27 (soybean, herbicide tolerance, deposited as NCIMB41658, described in WO 06/108674 or US-A 2008-320616); Event LL55 (soybean, herbicide tolerance, deposited as NCIMB 41660, described in WO 06/108675 or US-A 2008-196127); Event LLcotton25 (cotton, herbicide tolerance, deposited as ATCC PTA-3343, described in WO 03/013224 or US-A 2003-097687); Event LLRICE06 (rice, herbicide tolerance, deposited as ATCC 203353, described in U.S. Pat. No. 6,468,747 or WO 00/026345); Event LLRice62 (rice, herbicide tolerance, deposited as ATCC 203352, described in WO 2000/026345), Event LLRICE601 (rice, herbicide tolerance, deposited as ATCC PTA-2600, described in US-A 2008-2289060 or WO 00/026356); Event LY038 (corn, quality trait, deposited as ATCC PTA-5623, described in US-A 2007-028322 or WO 05/061720); Event MIR162 (corn, insect control, deposited as PTA-8166, described in US-A 2009-300784 or WO 07/142840); Event MIR604 (corn, insect control, not deposited, described in US-A 2008-167456 or WO 05/103301); Event MON15985 (cotton, insect control, deposited as ATCC PTA-2516, described in US-A 2004-250317 or WO 02/100163); Event MON810 (corn, insect control, not deposited, described in US-A 2002-102582); Event MON863 (corn, insect control, deposited as ATCC PTA-2605, described in WO 04/011601 or US-A 2006-095986); Event MON87427 (corn, pollination control, deposited as ATCC PTA-7899, described in WO 11/062904); Event MON87460 (corn, stress tolerance, deposited as ATCC PTA-8910, described in WO 09/111263 or US-A 2011-0138504); Event MON87701 (soybean, insect control, deposited as ATCC PTA-8194, described in US-A 2009-130071 or WO 09/064652); Event MON87705 (soybean, quality trait—herbicide tolerance, deposited as ATCC PTA-9241, described in US-A 2010-0080887 or WO 10/037016); Event MON87708 (soybean, herbicide tolerance, deposited as ATCC PTA-9670, described in WO 11/034704); Event MON87712 (soybean, yield, deposited as PTA-10296, described in WO 2012/051199), Event MON87754 (soybean, quality trait, deposited as ATCC PTA-9385, described in WO 10/024976); Event MON87769 (soybean, quality trait, deposited as ATCC PTA-8911, described in US-A 2011-0067141 or WO 09/102873); Event MON88017 (corn, insect control—herbicide tolerance, deposited as ATCC PTA-5582, described in US-A 2008-028482 or WO 05/059103); Event MON88913 (cotton, herbicide tolerance, deposited as ATCC PTA-4854, described in WO 04/072235 or US-A 2006-059590); Event MON88302 (oilseed rape, herbicide tolerance, deposited as PTA-10955, described in WO 2011/153186), Event MON88701 (cotton, herbicide tolerance, deposited as PTA-11754, described in WO 2012/134808), Event MON89034 (corn, insect control, deposited as ATCC PTA-7455, described in WO 07/140256 or US-A 2008-260932); Event MON89788 (soybean, herbicide tolerance, deposited as ATCC PTA-6708, described in US-A 2006-282915 or WO 06/130436); Event MS11 (oilseed rape, pollination control—herbicide tolerance, deposited as ATCC PTA-850 or PTA-2485, described in WO 01/031042); Event MS8 (oilseed rape, pollination control—herbicide tolerance, deposited as ATCC PTA-730, described in WO 01/041558 or US-A 2003-188347); Event NK603 (corn, herbicide tolerance, deposited as ATCC PTA-2478, described in US-A 2007-292854); Event PE-7 (rice, insect control, not deposited, described in WO 08/114282); Event RF3 (oilseed rape, pollination control—herbicide tolerance, deposited as ATCC PTA-730, described in WO 01/041558 or US-A 2003-188347); Event RT73 (oilseed rape, herbicide tolerance, not deposited, described in WO 02/036831 or US-A 2008-070260); Event SYHT0H2/SYN-000H2-5 (soybean, herbicide tolerance, deposited as PTA-11226, described in WO 2012/082548), Event T227-1 (sugar beet, herbicide tolerance, not deposited, described in WO 02/44407 or US-A 2009-265817); Event T25 (corn, herbicide tolerance, not deposited, described in US-A 2001-029014 or WO 01/051654); Event T304-40 (cotton, insect control—herbicide tolerance, deposited as ATCC PTA-8171, described in US-A 2010-077501 or WO 08/122406); Event T342-142 (cotton, insect control, not deposited, described in WO 06/128568); Event TC1507 (corn, insect control—herbicide tolerance, not deposited, described in US-A 2005-039226 or WO 04/099447); Event VIP1034 (corn, insect control—herbicide tolerance, deposited as ATCC PTA-3925, described in WO 03/052073), Event 32316 (corn, insect control-herbicide tolerance, deposited as PTA-11507, described in WO 11/084632), Event 4114 (corn, insect control-herbicide tolerance, deposited as PTA-11506, described in WO 11/084621), EE-GM3/FG72 (soybean, herbicide tolerance, ATCC Accession N^{o} PTA-11041, WO 2011/063413A2), event DAS-68416-4 (soybean, herbicide tolerance, ATCC Accession N^{o} PTA-10442, WO2 011/066360A1), event DAS-68416-4 (soybean, herbicide tolerance, ATCC Accession N^{o} PTA-10442, WO 2011/066384A1), event DP-040416-8 (corn, insect control, ATCC Accession N^{o} PTA-11508, WO 2011/075593A1), event DP-043A47-3 (corn, insect control, ATCC Accession N^{o} PTA-11509, WO 2011/075595A1), event DP-004114-3 (corn, insect control, ATCC Accession N^{o} PTA-11506, WO 2011/084621A1), event DP-032316-8 (corn, insect control, ATCC Accession N^{o} PTA-11507, WO 2011/084632A1), event MON-88302-9 (oilseed rape, herbicide tolerance, ATCC Accession N^{o} PTA-10955, WO 2011/153186A1), event DAS-21606-3 (soybean, herbicide tolerance, ATCC Accession No. PTA-11028, WO 2012/033794A2), event MON-87712-4 (soybean, quality trait, ATCC Accession N^{o}. PTA-10296, WO 2012/051199A2), event DAS-44406-6 (soybean, stacked herbicide tolerance, ATCC Accession N^{o}. PTA-11336, WO 2012/075426A1), event DAS-14536-7 (soybean, stacked herbicide tolerance, ATCC Accession N^{o}. PTA-11335, WO 2012/075429A1), event SYN-000H2-5 (soybean, herbicide tolerance, ATCC Accession N^{o}. PTA-11226, WO 2012/082548A2), event DP-061061-7 (oilseed rape, herbicide tolerance, no deposit N^{o} available, WO 2012071039A1), event DP-073496-4 (oilseed rape, herbicide tolerance, no deposit N^{o} available, US2012131692), event 8264.44.06.1 (soybean, stacked herbicide tolerance, Accession N^{o} PTA-11336, WO 2012075426A2), event 8291.45.36.2 (soybean, stacked herbicide tolerance, Accession N^{o}. PTA-11335, WO 2012075429A2), event SYHT0H2 (soybean, ATCC Accession N^{o}. PTA-11226, WO 2012/082548A2), event MON88701 (cotton, ATCC Accession N^{o} PTA-11754, WO 2012/134808A1), event KK179-2 (alfalfa, ATCC Accession N^{o} PTA-11833, WO2013003558A1), event pDAB8264.42.32.1 (soybean, stacked herbicide tolerance, ATCC Accession N^{o} PTA-11993, WO 2013010094A1), event MZDT09Y (corn, ATCC Accession N^{o} PTA-13025, WO 2013012775A1), event KK179-2 (alfalfa, ATCC Accession N^{o} PTA-11833), WO2013003558A1, event pDAB8264.42.32.1 (soybean, stacked herbicide tolerance, ATCC Accession N^{o} PTA-1 1993), WO2013010094A1, event MZDT09Y (corn, ATCC Accession N^{o} PTA-13025), WO2013012775A1, event VCO-01981-5 (corn, herbicide tolerance, NCIMB Accession N^{o} 41842), WO2013014241A1, event DAS-81419-2 X DAS-68416-4 (soybean stacked insect resistance and herbicide tolerance, ATCC Accession N^{o} PTA-10442), WO2013016516A1, event DAS-81419-2 (soybean stacked insect resistance and herbicide tolerance, ATCC Accession N^{o} PTA-12006), WO2013016527A1, event HCEM485 (corn, herbicide tolerance, ATCC Accession N^{o} PTA-12014), WO2013025400A1, event pDAB4468.18.07.1 (cotton, herbicide tolerance, ATCC Accession N^{o} PTA-12456), WO2013112525A2, event pDAB4468.19.10.3 (cotton, herbicide tolerance, ATCC Accession N^{o} PTA-12457), WO2013112527A1.

In an advantageous embodiment, the compounds of the formula (I) are used for treating transgenic plants comprising at least one gene or gene fragment coding for a Bt toxin or Vip-related toxin.

Preferably, the compounds of the formula (I) are used for treating transgenic plants comprising at least one gene or gene fragment coding for a Bt toxin. A Bt toxin is a protein originating from or derived from the soil bacterium Bacillus thuringiensis which either belongs to the group of the crystal toxins (Cry) or the cytolytic toxins (Cyt). In the bacterium, they are originally formed as protoxins and are only metabolized in alkaline medium—for example in the digestive tract of certain feed insects—to their active form. There, the active toxin then binds to certain hydrocarbon structures at cell surfaces causing pores to be formed which destroy the osmotic potential of the cell, which may effect cell lysis. The result is the death of the insects. Bt toxins are active in particular against certain harmful species from the orders of the Lepidoptera (butterflies), Homoptera, Diptera and Coleoptera (beetles) in all their development stages; i.e. from the egg larva via their juvenile forms to their adult forms.

It has been known for a long time that gene sequences coding for Bt toxins, parts thereof or else peptides or proteins derived from Bt toxins can be cloned with the aid of genetic engineering into agriculturally useful plants to generate transgenic plants having endogenous resistance to pests sensitive to Bt toxins. For the purpose of the invention, the transgenic plants coding for at least one Bt toxin or proteins derived therefrom are defined as “Bt plants”.

The “first generation” of such Bt plants generally only comprise the genes enabling the formation of a certain toxin, thus only providing resistance to one group of pathogens. An example of a commercially available maize variety comprising the gene for forming the Cry1Ab toxin is “YieldGard®” from Monsanto which is resistant to the European corn borer. In contrast, in the Bt cotton variety (Bollgard®), resistance to other pathogens from the family of the Lepidoptera is generated by introduction by cloning of the genes for forming the Cry1Ac toxin. Other transgenic crop plants, in turn, express genes for forming Bt toxins with activity against pathogens from the order of the Coleoptera. Examples that may be mentioned are the Bt potato variety “NewLeaf®” (Monsanto) capable of forming the Cry3A toxin, which is thus resistant to the Colorado potato beetle, and the transgenic maize variety “YieldGard®” (Monsanto) which is capable of forming the Cry 3Bb1 toxin and is thus protected against various species of the Western corn rootworm.

In a “second generation”, the multiply transgenic plants, already described above, expressing or comprising at least two foreign genes were generated.

Preference according to the invention is given to transgenic plants with Bt toxins from the group of the Cry family (see, for example, http://www.lifesci.susx.ac.uk/home/Neil_Crickmore/Bt/.

Preferred are transgenic plants with Bt toxins from the group of the

| | | NCBI | | | | Source | |
|---|---|---|---|---|---|---|---|
| Name | Acc No. | Protein | NCBI Nuc | Authors | Year | Strain | Comment |
| Cry1Aa1 | AAA22353 | 142765 | 142764 | Schnepf et al | 1985 | Bt kurstaki | |
| | | | | | | HD1 | |
| Cry1Aa2 | AAA22552 | 551713 | 143100 | Shibano et al | 1985 | Bt sotto | |
| Cry1Aa3 | BAA00257 | 216284 | 216283 | Shimizu et al | 1988 | Bt aizawai | |
| | | | | | | IPL7 | |
| Cry1Aa4 | CAA31886 | 40267 | 40266 | Masson et al | 1989 | Bt | |
| | | | | | | entomocidus | |
| Cry1Aa5 | BAA04468 | 535781 | 506190 | Udayasuriyan et | 1994 | Bt Fu-2-7 | |
| | | | | al | | | |
| Cry1Aa6 | AAA86265 | 1171233 | 1171232 | Masson et al | 1994 | Bt kurstaki | |
| | | | | | | NRD-12 | |
| Cry1Aa7 | AAD46139 | 5669035 | 5669034 | Osman et al | 1999 | Bt C12 | |
| Cry1Aa8 | I26149 | | | Liu | 1996 | | DNA sequence |
| | | | | | | | only |
| Cry1Aa9 | BAA77213 | 4666284 | 4666283 | Nagamatsu et al | 1999 | Bt | |
| | | | | | | dendrolimus | |
| | | | | | | T84A1 | |
| Cry1Aa10 | AAD55382 | 5901703 | 5901702 | Hou and Chen | 1999 | Bt kurstaki | |
| | | | | | | HD-1-02 | |
| Cry1Aa11 | CAA70856 | 6687073 | 6687072 | Tounsi et al | 1999 | Bt kurstaki | |
| Cry1Aa12 | AAP80146 | 32344731 | 32344730 | Yao et al | 2001 | Bt Ly30 | |
| Cry1Aa13 | AAM44305 | 21239436 | 21239435 | Zhong et al | 2002 | Bt sotto | |
| Cry1Aa14 | AAP40639 | 37781497 | 37781496 | Ren et al | 2002 | unpublished | |
| Cry1Aa15 | AAY66993 | 67089177 | 67089176 | Sauka et al | 2005 | Bt INTA | |
| | | | | | | Mol-12 | |
| Cry1Aa16 | HQ439776 | | | Liu et al | 2010 | Bt Ps9-E2 | No NCBI link |
| | | | | | | | June 13 |
| Cry1Aa17 | HQ439788 | | | Liu et al | 2010 | Bt PS9-C12 | No NCBI link |
| | | | | | | | June 13 |
| Cry1Aa18 | HQ439790 | | | Liu et al | 2010 | Bt PS9-D12 | No NCBI link |
| | | | | | | | June 13 |
| Cry1Aa19 | HQ685121 | 337732098 | 337732097 | Li & Luo | 2011 | Bt LS-R-21 | |
| Cry1Aa20 | JF340156 | | | Kumari & Kaur | 2011 | Bt SK-798 | |
| Cry1Aa21 | JN651496 | | | Li Yuhong | 2011 | Bt LTS-209 | No NCBI link |
| | | | | | | | June 13 |
| Cry1Aa22 | KC158223 | | | El Khoury et al | 2013 | Bt Lip | |
| Cry1Ab1 | AAA22330 | 142720 | 142719 | Wabiko et al | 1986 | Bt berliner | |
| | | | | | | 1715 | |
| Cry1Ab2 | AAA22613 | 143227 | 143226 | Thorne et al | 1986 | Bt kurstaki | |
| Cry1Ab3 | AAA22561 | 143124 | 143123 | Geiser et al | 1986 | Bt kurstaki | |
| | | | | | | HD1 | |
| Cry1Ab4 | BAA00071 | 216280 | 216279 | Kondo et al | 1987 | Bt kurstaki | |
| | | | | | | HD1 | |
| Cry1Ab5 | CAA28405 | 40255 | 40254 | Hofte et al | 1986 | Bt berliner | |
| | | | | | | 1715 | |
| Cry1Ab6 | AAA22420 | 142886 | 142885 | Hefford et al | 1987 | Bt kurstaki | |
| | | | | | | NRD-12 | |
| Cry1Ab7 | CAA31620 | 40278 | 40277 | Haider & Ellar | 1988 | Bt aizawai | |
| | | | | | | IC1 | |
| Cry1Ab8 | AAA22551 | 143099 | 143098 | Oeda et al | 1987 | Bt aizawai | |
| | | | | | | IPL7 | |
| Cry1Ab9 | CAA38701 | 40273 | 40272 | Chak & Jen | 1993 | Bt aizawai | |
| | | | | | | HD133 | |
| Cry1Ab10 | A29125 | | | Fischhoff et al | 1987 | Bt kurstaki | |
| | | | | | | HD1 | |
| Cry1Ab11 | I12419 | | | Ely & Tippett | 1995 | Bt A20 | DNA sequence |
| | | | | | | | only |
| Cry1Ab12 | AAC64003 | 3746545 | 3746544 | Silva-Werneck | 1998 | Bt kurstaki | |
| | | | | et al | | S93 | |
| Cry1Ab13 | AAN76494 | 25990352 | 25990351 | Tan et al | 2002 | Bt c005 | |
| Cry1Ab14 | AAG16877 | 10440886 | 10440885 | Meza-Basso & | 2000 | Native | |
| | | | | Theoduloz | | Chilean Bt | |
| Cry1Ab15 | AAO13302 | 27436100 | 27436098 | Li et al | 2001 | Bt B-Hm-16 | |
| Cry1Ab16 | AAK55546 | 14190061 | 14190060 | Yu et al | 2002 | Bt AC-11 | |
| Cry1Ab17 | AAT46415 | 48734426 | 48734425 | Huang et al | 2004 | Bt WB9 | |
| Cry1Ab18 | AAQ88259 | 37048803 | 37048802 | Stobdan et al | 2004 | Bt | |
| Cry1Ab19 | AAW31761 | 56900936 | 56900935 | Zhong et al | 2005 | Bt X-2 | |
| Cry1Ab20 | ABB72460 | 82395049 | 82395048 | Liu et al | 2006 | BtC008 | |
| Cry1Ab21 | ABS18384 | 151655610 | 151655609 | Swiecicka et al | 2007 | Bt IS5056 | |
| Cry1Ab22 | ABW87320 | 159024156 | 159024155 | Wu and Feng | 2008 | BtS2491Ab | |
| Cry1Ab23 | HQ439777 | | | Liu et al | 2010 | Bt N32-2-2 | No NCBI link |
| | | | | | | | June 13 |
| Cry1Ab24 | HQ439778 | | | Liu et al | 2010 | Bt HD12 | No NCBI link |
| | | | | | | | June 13 |
| Cry1Ab25 | HQ685122 | 337732100 | 337732099 | Li & Luo | 2011 | Bt LS-R-30 | |
| Cry1Ab26 | HQ847729 | 320090245 | 320090244 | Prathap Reddy et | 2011 | DOR BT-1 | |
| | | | | al | | | |
| Cry1Ab27 | JN135249 | | | Ammouneh et al | 2011 | | |
| Cry1Ab28 | JN135250 | | | Ammouneh et al | 2011 | | |
| Cry1Ab29 | JN135251 | | | Ammouneh et al | 2011 | | |
| Cry1Ab30 | JN135252 | | | Ammouneh et al | 2011 | | |
| Cry1Ab31 | JN135253 | | | Ammouneh et al | 2011 | | |
| Cry1Ab32 | JN135254 | | | Ammouneh et al | 2011 | | |
| Cry1Ab33 | AAS93798 | | | Li et al | 2012 | Bt kenyae K3 | partial cds |
| Cry1Ab34 | KC156668 | | | Sampson et al | 2012 | | No NCBI link |
| | | | | | | | June 13 |
| Cry1Ab- | AAK14336 | 13173238 | 13173237 | Nagarathinam et | 2001 | Bt kunthala | uncertain |
| like | | | | al | | RX24 | sequence |
| Cry1Ab- | AAK14337 | 13173240 | 13173239 | Nagarathinam et | 2001 | Bt kunthala | uncertain |
| like | | | | al | | RX28 | sequence |
| Cry1Ab- | AAK14338 | 13173242 | 13173241 | Nagarathinam et | 2001 | Bt kunthala | uncertain |
| like | | | | al | | RX27 | sequence |
| Cry1Ab- | ABG88858 | 110734449 | 110734448 | Lin et al | 2006 | Bt ly4a3 | insufficient |
| like | | | | | | | sequence |
| Cry1Ac1 | AAA22331 | | | Adang et al | 1985 | Bt kurstaki | |
| | | | | | | HD73 | |
| Cry1Ac2 | AAA22338 | | | Von Tersch et al | 1991 | Bt kenyae | |
| Cry1Ac3 | CAA38098 | | | Dardenne et al | 1990 | Bt BTS89A | |
| Cry1Ac4 | AAA73077 | | | Feitelson | 1991 | Bt kurstaki | |
| | | | | | | PS85A1 | |
| Cry1Ac5 | AAA22339 | | | Feitelson | 1992 | Bt kurstaki | |
| | | | | | | PS81GG | |
| Cry1Ac6 | AAA86266 | | | Masson et al | 1994 | Bt kurstaki | |
| | | | | | | NRD-12 | |
| Cry1Ac7 | AAB46989 | | | Herrera et al | 1994 | Bt kurstaki | |
| | | | | | | HD73 | |
| Cry1Ac8 | AAC44841 | | | Omolo et al | 1997 | Bt kurstaki | |
| | | | | | | HD73 | |
| Cry1Ac9 | AAB49768 | | | Gleave et al | 1992 | Bt DSIR732 | |
| Cry1Ac10 | CAA05505 | | | Sun | 1997 | Bt kurstaki | |
| | | | | | | YBT-1520 | |
| Cry1Ac11 | CAA10270 | | | Makhdoom & | 1998 | | |
| | | | | Riazuddin | | | |
| Cry1Ac12 | I12418 | | | Ely & Tippett | 1995 | Bt A20 | DNA sequence |
| | | | | | | | only |
| Cry1Ac13 | AAD38701 | | | Qiao et al | 1999 | Bt kurstaki | |
| | | | | | | HD1 | |
| Cry1Ac14 | AAQ06607 | | | Yao et al | 2002 | Bt Ly30 | |
| Cry1Ac15 | AAN07788 | | | Tzeng et al | 2001 | Bt from | |
| | | | | | | Taiwan | |
| Cry1Ac16 | AAU87037 | | | Zhao et al | 2005 | Bt H3 | |
| Cry1Ac17 | AAX18704 | | | Hire et al | 2005 | Bt kenyae | |
| | | | | | | HD549 | |
| Cry1Ac18 | AAY88347 | | | Kaur & Allam | 2005 | Bt SK-729 | |
| Cry1Ac19 | ABD37053 | | | Gao et al | 2005 | Bt C-33 | |
| Cry1Ac20 | ABB89046 | | | Tan et al | 2005 | | |
| Cry1Ac21 | AAY66992 | | | Sauka et al | 2005 | INTA Mol-12 | |
| Cry1Ac22 | ABZ01836 | | | Zhang & Fang | 2008 | Bt W015-1 | |
| Cry1Ac23 | CAQ30431 | | | Kashyap et al | 2008 | Bt | |
| Cry1Ac24 | ABL01535 | | | Arango et al | 2008 | Bt 146-158- | |
| | | | | | | 01 | |
| Cry1Ac25 | FJ513324 | 237688242 | 237688241 | Guan et al | 2011 | Bt Tm37-6 | |
| Cry1Ac26 | FJ617446 | 256003038 | 256003037 | Guan et al | 2011 | Bt Tm41-4 | |
| Cry1Ac27 | FJ617447 | 256003040 | 256003039 | Guan et al | 2011 | Bt Tm44-1B | |
| Cry1Ac28 | ACM90319 | | | Li et al | 2009 | Bt Q-12 | |
| Cry1Ac29 | DQ438941 | | | Diego Sauka | 2009 | INTA TA24-6 | |
| Cry1Ac30 | GQ227507 | | | Zhang et al | 2010 | Bt S1478-1 | |
| Cry1Ac31 | GU446674 | 319433505 | | Zhao et al | 2010 | Bt S3299-1 | |
| Cry1Ac32 | HM061081 | | | Lu et al | 2010 | Bt ZQ-89 | |
| Cry1Ac33 | GQ866913 | 306977639 | 306977638 | Kaur & Meena | 2011 | Bt SK-711 | |
| Cry1Ac34 | HQ230364 | 314906994 | | Kaur & Kumari | 2010 | Bt SK-783 | |
| Cry1Ac35 | JF340157 | | | Kumari & Kaur | 2011 | Bt SK-784 | |
| Cry1Ac36 | JN387137 | | | Kumari & Kaur | 2011 | Bt SK-958 | |
| Cry1Ac37 | JQ317685 | | | Kumari & Kaur | 2011 | Bt SK-793 | |
| Cry1Ac38 | ACC86135 | | | Lin et al | 2008 | Bt LSZ9408 | |
| Cry1Ad1 | AAA22340 | | | Feitelson | 1993 | Bt aizawai | |
| | | | | | | PS81I | |
| Cry1Ad2 | CAA01880 | | | Anonymous | 1995 | Bt PS81RR1 | |
| Cry1Ae1 | AAA22410 | | | Lee & Aronson | 1991 | Bt alesti | |
| Cry1Af1 | AAB82749 | | | Kang et al | 1997 | Bt NT0423 | |
| Cry1Ag1 | AAD46137 | | | Mustafa | 1999 | | |
| Cry1Ah1 | AAQ14326 | | | Tan et al | 2000 | | |
| Cry1Ah2 | ABB76664 | | | Qi et al | 2005 | Bt alesti | |
| Cry1Ah3 | HQ439779 | | | Liu et al | 2010 | Bt S6 | No NCBI link |
| | | | | | | | June 13 |
| Cry1Ai1 | AAO39719 | | | Wang et al | 2002 | | |
| Cry1Ai2 | HQ439780 | | | Liu et al | 2010 | Bt SC6H8 | No NCBI link |
| | | | | | | | June 13 |
| Cry1A- | AAK14339 | | | Nagarathinam et | 2001 | Bt kunthala | uncertain |
| like | | | | al | | nags3 | sequence |
| Cry1Ba1 | CAA29898 | | | Brizzard & | 1988 | Bt | |
| | | | | Whiteley | | thuringiensis | |
| | | | | | | HD2 | |
| Cry1Ba2 | CAA65003 | | | Soetaert | 1996 | Bt | |
| | | | | | | entomocidus | |
| | | | | | | HD110 | |
| Cry1Ba3 | AAK63251 | | | Zhang et al | 2001 | | |
| Cry1Ba4 | AAK51084 | | | Nathan et al | 2001 | Bt | |
| | | | | | | entomocidus | |
| | | | | | | HD9 | |
| Cry1Ba5 | ABO20894 | | | Song et al | 2007 | Bt sfw-12 | |
| Cry1Ba6 | ABL60921 | | | Martins et al | 2006 | Bt S601 | |
| Cry1Ba7 | HQ439781 | | | Liu et al | 2010 | Bt N17-37 | No NCBI link |
| | | | | | | | June 13 |
| Cry1Bb1 | AAA22344 | | | Donovan et al | 1994 | Bt EG5847 | |
| Cry1Bb2 | HQ439782 | | | Liu et al | 2010 | Bt WBT-2 | No NCBI link |
| | | | | | | | June 13 |
| Cry1Bc1 | CAA86568 | | | Bishop et al | 1994 | Bt morrisoni | |
| Cry1Bd1 | AAD10292 | | | Kuo et al | 2000 | Bt | |
| | | | | | | wuhanensis | |
| | | | | | | HD525 | |
| Cry1Bd2 | AAM93496 | | | Isakova et al | 2002 | Bt 834 | |
| Cry1Be1 | AAC32850 | | | Payne et al | 1998 | Bt PS158C2 | |
| Cry1Be2 | AAQ52387 | | | Baum et al | 2003 | | |
| Cry1Be3 | ACV96720 | 259156864 | | Sun et al | 2010 | Bt g9 | |
| Cry1Be4 | HM070026 | | | Shu et al | 2010 | | No NCBI link |
| | | | | | | | June 13 |
| Cry1Bf1 | CAC50778 | | | Arnaut et al | 2001 | | |
| Cry1Bf2 | AAQ52380 | | | Baum et al | 2003 | | |
| Cry1Bg1 | AAO39720 | | | Wang et al | 2002 | | |
| Cry1Bh1 | HQ589331 | 315076091 | | Lira et al | 2010 | Bt PS46L | |
| Cry1Bi1 | KC156700 | | | Sampson et al | 2012 | | No NCBI link |
| | | | | | | | June 13 |
| Cry1Ca1 | CAA30396 | | | Honee et al | 1988 | Bt | |
| | | | | | | entomocidus | |
| | | | | | | 60.5 | |
| Cry1Ca2 | CAA31951 | | | Sanchis et al | 1989 | Bt aizawai | |
| | | | | | | 7.29 | |
| Cry1Ca3 | AAA22343 | | | Feitelson | 1993 | Bt aizawai | |
| | | | | | | PS81I | |
| Cry1Ca4 | CAA01886 | | | Van Mellaert et | 1990 | Bt | |
| | | | | al | | entomocidus | |
| | | | | | | HD110 | |
| Cry1Ca5 | CAA65457 | | | Strizhov | 1996 | Bt aizawai | |
| | | | | | | 7.29 | |
| Cry1Ca6 | AAF37224 | | | Yu et al | 2000 | Bt AF-2 | |
| [1] | | | | | | | |
| Cry1Ca7 | AAG50438 | | | Aixing et al | 2000 | Bt J8 | |
| Cry1Ca8 | AAM00264 | | | Chen et al | 2001 | Bt c002 | |
| Cry1Ca9 | AAL79362 | | | Kao et al | 2003 | Bt G10-01A | |
| Cry1Ca10 | AAN16462 | | | Lin et al | 2003 | Bt E05-20a | |
| Cry1Ca11 | AAX53094 | | | Cai et al | 2005 | Bt C-33 | |
| Cry1Ca12 | HM070027 | | | Shu et al | 2010 | | No NCBI link |
| | | | | | | | June 13 |
| Cry1Ca13 | HQ412621 | 312192962 | | Li & Luo | 2010 | Bt LB-R-78 | |
| Cry1Ca14 | JN651493 | | | Li Yuhong | 2011 | Bt LTS-38 | No NCBI link |
| | | | | | | | June 13 |
| Cry1Cb1 | M97880 | | | Kalman et al | 1993 | Bt galleriae | DNA sequence |
| | | | | | | HD29 | only |
| Cry1Cb2 | AAG35409 | | | Song et al | 2000 | Bt c001 | |
| Cry1Cb3 | ACD50894 | | | Huang et al | 2008 | Bt 087 | |
| Cry1Cb- | AAX63901 | | | Thammasittirong | 2005 | Bt TA476-1 | insufficient |
| like | | | | et al | | | sequence |
| Cry1Da1 | CAA38099 | | | Hofte et al | 1990 | Bt aizawai | |
| | | | | | | HD68 | |
| Cry1Da2 | I76415 | | | Payne & Sick | 1997 | | DNA sequence |
| | | | | | | | only |
| Cry1Da3 | HQ439784 | | | Liu et al | 2010 | Bt HD12 | No NCBI link |
| | | | | | | | June 13 |
| Cry1Db1 | CAA80234 | | | Lambert | 1993 | Bt | |
| | | | | | | BTS00349A | |
| Cry1Db2 | AAK48937 | | | Li et al | 2001 | Bt B-Pr-88 | |
| Cry1Dc1 | ABK35074 | | | Lertwiriyawong | 2006 | Bt JC291 | |
| | | | | et al | | | |
| Cry1Ea1 | CAA37933 | | | Visser et al | 1990 | Bt kenyae | |
| | | | | | | 4F1 | |
| Cry1Ea2 | CAA39609 | | | Bosse et al | 1990 | Bt kenyae | |
| Cry1Ea3 | AAA22345 | | | Feitelson | 1991 | Bt kenyae | |
| | | | | | | PS81F | |
| Cry1Ea4 | AAD04732 | | | Barboza-Corona | 1998 | Bt kenyae | |
| | | | | et al | | LBIT-147 | |
| Cry1Ea5 | A15535 | | | Botterman et al | 1994 | | DNA sequence |
| | | | | | | | only |
| Cry1Ea6 | AAL50330 | | | Sun et al | 1999 | Bt YBT-032 | |
| Cry1Ea7 | AAW72936 | | | Huehne et al | 2005 | Bt JC190 | |
| Cry1Ea8 | ABX11258 | | | Huang et al | 2007 | Bt HZM2 | |
| Cry1Ea9 | HQ439785 | | | Liu et al | 2010 | Bt S6 | No NCBI link |
| | | | | | | | June 13 |
| Cry1Ea10 | ADR00398 | | | Goncalves et al | 2010 | Bt BR64 | |
| Cry1Ea11 | JQ652456 | | | Lin Qunxin et al | 2012 | Bt | |
| Cry1Ea12 | KF601559 | | | Baonan He | 2013 | Bt strain V4 | No NCBI link |
| | | | | | | | Sep 13 |
| Cry1Eb1 | AAA22346 | | | Feitelson | 1993 | Bt aizawai | |
| | | | | | | PS81A2 | |
| Cry1Fa1 | AAA22348 | | | Chambers et al | 1991 | Bt aizawai | |
| | | | | | | EG6346 | |
| Cry1Fa2 | AAA22347 | | | Feitelson | 1993 | Bt aizawai | |
| | | | | | | PS81I | |
| Cry1Fa3 | HM070028 | | | Shu et al | 2010 | | No NCBI link |
| | | | | | | | June 13 |
| Cry1Fa4 | HM439638 | | | Liu et al | 2010 | Bt mo3-D10 | No NCBI link |
| | | | | | | | June 13 |
| Cry1Fb1 | CAA80235 | | | Lambert | 1993 | Bt | |
| | | | | | | BTS00349A | |
| Cry1Fb2 | BAA25298 | | | Masuda & | 1998 | Bt morrisoni | |
| | | | | Asano | | INA67 | |
| Cry1Fb3 | AAF21767 | | | Song et al | 1998 | Bt morrisoni | |
| Cry1Fb4 | AAC10641 | | | Payne et al | 1997 | | |
| Cry1Fb5 | AAO13295 | | | Li et al | 2001 | Bt B-Pr-88 | |
| Cry1Fb6 | ACD50892 | | | Huang et al | 2008 | Bt 012 | |
| Cry1Fb7 | ACD50893 | | | Huang et al | 2008 | Bt 087 | |
| Cry1Ga1 | CAA80233 | | | Lambert | 1993 | Bt BTS0349A | |
| Cry1Ga2 | CAA70506 | | | Shevelev et al | 1997 | Bt | |
| | | | | | | wuhanensis | |
| Cry1Gb1 | AAD10291 | | | Kuo & Chak | 1999 | Bt | |
| | | | | | | wuhanensis | |
| | | | | | | HD525 | |
| Cry1Gb2 | AAO13756 | | | Li et al | 2000 | Bt B-Pr-88 | |
| Cry1Gc1 | AAQ52381 | | | Baum et al | 2003 | | |
| Cry1Ha1 | CAA80236 | | | Lambert | 1993 | Bt | |
| | | | | | | BTS02069AA | |
| Cry1Hb1 | AAA79694 | | | Koo et al | 1995 | Bt morrisoni | |
| | | | | | | BF190 | |
| Cry1Hb2 | HQ439786 | | | Liu et al | 2010 | Bt WBT-2 | No NCBI link |
| | | | | | | | June 13 |
| Cry1H- | AAF01213 | | | Srifah et al | 1999 | Bt JC291 | insufficient |
| like | | | | | | | sequence |
| Cry1Ia1 | CAA44633 | | | Tailor et al | 1992 | Bt kurstaki | |
| Cry1Ia2 | AAA22354 | | | Gleave et al | 1993 | Bt kurstaki | |
| Cry1Ia3 | AAC36999 | | | Shin et al | 1995 | Bt kurstaki | |
| | | | | | | HD1 | |
| Cry1Ia4 | AAB00958 | | | Kostichka et al | 1996 | Bt AB88 | |
| Cry1Ia5 | CAA70124 | | | Selvapandiyan | 1996 | Bt 61 | |
| Cry1Ia6 | AAC26910 | | | Zhong et al | 1998 | Bt kurstaki | |
| | | | | | | S101 | |
| Cry1Ia7 | AAM73516 | | | Porcar et al | 2000 | Bt | |
| Cry1Ia8 | AAK66742 | | | Song et al | 2001 | | |
| Cry1Ia9 | AAQ08616 | | | Yao et al | 2002 | Bt Ly30 | |
| Cry1Ia10 | AAP86782 | | | Espindola et al | 2003 | Bt | |
| | | | | | | thuringiensis | |
| Cry1Ia11 | CAC85964 | | | Tounsi et al | 2003 | Bt kurstaki | |
| | | | | | | BNS3 | |
| Cry1Ia12 | AAV53390 | | | Grossi de Sa et | 2005 | Bt | |
| | | | | al | | | |
| Cry1Ia13 | ABF83202 | | | Martins et al | 2006 | Bt | |
| Cry1Ia14 | ACG63871 | | | Liu & Guo | 2008 | Bt11 | |
| Cry1Ia15 | FJ617445 | 256003036 | 256003035 | Guan et al | 2011 | Bt E-1B | |
| Cry1Ia16 | FJ617448 | 256003042 | 256003041 | Guan et al | 2011 | Bt E-1A | |
| Cry1Ia17 | GU989199 | | | Li et al | 2010 | Bt MX2 | |
| Cry1Ia18 | ADK23801 | 300492624 | | Li et al | 2010 | Bt MX9 | |
| Cry1Ia19 | HQ439787 | | | Liu et al | 2010 | Bt SC6H6 | No NCBI link |
| | | | | | | | June 13 |
| Cry1Ia20 | JQ228426 | | | Zhao Can | 2011 | Bt wu1H-3 | No NCBI link |
| | | | | | | | June 13 |
| Cry1Ia21 | JQ228424 | | | Zhao Can | 2011 | Bt you1D-9 | No NCBI link |
| | | | | | | | June 13 |
| Cry1Ia22 | JQ228427 | | | Zhao Can | 2011 | Bt wu1E-3 | No NCBI link |
| | | | | | | | June 13 |
| Cry1Ia23 | JQ228428 | | | Zhao Can | 2011 | Bt wu1E-4 | No NCBI link |
| | | | | | | | June 13 |
| Cry1Ia24 | JQ228429 | | | Zhao Can | 2011 | Bt wu2B-6 | No NCBI link |
| | | | | | | | June 13 |
| Cry1Ia25 | JQ228430 | | | Zhao Can | 2011 | Bt wu2G-11 | No NCBI link |
| | | | | | | | June 13 |
| Cry1Ia26 | JQ228431 | | | Zhao Can | 2011 | Bt wu2G-12 | No NCBI link |
| | | | | | | | June 13 |
| Cry1Ia27 | JQ228432 | | | Zhao Can | 2011 | Bt you2D-3 | No NCBI link |
| | | | | | | | June 13 |
| Cry1Ia28 | JQ228433 | | | Zhao Can | 2011 | Bt you2E-3 | No NCBI link |
| | | | | | | | June 13 |
| Cry1Ia29 | JQ228434 | | | Zhao Can | 2011 | Bt you2F-3 | No NCBI link |
| | | | | | | | June 13 |
| Cry1Ia30 | JQ317686 | | | Kumari & Kaur | 2011 | Bt 4J4 | |
| Cry1Ia31 | JX944038 | | | Song et al | 2012 | Bt SC-7 | |
| Cry1Ia32 | JX944039 | | | Song et al | 2012 | Bt SC-13 | |
| Cry1Ia33 | JX944040 | | | Song et al | 2012 | Bt SC-51 | |
| Cry1Ib1 | AAA82114 | | | Shin et al | 1995 | Bt | |
| | | | | | | entomocidus | |
| | | | | | | BP465 | |
| Cry1Ib2 | ABW88019 | | | Guan et al | 2007 | Bt PP61 | |
| Cry1Ib3 | ACD75515 | | | Liu & Guo | 2008 | Bt GS8 | |
| Cry1Ib4 | HM051227 | 301641366 | | Zhao et al | 2010 | Bt BF-4 | |
| Cry1Ib5 | HM070028 | | | Shu et al | 2010 | | No NCBI link |
| | | | | | | | June13 |
| Cry1Ib6 | ADK38579 | 300836937 | | Li et al | 2010 | Bt LB52 | |
| Cry1Ib7 | JN571740 | | | Kumari & Kaur | 2011 | Bt SK-935 | |
| Cry1Ib8 | JN675714 | | | Swamy et al | 2011 | | |
| Cry1Ib9 | JN675715 | | | Swamy et al | 2011 | | |
| Cry1Ib10 | JN675716 | | | Swamy et al | 2011 | | |
| Cry1Ib11 | JQ228423 | | | Zhao Can | 2011 | Bt HD12 | No NCBI link |
| | | | | | | | June 13 |
| Cry1Ic1 | AAC62933 | | | Osman et al | 1998 | Bt C18 | |
| Cry1Ic2 | AAE71691 | | | Osman et al | 2001 | | |
| Cry1Id1 | AAD44366 | | | Choi | 2000 | | |
| Cry1Id2 | JQ228422 | | | Zhao Can | 2011 | Bt HD12 | No NCBI link |
| | | | | | | | June 13 |
| Cry1Ie1 | AAG43526 | | | Song et al | 2000 | Bt BTC007 | |
| Cry1Ie2 | HM439636 | | | Liu et al | 2010 | Bt T03B001 | No NCBI link |
| | | | | | | | June 13 |
| Cry1Ie3 | KC156647 | | | Sampson et al | 2012 | | No NCBI link |
| | | | | | | | June 13 |
| Cry1Ie4 | KC156681 | | | Sampson et al | 2012 | | No NCBI link |
| | | | | | | | June 13 |
| Cry1If1 | AAQ52382 | | | Baum et al | 2003 | | |
| Cry1Ig1 | KC156701 | | | Sampson et al | 2012 | | No NCBI link |
| | | | | | | | June 13 |
| Cry1I-like | AAC31094 | | | Payne et al | 1998 | | insufficient |
| | | | | | | | sequence |
| Cry1I-like | ABG88859 | | | Lin & Fang | 2006 | Bt 1y4a3 | insufficient |
| | | | | | | | sequence |
| Cry1Ja1 | AAA22341 | | | Donovan | 1994 | Bt EG5847 | |
| Cry1Ja2 | HM070030 | | | Shu et al | 2010 | | No NCBI link |
| | | | | | | | June 13 |
| Cry1Ja3 | JQ228425 | | | Zhao Shiyuan | 2011 | Bt FH21 | No NCBI link |
| | | | | | | | June 13 |
| Cry1Jb1 | AAA98959 | | | Von Tersch & | 1994 | Bt EG5092 | |
| | | | | Gonzalez | | | |
| Cry1Jc1 | AAC31092 | | | Payne et al | 1998 | | |
| Cry1Jc2 | AAQ52372 | | | Baum et al | 2003 | | |
| Cry1Jd1 | CAC50779 | | | Arnaut et al | 2001 | Bt | |
| Cry1Ka1 | AAB00376 | | | Koo et al | 1995 | Bt morrisoni | |
| | | | | | | BF190 | |
| Cry1Ka2 | HQ439783 | | | Liu et al | 2010 | Bt WBT-2 | No NCBI link |
| | | | | | | | June 13 |
| Cry1La1 | AAS60191 | | | Je et al | 2004 | Bt kurstaki | |
| | | | | | | K1 | |
| Cry1La2 | HM070031 | | | Shu et al | 2010 | | No NCBI link |
| | | | | | | | June 13 |
| Cry1Ma1 | FJ884067 | | | Noguera & | 2010 | LBIT 1189 | |
| | | | | Ibarra | | | |
| Cry1Ma2 | KC156659 | | | Sampson et al | 2012 | | No NCBI link |
| | | | | | | | June 13 |
| Cry1Na1 | KC156648 | | | Sampson et al | 2012 | | No NCBI link |
| | | | | | | | June 13 |
| Cry1Nb1 | KC156678 | | | Sampson et al | 2012 | | No NCBI link |
| | | | | | | | June 13 |

Particular preference is given to the genes or gene sections of the subfamilies cry1, cry2, cry3, cry5 and cry9; especially preferred are members of the subfamily cry1A such as cry1Aa, cry1Ac, cry2Ab.

Furthermore, it is preferred to use plants which, in addition to the genes for one or more Bt toxins, express or contain, if appropriate, also genes for expressing, for example, a protease or peptidase inhibitor (such as in WO-A 95/35031), of herbicide resistances (for example to glufosinate or glyphosate by expression of the pat gene or bar gene) or for becoming resistant to nematodes, fungi or viruses (for example by expressing a gluconase, chitinase). However, they may also be genetically modified in their metabolic properties, so that they show a qualitative and/or quantitative change of ingredients (for example by modification of the energy, carbohydrate, fatty acid or nitrogen metabolism or by metabolite currents influencing these (see above).

In one preferred embodiment, a Bt-plant, preferably a Bt-soybean, comprises event MON87701 which is described in, e.g., WO2009/064652. Thus, in one preferred embodiment, a Bt-soybean seeds comprising said event of which a representative sample was deposited at the ATCC under Accession No. PTA-8194 are treated with a ryanodine receptor modulator according to the present invention.

In another preferred embodiment, a Bt-soybean comprises event pDAB9582.814.19.1 and/or event pDAB4468.04.16.1 which are described in, e.g., WO 2013/016516. This breeding stacks comprise cry1F, cry1Ac and pat and aad-12 and pat, as described in WO 2012/075426. Thus, in one preferred embodiment, a Bt-soybean seeds of which comprising said events were deposited at the ATCC under Accession No. PTA-10442 (pDAB4468.04.16.1) are treated with a ryanodine receptor modulator according to the present invention.

In one preferred embodiment, the method of the invention is characterized in that the Bt-plant, preferably a Bt-soybean plant, comprises at least one cry-gene or a cry-gene fragment coding for a Bt toxin.

In one preferred embodiment, said method is characterized in that the Bt-plant, preferably Bt-soybean plant, comprises at least one cry1A-gene or cry1A-gene fragment coding for a Bt toxin.

In one preferred embodiment, said method is characterized in that said Bt-plant, preferably Bt-soybean plant, further comprising a cryF gene or cryF-gene fragment coding for a Bt toxin.

In another preferred embodiment, said method is characterized in that said plant, preferably said soybean plant, comprises event MON87701.

In a more preferred embodiment, said soybean plant comprises event MON87701 and event MON89788, e.g. Intacta™ Roundup Ready™ 2 Pro.

In another preferred embodiment, said method is characterized in that said soybean plant comprising DNA that comprises a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; bp 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 15; bp 2530-2930 of SEQ ID NO: 15; bp 9071-9171 of SEQ ID NO: 15; bp 9021-9221 of SEQ ID NO: 15; and, bp 8921-9321 of SEQ ID NO: 15 said first and second sequences being diagnostic for the presence of soybean event pDAB9582.814.19.1::pDAB4468.04.16.1. pDAB9582.814.19.1::pDAB4468.04.16.1 are disclosed in WO 2013/016516.

In one preferred embodiment, said method is characterized in that said soybean plant comprising a nucleotide sequence of SEQ ID NO: 4, SEQ ID NO:5, or complement thereof.

In one preferred embodiment, said method is characterized in that said soybean plant comprising a nucleotide sequence of SEQ ID NO:6, SEQ ID NO:7, SEQ ID NO:9 or complement thereof.

In one preferred embodiment, said method is characterized in that said soybean plant comprising a nucleotide sequence of SEQ ID NO:6 from positions 1 to 5757, the nucleotide sequence of SEQ ID NO:8 from positions 1 to 6426, and the nucleotide sequence of SEQ ID NO:7 from positions 379 to 2611, or complement thereof.

In one preferred embodiment, said method is characterized in that said soybean plant comprising a nucleotide sequence essentially of the nucleotide sequence of SEQ ID NO: 9 or complement thereof.

In another preferred embodiment, said method is characterized in that said pest is selected from the group consisting of Pseudoplusia includens (soybean looper), Anticarsia gemmatalis (velvet bean caterpillar) and Spodoptera frugiperda (fall armyworm).

In another preferred embodiment, said method is characterized in that the use form of the ryanodine receptor modulator is present in a mixture with at least one mixing partner.

A second aspect refers to a method for improving the utilization of the production potential of transgenic soybean plants in the absent of a pest. Preferred embodiments of this aspect are identical to the preferred embodiments disclosed for the first aspect of the present invention.

A third aspect refers to a synergistic composition comprising Bt toxins encoded by a nucleotide sequence that comprises
a first sequence selected from the group consisting of bp 1385-1415 of SEQ ID NO: 1; bp 1350-1450 of SEQ ID NO: 1; bp 1300-1500 of SEQ ID NO: 1; bp 1200-1600 of SEQ ID NO: 1; by 137-168 of SEQ ID NO:2; bp 103-203 of SEQ ID NO:2; and bp 3-303 of SEQ ID NO:2; and a second sequence selected from the group consisting bp 2680-2780 of SEQ ID NO: 3; bp 2630-2830 of SEQ ID NO: 15; bp 2530-2930 of SEQ ID NO: 15; bp 9071-9171 of SEQ ID NO: 15; bp 9021-9221 of SEQ ID NO: 15; and, bp 8921-9321 of SEQ ID NO: 15 or
a nucleotide sequence of SEQ ID NO: 4, SEQ ID NO:5, or complement thereof
   and a ryanodine receptor modulator as described herein.

A fourth aspect refers to a Bt-soybean plant, characterized in that at least 0.00001 g of a ryanodine receptor modulator as described herein is attached to it.

SEQ ID No: 1 (disclosed in WO 2013/016516) is the 5′ DNA flanking border sequence for soybean event pDAB9582.814.19.1. Nucleotides 1-1400 are genomic sequence. Nucleotides 1401-1535 are a rearranged sequence from pDAB9582. Nucleotides 1536-1836 are insert sequence.

SEQ ID No: 2 (disclosed in WO 2013/016516) is the 3′ DNA flanking border sequence for soybean event pDAB9582.814.19.1. Nucleotides 1-152 are insert sequence. Nucleotides 153-1550 are genomic sequence.

SEQ ID No: 3 (disclosed in WO 2013/016516) is the confirmed sequence of soybean event pDAB4468.04.16.1. Including the 5′ genomic flanking sequence, pDAB4468 T-strand insert, and 3′ genomic flanking sequence.

SEQ ID No:4 (disclosed in WO 2009/064652) is a A 20 nucleotide sequence representing the junction between the soybean genomic DNA and an integrated expression cassette. This sequence corresponds to positions 5748 to 5767 of SEQ ID NO:9. In addition, SEQ ID NO: 1 is a nucleotide sequence corresponding to positions 5748 through 5757 of SEQ ID NO:6 and the integrated right border of the TIC 107 expression cassette corresponding to positions 1 through 10 of SEQ ID NO:8. SEQ ID NO:1 also corresponds to positions 5748 to 5767 of the 5′ flanking sequence, SEQ ID NO:6.

SEQ ID No: 5 (disclosed in WO 2009/064652) is a 20 nucleotide sequence representing the junction between an integrated expression cassette and the soybean genomic DNA. This sequence corresponds to positions 12174 to 12193 of SEQ ID NO:9. In addition, SEQ ID NO:2 is a nucleotide sequence corresponding positions 6417 through 6426 of SEQ ID NO:8 and the 3′ flanking sequence corresponding to positions 379 through 388 of SEQ ED NO:7.

SEQ ID No: 6 (disclosed in WO 2009/064652) is the 5′ sequence flanking the inserted DNA of MON87701 up to and including a region of transformation DNA (T-DNA) insertion.

SEQ ID No: 7 (disclosed in WO 2009/064652) is the 3′ sequence flanking the inserted DNA of MON87701 up to and including a region of T-DNA insertion.

SEQ ID No: 8 (disclosed in WO 2009/064652) is the sequence of the integrated TIC 107 expression cassette, including right and left border sequence after integration.

SEQ ID No: 9 (disclosed in WO 2009/064652) is a 14,416 bp nucleotide sequence representing the contig of the 5′ sequence flanking the inserted DNA of MON87701 (SEQ ID NO:6), the sequence of the integrated expression cassette (SEQ ID NO:8) and the 3′ sequence flanking the inserted DNA of MON87701 (SEQ ID NO: 7).

A nucleic acid molecule is said to be the “complement” of another nucleic acid molecule if they exhibit complete complementarity. As used herein, molecules are said to exhibit “complete complementarity” when every nucleotide of one of the molecules is complementary to a nucleotide of the other. Two molecules are said to be “minimally complementary” if they can hybridize to one another with sufficient stability to permit them to remain annealed to one another under at least conventional “low-stringency” conditions. Similarly, the molecules are said to be “complementary” if they can hybridize to one another with sufficient stability to permit them to remain annealed to one another under conventional “high-stringency” conditions. Conventional stringency conditions are described by Sambrook et al, 1989, and by Haymes et al, In: Nucleic Acid Hybridization, A Practical Approach, IRL Press, Washington, D.C. (1985), Departures from complete complementarity are therefore permissible, as long as such departures do not completely preclude the capacity of the molecules to form a double-stranded structure. In order for a nucleic acid molecule to serve as a primer or probe it need only be sufficiently complementary in sequence to be able to form a stable double-stranded structure under the particular solvent and salt concentrations employed.

As used herein, a “substantially homologous sequence” is a nucleic acid sequence that will specifically hybridize to the complement of the nucleic acid sequence to which it is being compared under high stringency conditions. Appropriate stringency conditions which promote DNA hybridization, for example, 6.0× sodium chloride/sodium citrate (SSC) at about 45<0>C, followed by a wash of 2.0×SSC at 50<0>C, are known to those skilled in the art or can be found in Current Protocols in Molecular Biology, John Wiley & Sons, N.Y. (1989), 6.3.1-6.3.6. For example, the salt concentration in the wash step can be selected from a low stringency of about 2.0×SSC at 50<0>C to a high stringency of about 0.2×SSC at 50<0>C. In addition, the temperature in the wash step can be increased from low stringency conditions at room temperature, about 22<0>C, to high stringency conditions at about 65<0>C. Both temperature and salt may be varied, or either the temperature or the salt concentration may be held constant while the other variable is changed. In a preferred embodiment, a nucleic acid of the present invention will specifically hybridize to one or more of the nucleic acid molecules set forth in SEQ ID NO: 1 and 2 or complements thereof or fragments of either under moderately stringent conditions, for example at about 2.0×SSC and about 65<0>C. In a particularly preferred embodiment, a nucleic acid of the present invention will specifically hybridize to one or more of the nucleic acid molecules set forth in SEQ ID NO: 1 and SEQ ID NO:2 or complements or fragments of either under high stringency conditions. In one aspect of the present invention, a preferred marker nucleic acid molecule of the present invention has the nucleic acid sequence set forth in SEQ ID NO:1 and SEQ ID NO:2 or complements thereof or fragments of either. In another aspect of the present invention, a preferred marker nucleic acid molecule of the present invention shares 80%, 81%, 82%, 83%, 84%, 85%, 86%, 87%, 88%, 89%, 90%, 91%, 92%, 93%, 94%, 95%, 96%, 97%, 98%, 99% and 100% sequence identity with the nucleic acid sequence set forth in SEQ ID NO:1 and SEQ ID NO:2 or complement thereof or fragments of either. In a further aspect of the present invention, a preferred marker nucleic acid molecule of the present invention shares 95% 96%, 97%, 98%, 99% and 100% sequence identity with the sequence set forth in SEQ ID NO:1 and SEQ ID NO: 2 or complement thereof or fragments of either. SEQ ID NO:1 and SEQ ID NO:2 may be used as markers in plant breeding methods to identify the progeny of genetic crosses similar to the methods described for simple sequence repeat DNA marker analysis, in “DNA markers: Protocols, applications, and overviews: (1997) 173-185, Cregan, et al., eds., Wiley-Liss NY”; all of which is herein incorporated by reference. The hybridization of the probe to the target DNA molecule can be detected by any number of methods known to those skilled in the art, these can include, but are not limited to, fluorescent tags, radioactive tags, antibody based tags, and chemilluminescent tags.

Regarding the amplification of a target nucleic acid sequence (e.g., by PCR) using a particular amplification primer pair, “stringent conditions” are conditions that permit the primer pair to hybridize only to the target nucleic-acid sequence to which a primer having the corresponding wild-type sequence (or its complement) would bind and preferably to produce a unique amplification product, the amplicon, in a DNA thermal amplification reaction.

The term “specific for (a target sequence)” indicates that a probe or primer hybridizes under stringent hybridization conditions only to the target sequence in a sample comprising the target sequence.

In a particularly preferred variant, the process according to the invention is used for treating transgenic vegetable, maize, soya bean, cotton, tobacco, rice, potato and sugar beet varieties. These are preferably Bt plants.

The vegetable plants or varieties are, for example, the following useful plants:
potatoes: preferably starch potatoes, sweet potatoes and table potatoes;
root vegetables: preferably carrots, turnips (swedes, stubble turnips (Brassica rapa var. rapa), spring turnips, autumn turnips (Brassica campestris ssp. rapifera), Brassica rapa L. ssp. rapa f. teltowiensis), scorzonera, Jerusalem artichoke, turnip-rooted parsley, parsnip, radish and horseradish;
tuber vegetables: preferably kohlrabi, beetroot, celeriac, garden radish;
bulb crops: preferably scallion, leek and onions (planting onions and seed onions);
brassica vegetables: preferably headed cabbage (white cabbage, red cabbage, kale, savoy cabbage), cauliflowers, broccoli, curly kale, marrow-stem kale, seakale and Brussels sprouts;
fruiting vegetables: preferably tomatoes (outdoor tomatoes, vine-ripened tomatoes, beef tomatoes, greenhouse tomatoes, cocktail tomatoes, industrial and fresh market tomatoes), melons, eggplants, aubergines, pepper (sweet pepper and hot pepper, Spanish pepper), chilli pepper, pumpkins, courgettes and cucumbers (outdoor cucumbers, greenhouse cucumbers snake gourds and gherkins);
vegetable pulses: preferably bush beans (as sword beans, string beans, flageolet beans, wax beans, corn beans of green- and yellow-podded cultivars), pole beans (as sword beans, string beans, flageolet beans, wax beans of green-, blue- and yellow-podded cultivars), broadbeans (field beans, Windsor beans, cultivars having white- and black-spotted flowers), peas (chickling vetch, chickpeas, marrow peas, shelling peas, sugar-peas, smooth peas, cultivars having light- and dark-green fresh fruits) and lentils;
green vegetables and stem vegetables: preferably Chinese cabbage, round-headed garden lettuce, curled lettuce, lamb's-lettuce, iceberg lettuce, romaine lettuce, oakleaf lettuce, endives, radicchio, lollo rossa, ruccola lettuce, chicory, spinach, chard (leaf chard and stem chard) and parsley;
other vegetables: preferably asparagus, rhubarb, chives, artichokes, mint varieties, sunflowers, Florence fennel, dill, garden cress, mustard, poppy seed, peanuts, sesame and salad chicory.

Bt vegetables including exemplary methods for preparing them are described in detail, for example, in Barton et al., 1987, Plant Physiol. 85: 1103-1109; Vaeck et al., 1987, Nature 328: 33-37; Fischhoff et al., 1987, Bio/Technology 5: 807-813. In addition, Bt vegetable plants are already known as commercial varieties, for example the potato cultivar NewLeaf® (Monsanto). The preparation of Bt vegetables is also described in U.S. Pat. No. 6,072,105.

Likewise, Bt cotton is already known in principle, for example from U.S. Pat. No. 5,322,938. In the context of the present invention, particular preference is given to Bt cotton with the trade names NuCOTN33® and NuCOTN33B®.

The use and preparation of Bt maize has likewise already been known for a long time, for example from Ishida, Y., Saito, H., Ohta, S., Hiei, Y., Komari, T., and Kumashiro, T. (1996). High efficiency transformation of maize (Zea mayz L.) mediated by Agrobacterium tumefaciens, Nature Biotechnology 4: 745-750. EP-B-0485506, too, describes the preparation of Bt maize plants. Furthermore, different varieties of Bt maize are commercially available, for example under the following names (company/companies is/are in each case given in brackets): KnockOut® (Novartis Seeds), NaturGard® (Mycogen Seeds), Yieldgard® (Novartis Seeds, Monsanto, Cargill, Golden Harvest, Pioneer, DeKalb inter alia), Bt-Xtra® (DeKalb) and StarLink® (Aventis CropScience, Garst inter alia). For the purpose of the present invention, particular preference is given especially to the following maize cultivars: KnockOut®, NaturGard®, Yieldgard®, Bt-Xtra® and StarLink®.

For soya beans, too, Roundup®Ready cultivar or cultivars resistant to the herbicide Liberty Link® are available and can be treated according to the invention. In the case of rice, a large number of “Golden Rice” lines are available which are likewise characterized in that, by virtue of a transgenic modification, they have an increased content of provitamin A. They, too, are examples of plants which can be treated by the method according to the invention, with the advantages described.

The method according to the invention is suitable for controlling a large number of harmful organisms which occur in particular in vegetables, maize and cotton, in particular insects and arachnids, very particularly preferably insects. The pests mentioned include:
From the order of the Anoplura (Phthiraptera), for example, Damalinia spp., Haematopinus spp., Linognathus spp., Pediculus spp., Trichodectes spp.
From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.
From the class of the Bivalva, for example, Dreissena spp.
From the order of the Chilopoda, for example, Geophilus spp., Scutigera spp.
From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premno-trypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.
From the order of the Collembola, for example, Onychiurus armatus.
From the order of the Dermaptera, for example, Forficula auricularia.
From the order of the Diplopoda, for example, Blaniulus guttulatus.
From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypo-derma spp., Liriomyza spp. Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.
From the class of the Gastropoda, for example, Anion spp., Biomphalaria spp., Bulinus spp., Deroceras spp., Galba spp., Lymnaea spp., Oncomelania spp., Succinea spp.
From the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti.
It is furthermore possible to control Protozoa, such as Eimeria.
From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.
From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma pini, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.
From the order of the Hymenoptera, for example, Diprion spp., Hoplocampa spp., Lasius spp., Monomorium pharaonis, Vespa spp.
From the order of the Isopoda, for example, Armadillidium vulgare, Oniscus asellus, Por-cellio scaber.
From the order of the Isoptera, for example, Reticulitermes spp., Odontotermes spp.
From the order of the Lepidoptera, for example, Acronicta major, Aedia leucomelas, Agrotis spp., Alabama argillacea, Anticarsia spp., Barathra brassicae, Bucculatrix thur-beriella, Bupalus piniarius, Cacoecia podana, Capua reticulana, Carpocapsa pomonella, Cheimatobia brumata, Chilo spp., Choristoneura fumiferana, Clysia ambiguella, Cnaphalo-cerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mame-stra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.
From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.
From the order of the Siphonaptera, for example, Ceratophyllus spp., Xenopsylla cheopis.
From the order of the Symphyla, for example, Scutigerella immaculata.
From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.
From the order of the Thysanura, for example, Lepisma saccharina.
The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

The method according to the invention for the treatment of Bt vegetables, Bt maize, Bt cotton, Bt soya beans, Bt tobacco and also Bt rice, Bt sugar beets or Bt potatoes is particularly suitable for controlling aphids (Aphidina), whiteflies (Trialeurodes), thrips (Thysanoptera), spider mites (Arachnida), soft scale insects or mealy bugs (Coccoidae and Pseudococcoidae, respectively).

The active compounds which can be used according to the invention can be employed in customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active compound, synthetic substances impregnated with active compound, fertilizers and also microencapsulations in polymeric substances.

These formulations are prepared in a known manner, for example by mixing the active compounds with extenders, i.e. liquid solvents and/or solid carriers, if appropriate using surfactants, i.e. emulsifiers and/or dispersants and/or foam-formers. The formulations are prepared either in suitable plants or else before or during application.

Wettable powders are preparations which can be dispersed homogeneously in water and which, in addition to the active compound and beside a diluent or inert substance, also comprise wetting agents, for example polyethoxylated alkylphenols, polyethoxylated fatty alcohols, alkylsulphonates or alkylphenylsulphonates and dispersants, for example sodium lignosulphonate, sodium 2,2′-dinaphthylmethane-6,6′-disulphonate.

Dusts are obtained by grinding the active compound with finely distributed solid substances, for example talc, natural clays, such as kaolin, bentonite, pyrophillite or diatomaceous earth. Granules can be prepared either by spraying the active compound onto granular inert material capable of adsorption or by applying active compound concentrates to the surface of carrier substances, such as sand, kaolinites or granular inert material, by means of adhesives, for example polyvinyl alcohol, sodium polyacrylate or mineral oils. Suitable active compounds can also be granulated in the manner customary for the preparation of fertilizer granules—if desired as a mixture with fertilizers.

Suitable for use as auxiliaries are substances which are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulphoxide, and also water.

Suitable solid carriers are for example, ammonium salts and ground natural minerals such as kaolins, clays, talc, chalk, quartz, attapulgite, montmorillonite or diatomaceous earth, and ground synthetic minerals, such as finely divided silica, alumina and silicates; suitable solid carriers for granules are: for example, crushed and fractionated natural rocks such as calcite, marble, pumice, sepiolite and dolomite, and also synthetic granules of inorganic and organic meals, and granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

Tackifiers such as carboxymethylcellulose and natural and synthetic polymers in the form of powders, granules or lattices, such as gum arabic, polyvinyl alcohol and polyvinyl acetate, as well as natural phospholipids such as cephalins and lecithins, and synthetic phospholipids, can be used in the formulations.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

Other possible additives are perfumes, mineral or vegetable, optionally modified oils, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present.

These individual types of formulation are known in principle and are described, for example, in: “Pesticides Formulations”, 2nd Ed., Marcel Dekker N.Y.; Martens, 1979, “Spray Drying Handbook”, 3rd Ed., G. Goodwin Ltd. London.

Based on his general expert knowledge, the person skilled in the art is able to choose suitable formulation auxiliaries (in this context, see, for example, Watkins, “Handbook of Insecticide Dust Diluents and Carriers”, 2nd Ed., Darland Books, Caldwell N.J.).

In a preferred embodiment, the plants or plant parts are treated according to the invention with an oil-based suspension concentrate. An advantageous suspension concentrate is known from WO 2005/084435 (EP 1 725 104 A2). It consists of at least one room-temperature-solid active agrochemical substance, at least one “closed” penetrant, at least one vegetable oil or mineral oil, at least one nonionic surfactant and/or at least one anionic surfactant, and optionally one or more additives from the groups of the emulsifiers, foam inhibitors, preservatives, antioxidants, colorants and/or inert filler materials. Preferred embodiments of the suspension concentrate are described in the above-mentioned WO 2005/084435. For the purpose of the disclosure, both documents are incorporated herein in their entirety by way of reference.

In a further preferred embodiment, the plants or plant parts are treated according to the invention with compositions comprising ammonium or phosphonium salts and, if appropriate, penetrants. Advantageous compositions are known from WO2007/068355 and from the not prior-published EP 07109732.3. They consist of at least one compound of the formula (I) and at least one ammonium or phosphonium salt and, if appropriate, penetrants. Preferred embodiments are described in WO2007/068355 and the not prior-published EP 07109732.3. For the purpose of the disclosure, these documents are incorporated herein in their entirety by way of reference.

In general, the formulations comprise from 0.01 to 98% by weight of active compound, preferably from 0.5 to 90%. In wettable powders, the active compound concentration is, for example, from about 10 to 90% by weight, the remainder to 100% by weight consisting of customary formulation components. In the case of emulsifiable concentrates, the active compound concentration can be from about 5 to 80% by weight. In most cases, formulations in the form of dusts comprise from 5 to 20% by weight of active compound, sprayable solutions comprise about 2 to 20% by weight. In the case of granules, the active compound content depends partially on whether the active compound is present in liquid or solid form and on which granulation auxiliaries, fillers, etc., are used.

The required application rate may also vary with external conditions such as, inter alia, temperature and humidity. It may vary within wide limits, for example between 0.1 g/h and 5.0 kg/ha or more of active substance. However, they are preferably between 0.1 g/ha and 1.0 kg/ha. Owing to the synergistic effects between Bt vegetables and the insecticide, particular preference is given to application rates of from 0.1 to 500 g/ha.

For compounds of the formula (I), preference is given to application rates of from 10 to 500 g/ha; particularly preferred are from 10 to 200 g/ha.

In a particular embodiment of the method according to the invention, the compound of the formula (I) is employed in an application rate of from 0.1 g/ha to 5.0 kg/ha, preferably from 0.1 to 500 g/ha and particularly preferably from 50 to 500 g/ha and especially preferably from 50 to 200 g/ha.

In their commercial formulations and in the use forms prepared from these formulations, the active compounds according to the invention may be present as mixtures with other active compounds, such as insecticides, attractants, sterilants, acaricides, nematicides, fungicides, growth-regulating substances or herbicides.

A mixture with other known compounds, such as herbicides, fertilizers, growth regulators, safeners, semiochemicals, or else with agents for improving plant properties is also possible.

The active compound content of the use forms prepared from the commercial formulations can be from 0.00000001 to 95% by weight, preferably between 0.00001 and 1% by weight, of active compound.

### Example

### Compound (1-5) on Transgenic Bt-Plant

### Spodoptera frugiperda—Spray Application on Transgenic Soy Bean, Field Trial

For preparing the stock solution, 20 mg of active compound is solved in 200 μl of dimethylformamide and filled-up with 9.78 ml SC blank formulation of Belt. The final test concentrations are prepared by dilution with water.

The test is conducted with conventional soybean plants (Glycine max; non-transgenic) and transgenic soybean plants containing a Cry1Ac gene (Intacta from Monsanto). When the plants are in stage V2 (3 nodes with 2 unfolded trifoliolates), they are treated by spray application with the active compound preparation. After application, clip-cages with 5-6 L2 larvae of the fall army worm (Spodoptera frugiperda) are placed on the leaves.

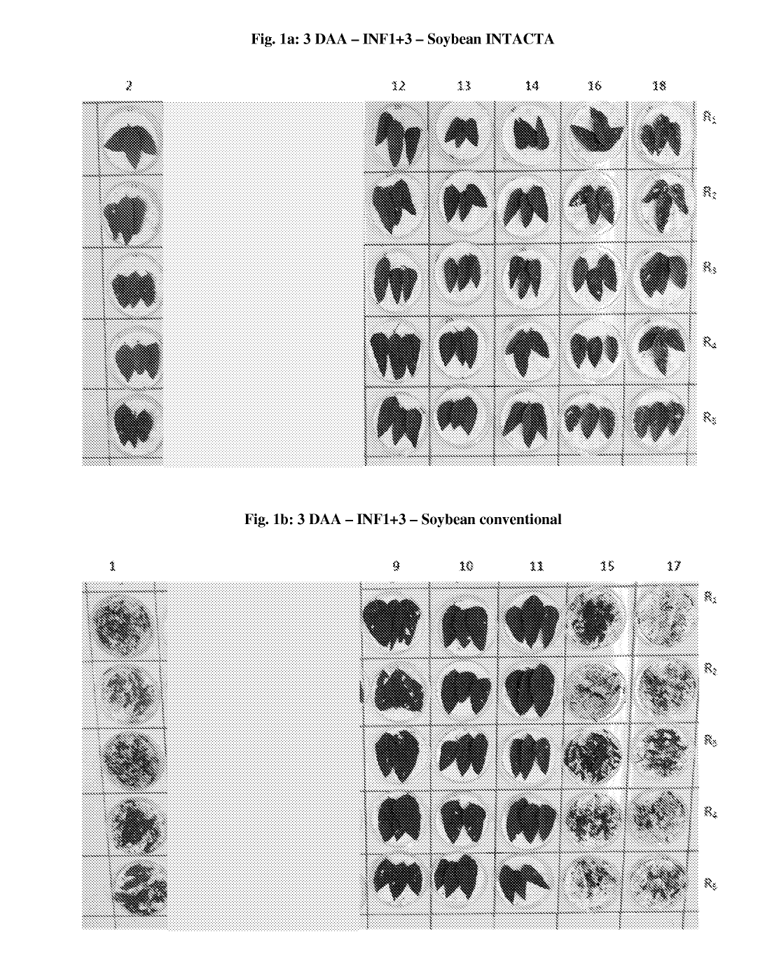

After the specified period of time, feeding damage (white holes on leaves) of Spodoptera frugiperda on conventional soybean, FIG. 1a, in comparison to Intacta soybean, FIG. 1b, is visualized on 3 randomly picked soybean leaves out of 5 replicate plots (R₁-R₅).

According to the present application in this test the following combinations of transgenic plant and compound shows a superior effect compared to the treated, non-transgenic plant respectively the non-treated, transgenic plant:

TABLE A
3 days after application (3 DAA)
Infection 1 + 3 days (Inf 1 + 3)
5 replicates per variety

| | Compound | Conc. [g ai/ha] | Soy variety |
|---|---|---|---|
| 1 | Untreated control | | Conventional |
| 2 | Untreated control | | Intacta |
| 9 | Compound (I-5) | 12 | Conventional |
| 10 | Compound (I-5) | 24 | Conventional |
| 11 | Compound (I-5) | 36 | Conventional |
| 12 | Compound (I-5) | 12 | Intacta |
| 13 | Compound (I-5) | 24 | Intacta |
| 14 | Compound (I-5) | 36 | Intacta |
| 15 | SC blank formulation | 0 | Conventional |
| 16 | SC blank formulation | 0 | Intacta |
| 17 | Water | 0 | Conventional |
| 18 | Water | 0 | Intacta |

Results of the experiments 1, 2 and 9 to 18 of Table A are shown in FIGS. 1a and 1b

1. Method for improving utilization of production potential of a transgenic plant and/or for controlling/combating/treating insect and/or nematode pests, comprising treating the plant with an effective amount of at least one compound of formula (I) 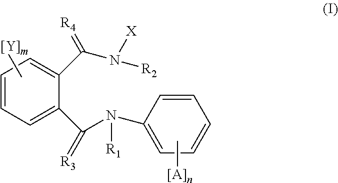
wherein
A represents individually halogen, cyano, nitro, hydroxyl, amino, C₁-C₈ alkyl group, substituted C₁-C₈ alkyl group having at least one substituent elected from the group consisting of halogen, hydroxy, cyano, nitro, amino, halo C₁-C₃ alkyl group, C₁-C₃ alkoxy group, halo C₁-C₃ alkoxy group, C₁-C₃ alkylthio group, halo C₁-C₃ alkylthio group, C₁-C₃ alkylsulfinyl group, halo C₁-C₃ alkylsulfinyl group, C₁-C₃ alkylsulfonyl group, halo C₁-C₃ alkylsulfonyl group and C₁-C₃ alkylthio, C₁-C₃ alkyl group; further, an arbitrary saturated carbon atom in said optionally substituted C₁-C₈ alkyl group;
n represents 0, 1, 2, 3 or 4, optionally 0, 1 or 2;
R₁ represents hydrogen, halogen, cyano C₁-C₈ alkyl or C₁-C₈ haloalkyl;
R₂ represents hydrogen, halogen, cyano C₁-C₈ alkyl or C₁-C₈ haloalkyl;
R₃ represents O or S;
R₄ represents O or S;
Y represents individually hydrogen, halogen, cyano, nitro, C₁-C₆ alkyl group, halo C₁-C₆ alkyl group, C₂-C₆ alkenyl group, halo C₂-C₆ alkenyl group, C₂-C₆ alkynyl group, halo C₂-C₆ alkynyl group, C₃-C₆ cycloalkyl group, halo C₃-C₆ cycloalkyl group, C₁-C₆ alkoxy group, halo C₁-C₆ alkoxy group, C₁-C₆ alkylthio group, halo C₁-C₆ alkylthio group, C₁-C₆ alkylsulfinyl group, halo C₁-C₆ alkylsulfinyl group, C₁-C₆ alkylsulfonyl group, or halo C₁-C₆ alkylsulfonyl group;
m represents 0, 1, 2, 3, or 4;
X represents a C₁-C₈ alkyl group or a substituted C₁-C₈ alkyl group having at least one substituent selected from the group consisting of halogen, hydroxy, cyano, nitro, amino, halo C₁-C₃ alkyl group, C₁-C₃ alkoxy group, halo C₁-C₃ alkoxy group.

2. Method according to claim 1, wherein the compound of formula (I) is formula (I-1): 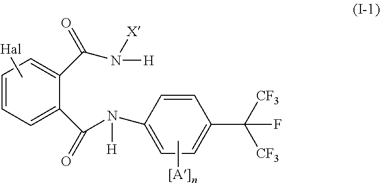
wherein
Hal represents F, Cl, I or Br; and
X′ represents C₁-C₆ alkyl or substituted C₁-C₆ alkyl having at least one substituent selected from the group consisting of halogen, hydroxy, cyano, nitro, amino, halo C₁-C₃ alkyl group, optionally a C₁-C₆ cyanoalkyl;
A′ represents C₁-C₃ alkyl, C₁-C₃ haloalkyl, halogen, optionally methyl, halomethyl, ethyl or haloethyl, optionally methyl or ethyl;
n represents 0, 1, 2, 3 or 4, optionally 0, 1 or 2, optionally 1.

3. Method according to claim 1, wherein the compound of the formula (I) is selected from the group consisting of compound (I-2), (I-3), (I-4) or (I-5):

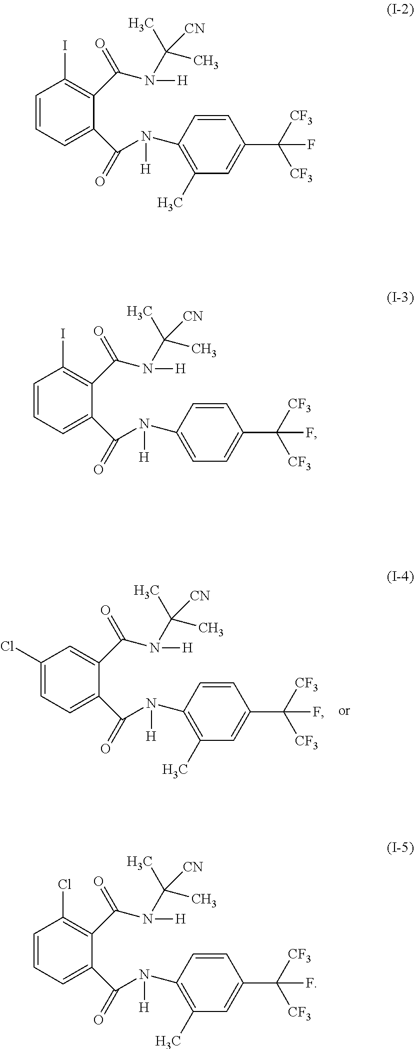 [SMILES: Cc1cc(C(F)(C(F)(F)F)C(F)(F)F)ccc1NC(=O)c1cccc(I)c1C(=O)NC(C)(C)C#N ; CC(C)(C#N)NC(=O)c1c(I)cccc1C(=O)Nc1ccc(C(F)(C(F)(F)F)C(F)(F)F)cc1 ; Cc1cc(C(F)(C(F)(F)F)C(F)(F)F)ccc1NC(=O)c1ccc(Cl)cc1C(=O)NC(C)(C)C#N ; "or" ; Cc1cc(C(F)(C(F)(F)F)C(F)(F)F)ccc1NC(=O)c1cccc(Cl)c1C(=O)NC(C)(C)C#N]

4. Method according to claim 3, wherein the compound of formula (I) is compound (I-5).

5. Method according to claim 1, wherein the transgenic plant contains at least one cry-gene or a cry-gene fragment coding for a Bt toxin.

6. Method according to claim 5, wherein the Bt toxin is encoded by a cry gene or a cry-gene fragment selected from the subgroup cry1A.

7. Method according to claim 6, wherein the Bt toxin is encoded by a cry gene or a cry-gene fragment selected from the subgroups cry1Aa, cry1Ab and cry1Ac or a hybrid thereof.

8. Method according to claim 5, wherein the Bt toxin is encoded by a bt-gene or fragment thereof comprising event MON87701.

9. Method according to claim 1, wherein the transgenic plant is a vegetable plant, maize plant, soya bean plant, cotton plant, tobacco plant, rice plant, sugar beet plant, oilseed rape plant or potato plant.

10. Method according to claim 1, wherein the compound of formula (I) is present in a mixture with at least one mixing partner.

11. Synergistic composition comprising a Bt toxin, optionally a Bt toxin encoded by a bt-gene or fragment thereof comprising event MON87701, and a compound of formula (I) 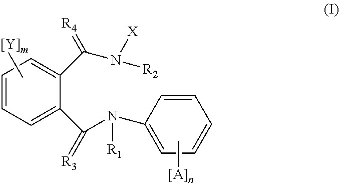
wherein
A represents individually halogen, cyano, nitro, hydroxyl, amino, C₁-C₈ alkyl group, substituted C₁-C₈ alkyl group having at least one substituent elected from the group consisting of halogen, hydroxy, cyano, nitro, amino, halo C₁-C₃ alkyl group, C₁-C₃ alkoxy group, halo C₁-C₃ alkoxy group, C₁-C₃ alkylthio group, halo C₁-C₃ alkylthio group, C₁-C₃ alkylsulfinyl group, halo C₁-C₃ alkylsulfinyl group, C₁-C₃ alkylsulfonyl group, halo C₁-C₃ alkylsulfonyl group and C₁-C₃ alkylthio, C₁-C₃ alkyl group; further, an arbitrary saturated carbon atom in said optionally substituted C₁-C₈ alkyl group;
n represents 0, 1, 2, 3 or 4, optionally 0, 1 or 2;
R₁ represents hydrogen, halogen, cyano C₁-C₈ alkyl or C₁-C₈ haloalkyl;
R₂ represents hydrogen, halogen, cyano C₁-C₈ alkyl or C₁-C₈ haloalkyl;
R₃ represents O or S;
R₄ represents O or S;
Y represents individually hydrogen, halogen, cyano, nitro, C₁-C₆ alkyl group, halo C₁-C₆ alkyl group, C₂-C₆ alkenyl group, halo C₂-C₆ alkenyl group, C₂-C₆ alkynyl group, halo C₂-C₆ alkynyl group, C₃-C₆ cycloalkyl group, halo C₃-C₆ cycloalkyl group, C₁-C₆ alkoxy group, halo C₁-C₆ alkoxy group, C₁-C₆ alkylthio group, halo C₁-C₆ alkylthio group, C₁-C₆ alkylsulfinyl group, halo C₁-C₆ alkylsulfinyl group, C₁-C₆ alkylsulfonyl group, or halo C₁-C₆ alkylsulfonyl group;
m represents 0, 1, 2, 3, or 4;
X represents a C₁-C₈ alkyl group or a substituted C₁-C₈ alkyl group having at least one substituent selected from the group consisting of halogen, hydroxy, cyano, nitro, amino, halo C₁-C₃ alkyl group, C₁-C₃ alkoxy group, halo C₁-C₃ alkoxy group.

12. Synergistic composition according to claim 11, wherein the Bt toxin is encoded by a cry gene or a cry-gene fragment selected from the group consisting of cry1, cry2, cry3, cry5 and cry9, optionally cry1.

13. Synergistic composition according to claim 12, wherein the Bt toxin is encoded by a cry gene or a cry-gene fragment selected from the subgroup cry1A, optionally cry1Aa, cry1Ab and cry1Ac.

14. Synergistic composition according to claim 13, wherein the Bt toxin is encoded by a bt-gene or fragment thereof comprising event MON87701.

15. A Bt plant, wherein at least 0.00001 g of a compound of formula (I), 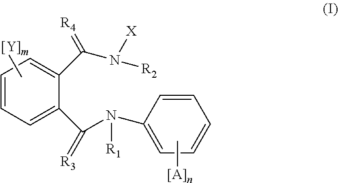
wherein
A represents individually halogen, cyano, nitro, hydroxyl, amino, C₁-C₈ alkyl group, substituted C₁-C₈ alkyl group having at least one substituent elected from the group consisting of halogen, hydroxy, cyano, nitro, amino, halo C₁-C₃ alkyl group, C₁-C₃ alkoxy group, halo C₁-C₃ alkoxy group, C₁-C₃ alkylthio group, halo C₁-C₃ alkylthio group, C₁-C₃ alkylsulfinyl group, halo C₁-C₃ alkylsulfinyl group, C₁-C₃ alkylsulfonyl group, halo C₁-C₃ alkylsulfonyl group and C₁-C₃ alkylthio, C₁-C₃ alkyl group; further, an arbitrary saturated carbon atom in said optionally substituted C₁-C₈ alkyl group;
n represents 0, 1, 2, 3 or 4, optionally 0, 1 or 2;
R₁ represents hydrogen, halogen, cyano C₁-C₈ alkyl or C₁-C₈ haloalkyl;
R₂ represents hydrogen, halogen, cyano C₁-C₈ alkyl or C₁-C₈ haloalkyl;
R₃ represents O or S;
R₄ represents O or S;
Y represents individually hydrogen, halogen, cyano, nitro, C₁-C₆ alkyl group, halo C₁-C₆ alkyl group, C₂-C₆ alkenyl group, halo C₂-C₆ alkenyl group, C₂-C₆ alkynyl group, halo C₂-C₆ alkynyl group, C₃-C₆ cycloalkyl group, halo C₃-C₆ cycloalkyl group, C₁-C₆ alkoxy group, halo C₁-C₆ alkoxy group, C₁-C₆ alkylthio group, halo C₁-C₆ alkylthio group, C₁-C₆ alkylsulfinyl group, halo C₁-C₆ alkylsulfinyl group, C₁-C₆ alkylsulfonyl group, or halo C₁-C₆ alkylsulfonyl group;
m represents 0, 1, 2, 3, or 4;
X represents a C₁-C₈ alkyl group or a substituted C₁-C₈ alkyl group having at least one substituent selected from the group consisting of halogen, hydroxy, cyano, nitro, amino, halo C₁-C₃ alkyl group, C₁-C₃ alkoxy group, halo C₁-C₃ alkoxy group optionally compound (I-5), 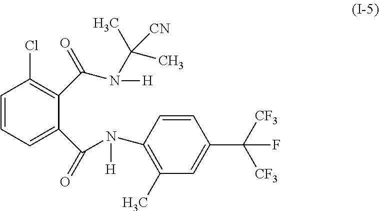 [SMILES: Cc1cc(C(F)(C(F)(F)F)C(F)(F)F)ccc1NC(=O)c1cccc(Cl)c1C(=O)NC(C)(C)C#N]
is attached to said plant.


SEQUENCE LISTING (9 sequences)

SEQ ID NO: 1 - DNA, 1836 bp, Glycine max
ttaacaatgaccaagatttatgctatatagaagacttggagggcttaaggctatgatatattatggatgatatggttctgatttgtgtagtttcgaaggatcaaatcaaccatttgttggtacaatgggaagaaaaaatgttttcatcattccactctattgaaaaagatccaacaattgtaacaccccgacgaatcacaccggaaagagaagaatccaaagattgtgtaggtatgagactgtatagttgatgaaaacttaaaaaaattaattggtactacttataccaacaagatgcatatatttttcgatagcctatcacataagaacttcatagttaagggtgcttaacttggagtagttatgaaatgagtgaccttttaaaataattattgtcttaggttattgtatgaaaataaaaaataataataaatatacataaaaaataataattttataaaattaaccttatattatcattaatttatttttagattttgttattcattattaatatatgaggtataaatgaaaaatataattaatgtcacattaaaaaattaaaatgataattattttgaaacaaattatttatttttatacgacaattataatagaaatttgagagtaaaaaaaaattgaaaattcataaaatatatgaatatattcatttctcctatccgtcaaataaatctgctccataatttatctaagcattggtcttgtagttcagagtaataaaattttagcaattattagttagtacagatacatttaaagaaataatatattttagcaactagaagtttataaaaagttttaaattataaagacttatatataaatttagtaaaactagatggatgtcccaagtaatttttatataactattctcgtacaacattaatgaaaatcttgtttctattatttatatgtatattattattttattttggaacaatatgggattaaaaactcttataaattaaatcttagaataagttttcctaacatgttttttttatggatgttttcctaacatgtttggttatcttagttttgctttaattttgtcggattatttttggactttattaggtaattttgataaaacttttagttgatgttagtagtttactcttacataatgatttgatattgaatgtgtataattggaaggcaataaatgaagatcaagcgtacaagagttcgccaatcaagaggatttgaagagagtaaaatattatgcgaagtcccatgtgaagaaaatccaaccattggaataaaaaataaagttttttctttggaattgctaatgctacagcacttattggtacttgtcctaaaaatgaaactctagctatatttagcacttgatattcatgaatcaaacttctctatgaaataaccgcggtgcgcatcggtgcctgttgatcccgcgcaagttgggatcttgaagcaagttccgctcatcactaagtcgcttagcatgtttgaccttctcggacaactccttcttctctttaattgatcaacagtcagcatcatcacaccaaaagttaggcccgaatagtttgaaattagaaagctcgcaattgaggtctacaggccaaattcgctcttagccgtacaatattactcaccggatcctaaccggtgtgatcatgggccgcgattaaaaatctcaattatatttggtctaatttagtttggtattgagtaaaacaaattcggcgccatgcccgggcaagcggccgcacaagtttgtacaaaaaagcaggctccgcggtgactgactgaaaagcttgtcgacctgcaggtcaacggatcaggata

SEQ ID NO: 2 - DNA, 1550 bp, Glycine max
gcacatagacacacacatcatctcattgatgcttggtaataattgtcattagattgtttttatgcatagatgcactcgaaatcagccaattttagacaagtatcaaacggatgtgacttcagtacattaaaaacgtccgcaatatgatattcattaattttatattatctaaaagagttaaaagagaaaaaagaaatatgacaatttttttctttcacatcttctaacctaaaagtatgactctatggaggctaagtttagaaaaagatacggatctagggtgtggaaacatcaatggtcaactccttttatatttcaatcaattgggttttgctttatctttacattttctccttttattttccacgtctattcaaatctacttgttagcgggtgattactcttttttcttttatagatgccaattatttctctcctatgtattaaattagagtatattgtcttgaaagtgacttagtattttagtttatagtctcttaaagaacgacaccttttattcttaactctctttatcaagttttaatttaaaattattttaaattaagtatgcatacatatcttaatatttttcttaattatttttaaattccctaaatttaatgttttcatacaatgtaagagatatacatattaattatatttaaagataaaacttactttcctgcaataaaataaagaaaaggacagtcatacaattatataattaatccagaatatttatagcttttaaacatttattttctatcaattaagtaataactttaaataaaattaagagtacttttttatactccaaagaatttatttattttcaacaaaatcgtctgactgtttcaattgatcattatcagcctagcataacctaaatttcattttcaaacataacttttggcaccaaatcacccggcattgcaaaaaagtcttttgcgatatgaccctccacgacgcagaaccactgttattcattaccatcacttttaatcctaatttcccatacacttaccctttccatgacatcttcaaagcctttattttgcttttcttgtttaagctgttttaacctaatttcatgcatataaacaaagagtaaagcaaaggcaaatatttgtacgtatagtttttagacagaaaaggaaagtaaattatagagataatgaagtttgctcttttaaattcgtcgtgatgttatccatcatatctaaatgcttattcctgtttttgtcttttttctcttttaccggagtttattttatataattaattaaagttagtagatctatattctttttcatagataatccatcttctttggaggcacatcgatcattaatcatagagttttgagaagcattatcactaaagcttcaattaattatatccaataaacggtattggtgtatgatgttatgatagcaaatagataatctaatctatacgagccacaaaaggggcatgaactctatctcgaagaaattggagatgaagggattgagattggcaccttgtgctattattgcccactaatcatt

SEQ ID NO: 3 - DNA, 10212 bp, Artificial Sequence
  Sequence of soybean event pDAB4468.04.16.1. Including the 5′ genomic flanking sequence, pDAB4468 T-strand insert, and 3′ genomic flanking sequence.
ctgtcgttggattcacagaacattgacgccagttttcacttcgttatctttgaattcattaaaatcgaatctctcacctatacccccccatttttctaatccatcataatcaaaattcataaatgaatcagttaccattaccataatacctttttgaaaatgagtttgaataatcagtatctttagaaaactaattaagaaattaaataaaaaatatttatcatgaagatgagtgtaagaaaaattatgaaaagtataactttatacatttctataaaattattttttcttttaatttcttaattaatatcctaagtaaatgagttaatatttatctttcaaaaattcttatagtcgccaattaattttcccatgcaatgacaacttgtccgtattctacgtggtaggttaggctacctgccgagacaaattgccttgagacaaattcaatagagaacccttccaagggaccattataaatagagaactttcattaaccgataagccacaccctttcaatcaaacacaaacacttgaagtactaagttagtgtgtttgagcaaattaactatggcttcgttttgttctagattgacaatttgtttggctctgtttgtcctcatatgggggagtgccaatgcacaactttctacaaacttttactaccattcatgtccaaacctcttctcctctgtgaaatccacagtgcaatctgccatatctaaggagacccgcatgggtgcttctctccttcgcttgttcttccacgattgctttgtcaatgtaatttatttgcaccttctcccacttacatacaaatatgctaagcttacatatagctcctctttctaccacttgcatgcatcatctaattttgtttgaaacaacacttgttccttttattatacacatcatctttgataaaattttgtcgtgtgcaacttttttttagtgtgttaatcagttctatgatgatactattagttaagaaattttaatgcacttaataaaccattttaagtactttaaccgttcaatgatattatatatttaaagataataaatatttctgcttttgtttctatattagtgtagttaagaaccttcttacttcttagctagctaaatattaatgagtaaacattaacaaatgcagggatgtgatggttcaattctattggatgacacatcaagcttcaccggagagaagaacgcaaaccccaacaggaactctgctcgtggattcgaggttattgacaacattaaatcagccgtggagaaagtgtgtccaggagttgtttcctgcgcagatatccttgccatcgctgccagagactctgttcagattgtaagtggtcaaacaaccaacaaaaacacattaaactaaatcattaaattgtacatatcaaaattaattaccaatttagtaccacacatgcaattaaagagaacattttgttgattttgatcaatatagcttggaggccctacatggaatgttaaacttggaagaagagacgctagaactgctagccaatctgctgctaacaatggcatccctgcacccacttcaaaccttaaccaactcatctcaagatttagcgctcttggactttccaccaaggacttggtcgccttgtccggtacaaaacatatatcacataattttccaattaattacatttcaatcatatagtaaaatttctcaattaattaggaacatgagaaacttatagtcacacgttcttttgttgaggaatattgcatggtttaattttgctttcattaggtggtcacacaattggacaagcaaggtgcacaaacttcagagcccgcatctacaacgagaccaacatagaaaccgcatttgcaaggactaggcagcaaagctgccctagaacatcagggtcaggggacaacaatctggcaccacttgatcttcaaactccaaccagctttgacaactactacttcaagaacctcgttcagaagaagggtctcctccactctgatcagcaactgttcaacggtgggtccaccgactccattgtgcgtggctacagcaccaacccgggcaccttctcctctgatttcgccgccgccatgatcaagatgggagacattagtcctctcactggctccaatggagaaatcaggaagaattgtagaaggattaactaatttgattcagtcttgaatattaagggtcctacacatacgcaagcaatttaattgtgtttaataagttgttaaaacatgttttggttgtattttggattcctagtgtagtttcggtgatcaatgccgtctactttagtgtgttctacttccctttatttttgtttcttttttactttttccttaactatattgtaggaaaaaaaaaatcctttatcaagcatttatcaagaacggagtttgctttttaattttcccttcataacattccatcagaattcagttttgcttttgcttctaaattacgttcaaatcagggatgataatcggttaggtaatatatacagtaccccttgcatagtcacgtttgaaaaatataatcatacttagttcggtaacaatttaaattatcattctcgtaatcattagctacttatgcactcatatccgtatccgctacttgctcttgtcgtaagtcaataaattaatataaaaaaatacttaaaacttgttacaactaaattaaaaatttatttttaaatcattcaagcaccagtcagcatcatcacaccaaaagttaggcccgaatagtttgaaattagaaagctcgcaattgaggtctacaggccaaattcgctcttagccgtacaatattactcaccggatcctaaccggtgtgatcatgggccgcgattaaaaatctcaattatatttggtctaatttagtttggtattgagtaaaacaaattcgaaccaaaccaaaatataaatatatagtttttatatatatgcctttaagactttttatagaattttctttaaaaaatatctagaaatatttgcgactcttctggcatgtaatatttcgttaaatatgaagtgctccatttttattaactttaaataattggttgtacgatcactttcttatcaagtgttactaaaatgcgtcaatctctttgttcttccatattcatatgtcaaaacctatcaaaattcttatatatctttttcgaatttgaagtgaaatttcgataatttaaaattaaatagaacatatcattatttaggtatcatattgatttttatacttaattactaaatttggttaactttgaaagtgtacatcaacgaaaaattagtcaaacgactaaaataaataaatatcatgtgttattaagaaaattctcctataagaatattttaatagatcatatgtttgtaaaaaaaattaatttttactaacacatatatttacttatcaaaaatttgacaaagtaagattaaaataatattcatctaacaaaaaaaaaaccagaaaatgctgaaaacccggcaaaaccgaaccaatccaaaccgatatagttggtttggtttgattttgatataaaccgaaccaactcggtccatttgcacccctaatcataatagctttaatatttcaagatattattaagttaacgttgtcaatatcctggaaattttgcaaaatgaatcaagcctatatggctgtaatatgaatttaaaagcagctcgatgtggtggtaatatgtaatttacttgattctaaaaaaatatcccaagtattaataatttctgctaggaagaaggttagctacgatttacagcaaagccagaatacaatgaaccataaagtgattgaagctcgaaatatacgaaggaacaaatatttttaaaaaaatacgcaatgacttggaacaaaagaaagtgatatattttttgttcttaaacaagcatcccctctaaagaatggcagttttcctttgcatgtaactattatgctcccttcgttacaaaaattttggactactattgggaacttcttctgaaaatagtggccaccgcttaattaaggcgcgccatgcccgggcaagcggccgcacaagtttgtacaaaaaagcaggctccgcggtgactgactgaaaagcttgtcgacctgcaggtcaacggatcaggatattcttgtttaagatgttgaactctatggaggtttgtatgaactgatgatctaggaccggataagttcccttcttcatagcgaacttattcaaagaatgttttgtgtatcattcttgttacattgttattaatgaaaaaatattattggtcattggactgaacacgagtgttaaatatggaccaggccccaaataagatccattgatatatgaattaaataacaagaataaatcgagtcaccaaaccacttgccttttttaacgagacttgttcaccaacttgatacaaaagtcattatcctatgcaaatcaataatcatacaaaaatatccaataacactaaaaaattaaaagaaatggataatttcacaatatgttatacgataaagaagttacttttccaagaaattcactgattttataagcccacttgcattagataaatggcaaaaaaaaacaaaaaggaaaagaaataaagcacgaagaattctagaaaatacgaaatacgcttcaatgcagtgggacccacggttcaattattgccaattttcagctccaccgtatatttaaaaaataaaacgataatgctaaaaaaatataaatcgtaacgatcgttaaatctcaacggctggatcttatgacgaccgttagaaattgtggttgtcgacgagtcagtaataaacggcgtcaaagtggttgcagccggcacacacgagtcgtgtttatcaactcaaagcacaaatacttttcctcaacctaaaaataaggcaattagccaaaaacaactttgcgtgtaaacaacgctcaatacacgtgtcattttattattagctattgcttcaccgccttagctttctcgtgacctagtcgtcctcgtcttttcttcttcttcttctataaaacaatacccaaagcttcttcttcacaattcagatttcaatttctcaaaatcttaaaaactttctctcaattctctctaccgtgatcaaggtaaatttctgtgttccttattctctcaaaatcttcgattttgttttcgttcgatcccaatttcgtatatgttctttggtttagattctgttaatcttagatcgaagacgattttctgggtttgatcgttagatatcatcttaattctcgattagggtttcataaatatcatccgatttgttcaaataatttgagttttgtcgaataattactcttcgatttgtgatttctatctagatctggtgttagtttctagtttgtgcgatcgaatttgtcgattaatctgagtttttctgattaacagagatctccatggctcagaccactctccaaatcacacccactggtgccaccttgggtgccacagtcactggtgttcaccttgccacacttgacgatgctggtttcgctgccctccatgcagcctggcttcaacatgcactcttgatcttccctgggcaacacctcagcaatgaccaacagattacctttgctaaacgctttggagcaattgagaggattggcggaggtgacattgttgccatatccaatgtcaaggcagatggcacagtgcgccagcactctcctgctgagtgggatgacatgatgaaggtcattgtgggcaacatggcctggcacgccgactcaacctacatgccagtcatggctcaaggagctgtgttcagcgcagaagttgtcccagcagttgggggcagaacctgctttgctgacatgagggcagcctacgatgcccttgatgaggcaacccgtgctcttgttcaccaaaggtctgctcgtcactcccttgtgtattctcagagcaagttgggacatgtccaacaggccgggtcagcctacataggttatggcatggacaccactgcaactcctctcagaccattggtcaaggtgcatcctgagactggaaggcccagcctcttgatcggccgccatgcccatgccatccctggcatggatgcagctgaatcagagcgcttccttgaaggacttgttgactgggcctgccaggctcccagagtccatgctcaccaatgggctgctggagatgtggttgtgtgggacaaccgctgtttgctccaccgtgctgagccctgggatttcaagttgccacgtgtgatgtggcactccagactcgctggacgcccagaaactgagggtgctgccttggtttgagtagttagcttaatcacctagagctcggtcaccagcataatttttattaatgtactaaattactgttttgttaaatgcaattttgctttctcgggattttaatatcaaaatctatttagaaatacacaatattttgttgcaggcttgctggagaatcgatctgctatcataaaaattacaaaaaaattttatttgcctcaattattttaggattggtattaaggacgcttaaattatttgtcgggtcactacgcatcattgtgattgagaagatcagcgatacgaaatattcgtagtactatcgataatttatttgaaaattcataagaaaagcaaacgttacatgaattgatgaaacaatacaaagacagataaagccacgcacatttaggatattggccgagattactgaatattgagtaagatcacggaatttctgacaggagcatgtcttcaattcagcccaaatggcagttgaaatactcaaaccgccccatatgcaggagcggatcattcattgtttgtttggttgcctttgccaacatgggagtccaaggttgcggccgcgcgccgacccagctttcttgtacaaagtggttgcggccgcttaattaaatttaaatgcccgggcgtttaaacgcggccgcttaattaaggccggcctgcagcaaacccagaaggtaattatccaagatgtagcatcaagaatccaatgtttacgggaaaaactatggaagtattatgtaagctcagcaagaagcagatcaatatgcggcacatatgcaacctatgttcaaaaatgaagaatgtacagatacaagatcctatactgccagaatacgaagaagaatacgtagaaattgaaaaagaagaaccaggcgaagaaaagaatcttgaagacgtaagcactgacgacaacaatgaaaagaagaagataaggtcggtgattgtgaaagagacatagaggacacatgtaaggtggaaaatgtaagggcggaaagtaaccttatcacaaaggaatcttatcccccactacttatccttttatatttttccgtgtcatttttgcccttgagttttcctatataaggaaccaagttcggcatttgtgaaaacaagaaaaaatttggtgtaagctattttctttgaagtactgaggatacaacttcagagaaatttgtaagtttgtagatctccatgtctccggagaggagaccagttgagattaggccagctacagcagctgatatggccgcggtttgtgatatcgttaaccattacattgagacgtctacagtgaactttaggacagagccacaaacaccacaagagtggattgatgatctagagaggttgcaagatagatacccttggttggttgctgaggttgagggtgttgtggctggtattgcttacgctgggccctggaaggctaggaacgcttacgattggacagttgagagtactgtttacgtgtcacataggcatcaaaggttgggcctaggatccacattgtacacacatttgcttaagtctatggaggcgcaaggttttaagtctgtggttgctgttataggccttccaaacgatccatctgttaggttgcatgaggctttgggatacacagcccggggtacattgcgcgcagctggatacaagcatggtggatggcatgatgttggtttttggcaaagggattttgagttgccagctcctccaaggccagttaggccagttacccagatctgaggtaccctgagcttgagcttatgagcttatgagcttagagctcggatccactagtaacggccgccagtgtgctggaattcgcccttgactagataggcgcccagatcggcggcaatagcttcttagcgccatcccgggttgatcctatctgtgttgaaatagttgcggtgggcaaggctctctttcagaaagacaggcggccaaaggaacccaaggtgaggtgggctatggctctcagttccttgtggaagcgcttggtctaaggtgcagaggtgttagcgggatgaagcaaaagtgtccgattgtaacaagatatgttgatcctacgtaaggatattaaagtatgtattcatcactaatataatcagtgtattccaatatgtactacgatttccaatgtctttattgtcgccgtatgtaatcggcgtcacaaaataatccccggtgactttcttttaatccaggatgaaataatatgttattataatttttgcgatttggtccgttataggaattgaagtgtgcttgcggtcgccaccactcccatttcataattttacatgtatttgaaaaataaaaatttatggtattcaatttaaacacgtatacttgtaaagaatgatatcttgaaagaaatatagtttaaatatttattgataaaataacaagtcaggtattatagtccaagcaaaaacataaatttattgatgcaagtttaaattcagaaatatttcaataactgattatatcagctggtacattgccgtagatgaaagactgagtgcgatattatggtgtaatacatagcggccgggtttctagtcaccggttaggatccgtttaaactcgaggctagcgcatgcacatagacacacacatcatctcattgatgcttggtaataattgtcattagattgtttttatgcatagatgcactcgaaatcagccaattttagacaagtatcaaacggatgtgacttcagtacattaaaaacgtccgcaatgtgttattaagttgtctaagcgtcaatattttaattcttaacaatcaatattttaattcttaaactttattaaatctaacaataaactgtaagaactaattcttaaacttcaataaacaatactgcgttttagtaattaaattaataatatatagatatagatatataatttgtcaacatattcttacctatttttccattgaaatatgttagcaagttcaaaaaaagttttgacaaaaaactctactatcttttgtttcatttactttatgtgagggatataatagtaatataacatttagtttatttaaagaaaataaaaaagttaatttctctttctgccactgatactctatggtggagagatccgatgcagtggtggagcctggcctcgacacataagtgtgacgacgcagctgttgaagagatctgattcgacggtggggtaatgcatggtggttgacaggttgatgggtggagaagacgtaattgctaccgccgtcaacggaggaaggagcaaagatgtctcgtatgtgaaaattatgcggttgagatgccgtttcattccctttaaaaaaatcccttgatggttgcaatgcaaattaaaaattgaaaaaataattaattgttcaaattaaagatttagcatgaaaaaaaaaacacttaattgtgcccatgactccatgacctgcgtaacttgggaaggaaaggaatttttttgctaaaggaaggcatgggaagatgagagaggagagagaatcagtggaagtgagagaaattaactttttgttttttaaaaactaaatattatattactattatatatatatatatatatatataaaagattttttagctggattcttgatataaaaaatttctcaccatatttattattatatatttttttggagatctcaaaaaaggaagttggatttcttctcaataactctaaaaaattattcctatttcaaaaaatattttttatgtctttctctaattgatgaataatatctatttaagtatattttattgtgaaatccacaaaagtgactgataaatctaatttaggatctaccattagagaaaaataaataaattcttatattatatgtgat

SEQ ID NO: 4 - DNA, 20 bp, Artificial sequence
  Synthetic
ttagtgtgtgtgtcaaacac

SEQ ID NO: 5 - DNA, 20 bp, Artificial sequence
  Synthetic
atgaagccatcaaaaagtag

SEQ ID NO: 6 - DNA, 6285 bp, Artificial sequence
  Synthetic
gggaaaatccctcttccatattaagaacataaaaatcaacaggaaaaataagttcaccaacccgaaccagcacatcctctatgaaacctgcggggtaagcagcacttctattttccaaatgaatcaccacatctgtagattgcaaaggtccaagagataaagaattgaaaatggacagaggggtgacactaactgatgctcctagatctagcattgtattatcaaatttactgttcccaataatgcaaggtatacagaaagtacctgggtccttacatttctcaggaatgtaaggaacaaatttacctatcaatgctgacacatttctgcccatgctaatcctttcattgcctttgagcttccttttgtgggtgcacaactcctttagaaacttgacacatcttggaatctgcttgatggcatctagcagaggtatgttcacctctactttcctgaaggtctccaagatctccttttctgcttcttccattttttttgtttggaattgctcaaggttggaatggaagagggataagaggctgcggtaagtcagaattactagaagaaggtccacctgcatgaaaatttttgttaggaagctttctcttttgtgcaactatctcatcctctttttcaggtgtagaatgaagcttgacaggttcaggtgcgggtgctgctactggtggaggtacttgaatttggttgtcagacctcaaggtgatgacactcacatttttcggattttgcacagtttgtgaaggcaatttgtcagaattttgggaatgagcttggttcaactgagtagccatccgccccatctgatttgtcagactctgaatgaaggctcttgtctcttgctgaaattgcatattctggatggtcatttgcctcactaactcttctaaggaaggttaaggaggagtctcagttgcttgttgtctttgttgtgactgttgttgttgttgctgctgtattggaggaggaacatatggtttgcttggaccagcaacattctggaaaggagggacagactgttgttgttgtgaaggacttgcccatctcatatttggatgatttctccaacctggattgtatctgttgcttggaagatcataattattttgctattgttggttttgctgttgagggggtctattataaatgtttgcagcataagcttcaggttgttcattgactccagattactgcaaagaaggacaaagatctgtatggtgatctgcagaagaacatataccacagactcttgtaacaggtgcaaatttctgattcatggcaagctgagttactaggttgaccaaggcatcaagttttccctcaagctttttattttcagtagataaagatgaatctgtggccacctcatcgactcctctaaggacaatagcatcatttcttgcactgaattgttgggagttggaagccttcttctcaatcaaattcctagcctcagcaggggtcatatcacgaagagctccaccactggcagcatcaatcatactcctctccatgttgctaagtccctcatagaaatattgaagaaggagttgctcagaaatctggtggtgaggacagcttgcacacaatttcttgaatctttctcagtactcatacaagctctctccactaagttgcctgatgcctgaaatttcttttctgatggcagtggtcctagatgcagggaagaatttctccaagaacaccctcttaaggtcatcccagctgaaaatggacctgggagcaaggtagtagagccaatcttttgtcactacctccagagaatgaggaaaagcctttagaaagatatgatcttcttggacatcagggggcttcatggtggaacaaacaatatggaactccttaagatgcttatgaggatcttcacctagaagaccatgaaacttgggtagcaaatgtattagtccagtcttgagaacatatggaacaccctcatcaggatattgaatgcacaagttttcataagtgaaatcaggtgcagccatctccctaagagtcctctcacgaggtggaggtttagccatgttctcagtatgaaaattagtagttgaatgctcaaaatcagaatattcagaatcaccagaaacaaaatactcagaatgctcaaaatgctcaaaatgcacataatgattaggatgcacactatgcctaactaatctatgaaaggttctatctatttcaggatcgaagggttataaatcacctagattgcccctagtcatgcactatatgtagcaaataatgtgttctcaaacaagcaccaagggagggttaaaactacaactatagtcaaatgatatccaaatgagttgaaattttgtgagcagcaccctaaaatcatgaaaagatagcacaaaaaatttcaaacgaaaattcaaagtctaactatgaaaactacttaagaaaagtttagaaaaataggacaataatacttgaaaaataaaaaaaaacatagtaaacagctgatttttcgagtttgggagactccaaccggctaaaacgggttgccacaatatgagaaatttttttctaccccaaatgccacaatatgagaaagttttgctaaaatctagttcccaaaatttttgtctctctcaaattcaaccacaccaagtgctcctagtatttttcacacaaaaaatcagccaaaaataacaactctaactatcaaaacaaaaacagctaattaaattgcaaaatcagtcgctaattcctagtcactaatcactgttcacagcaaaacaccaactgaatcagtcgctaaacagtcgctaaacaggagacgcaactgaaatgcaaaacagaatgctacacaaaacaaaacaactaaacactattatgaacctttggcccactgctccccgacaacggcgccaaatttgatcgaggtcgtacccgaatcaaataaacattaaaaatgcagtatctaggaagtgatcctaggtcatctcccaacgagcaatggtcaaccaatgttcataatagatagtgataaaacaataacgaattggggggggggggtatttgtttttgtaatttaaacaacaagcaaattttaattagaaaataacagaattaaaacatgttatttccccttgattcataagcaagtctcttatcctaggttaggaggatttatccctaaccagttcaaccacttaatccaaccctaaattaaattactaagcgaaaattaacataaggttgtctttatatgattaagcaacacatacaccaattaatcatgaacaaaatcgatcattaagcatcaacataaattaagcgcaaagataattaatcaagcactaagcatgcatggattagtagcaacaaatacagagtaattggtggagatgaaaaactgatcaatattcaatagtaataacaaaacctcaaagagagttgtgcttgattctcaagagaaaacaacgctggagacttagccttccattaatcagtagaaaacgaaattgtagaaaacgaattttattctatgtgaacaatgtgcatgaacagtaataaaaactggaattgcaaaaccctaaaattattcttctctccaaaaaaactccctaaactaaaaccctggtgctattatataggtcctcagccccaaagcttacaaatctattttcagtccaaacccataaacgaaataaaataaaatctggacaagataagataagattggatgaaataaaatctggacgaaataaaatctggataagataagatttgataaaataaaattgtctgctcttttcaagtccaagcccaattccggattcaagcccaattttttataattcttctgaaattaaattaaaaatacgaaattagtcaagtaggcccaaatgataaaactgcataattaatttgacaattaaggctaatcagtaattaaaatagtgacaaaaagggttaagaaataggagaataatgacacatcacccatatggggagcaattctaaaatgcatttgagttctttaacctgagacacagtgcagtagagtctccaaggattcattgtgccttttattttatatgatggggtcactacattggccttgtcaaagaaactgaatttgggggattaaagaaacacaaaataaaaacaaatgaaactagttaatagaaatgttgcctattgcttcttggaaaaagtccaaccatttgtgatttggataaaattcatattacccacttgtagcttgttcaatcaaacactagatttggataaaatctcactcctagatatacctcaagggataatatgaccaacattagtcatttttagaaagtaaagtggacaaatttgagatttcattccttaatgacattataaacatgtattttttccatgaccctttttcaatgtaagtacaatttatcccttagtttagatactctatatatgcatgttacgtagttgatgaaaacatacctaagttgttgtgtatggttaagtttgcgactacctctgatatcaaactcctcatctccaatctcatacaaaagatacttgtcacttggtacctgaaccttgtcagtttgcagttgtgagtttcttctgaagccacacgcttgtatagtaaccagaagccaggagggagtcctctaaggctctaactcgtattttccgtggaagtacattttttttcttaaagaaaacagagatagtttaccaatgataatatttctttagccaaataggaccatcatagaaaacaaaactcttcttctaagtatttaatgcaactacatatttagggtgcgtttgattcgctaaaaaataagggtctagacaacacaaaaatatttttccaacgtttgattttaaaaatggctgagagacaatacaaaataaagaatgatgaactggacaaaaacctaaaaacttgtaactcactgaatctcatacaactttttgttcagtgtctaaaaaaagtaaaaatacaatattattcctattttttactttgattatctcacaccttctttctactcatttgtttcacttcacctctccagtgggcaccttggtttgtcggcgagagtcgtatggacttttgttgtttcctttttgctcattatttctttcttttcattgttaatttattcaaatgttcccatcatcatcttactccttcttgttatgttttttttctttggccaactccaacgaggccgtgccgcgaccaccatcatcacgaccttatggcggcctcacgccgcaaggccctgcacccagtggcatcaggggtcatgcctccttcttaaaggtgtctctcttttgttatgtcgtcaaagtgttgctaattcacctagaatttttcaatgaatccctttacttgtgggttagtctaggtcgctctgcccggttccaaccctagcccaaaaaaaaatgaaatgggtaggaaaggcgggcctagtttgaattaaaataaatcatgctaagatattgataactgctatgtataggtatattttgggattaaattatataggaattagtaatttttctctcttatttcttcctttttgttcaaataattggaattctaacatcatttaagtttttatgtagaaaatattaaaagttgatgaatttatgatacttagtgaataattagagtagaaaaataaagtaaagcccaaaaaagaaaattggtgatatgaagatacatgcttagcatgccccaggcacgcttagtgtgtgtgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggc

SEQ ID NO: 7 - DNA, 2611 bp, Artificial sequence
  Synthetic
gactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccatcaaaaagtaggactaatttaggaaagcaagctaattcaagaaagtgaaggcacgcttagtgtgagacacgtgttgagcgcgattactgccactcactaaccacacaagtgcactcagtgcgaaggttgcttaaaaattaagttgattcgcacttataaaagaaggatagagatgaaggaaaaaacacagaaaatacaattccttatagaagacaaaggctagaagaagcaaacgcaaacattagaagtcattccttccctcaattccctttttcaatttccccttttactaaatattctcctcttgcaattataaagcctcctatgacaatgacaagctaaactctcctttgttgggaacttatcagtcaactgctcttaatataatttctcttcctatctattatgaatattcactacaagaaatatgcccatttgccagggatttttgacagggacattaacccctggcaaatttcccagggactaagccaaggaaacccctggcaaaatgacatttgagaaggctgggaccacttacatttacacaggggtttgtccctcgcaaaaatacaaaagccttggcaaaaaaaagagcgggaaatgaattttaaaacagcatgttgttttcacacagccaaacacacgggtatgccctcgttttctgtaaagctgacggaatcttcccataagtcaacacgacatgaccatgcactgcaaaaagctgtgcggcccagacgtgacaggggtgttacccctcggaaatggcttgcagcccctggcaaaaaggaatccctgctttcctagctacaccgttctgctcatatagctgaagctaggaggttagcctttgactctgttgttttgcgaggggcattccgtgagttattccctgggtttttttacactatatagccaaaccgcgtgtttatcctcatgctcagtgttgtgtttttgaaacttagaaaaattttcggtttccatttccatcctcaccagttcattttcagtccattatcattcagttcatacacttgttctataatttggtaacactcttttcacttattatatttttctgtttttatttgttactacttattaacataaatattttttattgtatcagtgtccaaatttgcctcctcctgctgctccttgctctctgaatttgttctcttaagcttcaacaagttagtaatttttctacttataattttagatatatgatgtttatatatatgatgttataattttgcatgatctgtcaaagaaaatatgatgtttctacttgcatgatgtgttataatatatgatgtttatatatatttcgaattttgttgttaataaaactgtttaattagaaactgtataatttttttgtttaataaaactgtttaattttgcatgatctgtttaataaaactgtttatataaaactgtttatatataatatatgatgttaacatttttaaaactgtttataaaacagtttagttagaaaaaatgttaaaactagagaaaaaaatgtataataaaactgtgtcagtacagcagcgcgtcagaaaagtgtgcagatgcgtcagtgagaagacaggggctaagacagggattttgacagggaattttgccagggattttgccagggtcagcccctcgtttttttgccaggggtgaaatccctggcaaactgatttgcgatgggcgtttttcccagggattcagcccctggcaaaatccctggcaaacgtccatttcccagggctttttgttcttttcccagggaatccgcccctggcaaacgagcttgtttcttgtagtgattacttttgcattagtttttcctgtatttaattttattgtttatggcttgattacccatttgcattataagttttaggggtagcgttgaaaagtgttattctctaatagaactggaaaagagtatttaaataacttcatcactagggatacattgattttatttagcttattatatatctctattattaatgtaatttaactattttatctctgcaaagtgatttgggagagaagatagataagttagactctttcactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgaaggg

SEQ ID NO: 8 - DNA, 6426 bp, Artificial sequence
  Synthetic
tgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggccaaaacaaatatgtagattaaaaattccagcctccaaaaaaaaatccaagtgttgtaaagcattatatatatatagtagatcccaaatttttgtacaattccacactgatcgaatttttaaagttgaatatctgacgtaggatttttttaatgtcttacctgaccatttactaataacattcatacgttttcatttgaaatatcctctataattatattgaatttggcacataataagaaacctaattggtgatttattttactagtaaatttctggtgatgggctttctactagaaagctctcggaaaatcttggaccaaatccatattccatgacttcgattgttaaccctattagttttcacaaacatactatcaatatcattgcaacggaaaaggtacaagtaaaacattcaatccgatagggaagtgatgtaggaggttgggaagacaggcccagaaagagatttatctgacttgttttgtgtatagttttcaatgttcataaaggaagatggagacttgagaagttttttttggactttgtttagctttgttgggcgtttttttttttgatcaataactttgttgggcttatgatttgtaatattttcgtggactctttagtttatttagacgtgctaactttgttgggcttatgacttgttgtaacatattgtaacagatgacttgatgtgcgactaatctttacacattaaacatagttctgttttttgaaagttcttattttcatttttatttgaatgttatatatttttctatatttataattctagtaaaaggcaaattttgcttttaaatgaaaaaaatatatattccacagtttcacctaatcttatgcatttagcagtacaaattcaaaaatttcccatttttattcatgaatcataccattatatattaactaaatccaaggtaaaaaaaaggtatgaaagctctatagtaagtaaaatataaattccccataaggaaagggccaagtccaccaggcaagtaaaatgagcaagcaccactccaccatcacacaatttcactcatagataacgataagattcatggaattatcttccacgtggcattattccagcggttcaagccgataagggtctcaacacctctccttaggcctttgtggccgttaccaagtaaaattaacctcacacatatccacactcaaaatccaacggtgtagatcctagtccacttgaatctcatgtatcctagaccctccgatcactccaaagcttgttctcattgttgttatcattatatatagatgaccaaagcactagaccaaacctcagtcacacaaagagtaaagaagaacaatggcttcctctatgctctcttccgctactatggttgcctctccggctcaggccactatggtcgctcctttcaacggacttaagtcctccgctgccttcccagccacccgcaaggctaacaacgacattacttccatcacaagcaacggcggaagagttaactgcatgcaggtgtggcctccgattggaaagaagaagtttgagactctctcttaccttcctgaccttaccgattccggtggtcgcgtcaactgcatgcaggccatggacaacaacccaaacatcaacgaatgcattccatacaactgcttgagtaacccagaagttgaagtacttggtggagaacgcattgaaaccggttacactcccatcgacatctccttgtccttgacacagtttctgctcagcgagttcgtgccaggtgctgggttcgttctcggactagttgacatcatctggggtatctttggtccatctcaatgggatgcattcctggtgcaaattgagcagttgatcaaccagaggatcgaagagttcgccaggaaccaggccatctctaggttggaaggattgagcaatctctaccaaatctatgcagagagcttcagagagtgggaagccgatcctactaacccagctctccgcgaggaaatgcgtattcaattcaacgacatgaacagcgccttgaccacagctatcccattgttcgcagtccagaactaccaagttcctctcttgtccgtgtacgttcaagcagctaatcttcacctcagcgtgcttcgagacgttagcgtgtttgggcaaaggtggggattcgatgctgcaaccatcaatagccgttacaacgaccttactaggctgattggaaactacaccgaccacgctgttcgttggtacaacactggcttggagcgtgtctggggtcctgattctagagattggattagatacaaccagttcaggagagaattgaccctcacagttttggacattgtgtctctcttcccgaactatgactccagaacctaccctatccgtacagtgtcccaacttaccagagaaatctatactaacccagttcttgagaacttcgacggtagcttccgtggttctgcccaaggtatcgaaggctccatcaggagcccacacttgatggacatcttgaacagcataactatctacaccgatgctcacagaggagagtattactggtctggacaccagatcatggcctctccagttggattcagcgggcccgagtttacctttcctctctatggaactatgggaaacgccgctccacaacaacgtatcgttgctcaactaggtcagggtgtctacagaaccttgtcttccaccttgtacagaagacccttcaatatcggtatcaacaaccagcaactttccgttcttgacggaacagagttcgcctatggaacctcttctaacttgccatccgctgtttacagaaagagcggaaccgttgattccttggacgaaatcccaccacagaacaacaatgtgccacccaggcaaggattctcccacaggttgagccacgtgtccatgttccgttccggattcagcaacagttccgtgagcatcatcagagctcctatgttctcttggatacatcgtagtgctgagttcaacaacatcatcgcatccgatagtattactcaaatccctgcagtgaagggaaactttctcttcaacggttctgtcatttcaggaccaggattcactggtggagacctcgttagactcaacagcagtggaaataacattcagaatagagggtatattgaagttccaattcacttcccatccacatctaccagatatagagttcgtgtgaggtatgcttctgtgacccctattcacctcaacgttaattggggtaattcatccatcttctccaatacagttccagctacagctacctccttggataatctccaatccagcgatttcggttactttgaaagtgccaatgcttttacatcttcactcggtaacatcgtgggtgttagaaactttagtgggactgcaggagtgattatcgacagattcgagttcattccagttactgcaacactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgcctcgacgagaagcgtgaactctccgagaaagttaaacacgccaagcgtctcagcgacgagaggaatctcttgcaagactccaacttcaaagacatcaacaggcagccagaacgtggttggggtggaagcaccgggatcaccatccaaggaggcgacgatgtgttcaaggagaactacgtcaccctctccggaactttcgacgagtgctaccctacctacttgtaccagaagatcgatgagtccaaactcaaagccttcaccaggtatcaacttagaggctacatcgaagacagccaagaccttgaaatctactcgatcaggtacaatgccaagcacgagaccgtgaatgtcccaggtactggttccctctggccactttctgcccaatctcccattgggaagtgtggagagcctaacagatgcgctccacaccttgagtggaatcctgacttggactgctcctgcagggatggcgagaagtgtgcccaccattctcatcacttctccttggacatcgatgtgggatgtactgacctgaatgaggacctcggagtctgggtcatcttcaagatcaagacccaagacggacacgcaagacttggcaaccttgagtttctcgaagagaaaccattggtcggtgaagctctcgctcgtgtgaagagagcagagaagaagtggagggacaaacgtgagaaactcgaatgggaaactaacatcgtttacaaggaggccaaagagtccgtggatgctttgttcgtgaactcccaatatgatcagttgcaagccgacaccaacatcgccatgatccacgccgcagacaaacgtgtgcacagcattcgtgaggcttacttgcctgagttgtccgtgatccctggtgtgaacgctgccatcttcgaggaacttgagggacgtatctttaccgcattctccttgtacgatgccagaaacgtcatcaagaacggtgacttcaacaatggcctcagctgctggaatgtgaaaggtcatgtggacgtggaggaacagaacaatcagcgttccgtcctggttgtgcctgagtgggaagctgaagtgtcccaagaggttagagtctgtccaggtagaggctacattctccgtgtgaccgcttacaaggagggatacggtgagggttgcgtgaccatccacgagatcgagaacaacaccgacgagcttaagttctccaactgcgtcgaggaagaaatctatcccaacaacaccgttacttgcaacgactacactgtgaatcaggaagagtacggaggtgcctacactagccgtaacagaggttacaacgaagctccttccgttcctgctgactatgcctccgtgtacgaggagaaatcctacacagatggcagacgtgagaacccttgcgagttcaacagaggttacagggactacacaccacttccagttggctatgttaccaaggagcttgagtactttcctgagaccgacaaagtgtggatcgagatcggtgaaaccgagggaaccttcatcgtggacagcgtggagcttctcttgatggaggaataatgagatcccgtcctttgtcttcaattttgagggctttttactgaataagtatgtagtactaaaatgtatgctgtaatagctcatagtgagcgaggaaagtatcgggctatttaactatgacttgagctccatctatgaataaataaatcagcatatgatgcttttgttttgtgtacttcaactgtctgcttagctaatttgatatggttggcacttggcacgtataaatatgctgaagtaatttactctgaagctaaattaactagattagatgagtgtattatatacaaaaggcattaaatcagatacatcttagacaaattgtcacggtctaccagaaaagaaattgcatttgtttttgggtctttcagactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccat

SEQ ID NO: 9 - DNA, 14416 bp, Artificial sequence
  Synthetic
gggaaaatccctcttccatattaagaacataaaaatcaacaggaaaaataagttcaccaacccgaaccagcacatcctctatgaaacctgcggggtaagcagcacttctattttccaaatgaatcaccacatctgtagattgcaaaggtccaagagataaagaattgaaaatggacagaggggtgacactaactgatgctcctagatctagcattgtattatcaaatttactgttcccaataatgcaaggtatacagaaagtacctgggtccttacatttctcaggaatgtaaggaacaaatttacctatcaatgctgacacatttctgcccatgctaatcctttcattgcctttgagcttccttttgtgggtgcacaactcctttagaaacttgacacatcttggaatctgcttgatggcatctagcagaggtatgttcacctctactttcctgaaggtctccaagatctccttttctgcttcttccattttttttgtttggaattgctcaaggttggaatggaagagggataagaggctgcggtaagtcagaattactagaagaaggtccacctgcatgaaaatttttgttaggaagctttctcttttgtgcaactatctcatcctctttttcaggtgtagaatgaagcttgacaggttcaggtgcgggtgctgctactggtggaggtacttgaatttggttgtcagacctcaaggtgatgacactcacatttttcggattttgcacagtttgtgaaggcaatttgtcagaattttgggaatgagcttggttcaactgagtagccatccgccccatctgatttgtcagactctgaatgaaggctcttgtctcttgctgaaattgcatattctggatggtcatttgcctcactaactcttctaaggaaggttaaggaggagtctcagttgcttgttgtctttgttgtgactgttgttgttgttgctgctgtattggaggaggaacatatggtttgcttggaccagcaacattctggaaaggagggacagactgttgttgttgtgaaggacttgcccatctcatatttggatgatttctccaacctggattgtatctgttgcttggaagatcataattattttgctattgttggttttgctgttgagggggtctattataaatgtttgcagcataagcttcaggttgttcattgactccagattactgcaaagaaggacaaagatctgtatggtgatctgcagaagaacatataccacagactcttgtaacaggtgcaaatttctgattcatggcaagctgagttactaggttgaccaaggcatcaagttttccctcaagctttttattttcagtagataaagatgaatctgtggccacctcatcgactcctctaaggacaatagcatcatttcttgcactgaattgttgggagttggaagccttcttctcaatcaaattcctagcctcagcaggggtcatatcacgaagagctccaccactggcagcatcaatcatactcctctccatgttgctaagtccctcatagaaatattgaagaaggagttgctcagaaatctggtggtgaggacagcttgcacacaatttcttgaatctttctcagtactcatacaagctctctccactaagttgcctgatgcctgaaatttcttttctgatggcagtggtcctagatgcagggaagaatttctccaagaacaccctcttaaggtcatcccagctgaaaatggacctgggagcaaggtagtagagccaatcttttgtcactacctccagagaatgaggaaaagcctttagaaagatatgatcttcttggacatcagggggcttcatggtggaacaaacaatatggaactccttaagatgcttatgaggatcttcacctagaagaccatgaaacttgggtagcaaatgtattagtccagtcttgagaacatatggaacaccctcatcaggatattgaatgcacaagttttcataagtgaaatcaggtgcagccatctccctaagagtcctctcacgaggtggaggtttagccatgttctcagtatgaaaattagtagttgaatgctcaaaatcagaatattcagaatcaccagaaacaaaatactcagaatgctcaaaatgctcaaaatgcacataatgattaggatgcacactatgcctaactaatctatgaaaggttctatctatttcaggatcgaagggttataaatcacctagattgcccctagtcatgcactatatgtagcaaataatgtgttctcaaacaagcaccaagggagggttaaaactacaactatagtcaaatgatatccaaatgagttgaaattttgtgagcagcaccctaaaatcatgaaaagatagcacaaaaaatttcaaacgaaaattcaaagtctaactatgaaaactacttaagaaaagtttagaaaaataggacaataatacttgaaaaataaaaaaaaacatagtaaacagctgatttttcgagtttgggagactccaaccggctaaaacgggttgccacaatatgagaaatttttttctaccccaaatgccacaatatgagaaagttttgctaaaatctagttcccaaaatttttgtctctctcaaattcaaccacaccaagtgctcctagtatttttcacacaaaaaatcagccaaaaataacaactctaactatcaaaacaaaaacagctaattaaattgcaaaatcagtcgctaattcctagtcactaatcactgttcacagcaaaacaccaactgaatcagtcgctaaacagtcgctaaacaggagacgcaactgaaatgcaaaacagaatgctacacaaaacaaaacaactaaacactattatgaacctttggcccactgctccccgacaacggcgccaaatttgatcgaggtcgtacccgaatcaaataaacattaaaaatgcagtatctaggaagtgatcctaggtcatctcccaacgagcaatggtcaaccaatgttcataatagatagtgataaaacaataacgaattggggggggggggtatttgtttttgtaatttaaacaacaagcaaattttaattagaaaataacagaattaaaacatgttatttccccttgattcataagcaagtctcttatcctaggttaggaggatttatccctaaccagttcaaccacttaatccaaccctaaattaaattactaagcgaaaattaacataaggttgtctttatatgattaagcaacacatacaccaattaatcatgaacaaaatcgatcattaagcatcaacataaattaagcgcaaagataattaatcaagcactaagcatgcatggattagtagcaacaaatacagagtaattggtggagatgaaaaactgatcaatattcaatagtaataacaaaacctcaaagagagttgtgcttgattctcaagagaaaacaacgctggagacttagccttccattaatcagtagaaaacgaaattgtagaaaacgaattttattctatgtgaacaatgtgcatgaacagtaataaaaactggaattgcaaaaccctaaaattattcttctctccaaaaaaactccctaaactaaaaccctggtgctattatataggtcctcagccccaaagcttacaaatctattttcagtccaaacccataaacgaaataaaataaaatctggacaagataagataagattggatgaaataaaatctggacgaaataaaatctggataagataagatttgataaaataaaattgtctgctcttttcaagtccaagcccaattccggattcaagcccaattttttataattcttctgaaattaaattaaaaatacgaaattagtcaagtaggcccaaatgataaaactgcataattaatttgacaattaaggctaatcagtaattaaaatagtgacaaaaagggttaagaaataggagaataatgacacatcacccatatggggagcaattctaaaatgcatttgagttctttaacctgagacacagtgcagtagagtctccaaggattcattgtgccttttattttatatgatggggtcactacattggccttgtcaaagaaactgaatttgggggattaaagaaacacaaaataaaaacaaatgaaactagttaatagaaatgttgcctattgcttcttggaaaaagtccaaccatttgtgatttggataaaattcatattacccacttgtagcttgttcaatcaaacactagatttggataaaatctcactcctagatatacctcaagggataatatgaccaacattagtcatttttagaaagtaaagtggacaaatttgagatttcattccttaatgacattataaacatgtattttttccatgaccctttttcaatgtaagtacaatttatcccttagtttagatactctatatatgcatgttacgtagttgatgaaaacatacctaagttgttgtgtatggttaagtttgcgactacctctgatatcaaactcctcatctccaatctcatacaaaagatacttgtcacttggtacctgaaccttgtcagtttgcagttgtgagtttcttctgaagccacacgcttgtatagtaaccagaagccaggagggagtcctctaaggctctaactcgtattttccgtggaagtacattttttttcttaaagaaaacagagatagtttaccaatgataatatttctttagccaaataggaccatcatagaaaacaaaactcttcttctaagtatttaatgcaactacatatttagggtgcgtttgattcgctaaaaaataagggtctagacaacacaaaaatatttttccaacgtttgattttaaaaatggctgagagacaatacaaaataaagaatgatgaactggacaaaaacctaaaaacttgtaactcactgaatctcatacaactttttgttcagtgtctaaaaaaagtaaaaatacaatattattcctattttttactttgattatctcacaccttctttctactcatttgtttcacttcacctctccagtgggcaccttggtttgtcggcgagagtcgtatggacttttgttgtttcctttttgctcattatttctttcttttcattgttaatttattcaaatgttcccatcatcatcttactccttcttgttatgttttttttctttggccaactccaacgaggccgtgccgcgaccaccatcatcacgaccttatggcggcctcacgccgcaaggccctgcacccagtggcatcaggggtcatgcctccttcttaaaggtgtctctcttttgttatgtcgtcaaagtgttgctaattcacctagaatttttcaatgaatccctttacttgtgggttagtctaggtcgctctgcccggttccaaccctagcccaaaaaaaaatgaaatgggtaggaaaggcgggcctagtttgaattaaaataaatcatgctaagatattgataactgctatgtataggtatattttgggattaaattatataggaattagtaatttttctctcttatttcttcctttttgttcaaataattggaattctaacatcatttaagtttttatgtagaaaatattaaaagttgatgaatttatgatacttagtgaataattagagtagaaaaataaagtaaagcccaaaaaagaaaattggtgatatgaagatacatgcttagcatgccccaggcacgcttagtgtgtgtgtcaaacactgatagtttaaactgaaggcgggaaacgacaatctgatccccatcaagcttgatatcgaattcctgcagcccgggggatccactagttctagagcggccgcgttaactgcaggtcgacggatccccgggtaccgagctcgaattcaaatttattatgtgttttttttccgtggtcgagattgtgtattattctttagttattacaagacttttagctaaaatttgaaagaatttactttaagaaaatcttaacatctgagataatttcagcaatagattatatttttcattactctagcagtatttttgcagatcaatcgcaacatatatggttgttagaaaaaatgcactatatatatatatattattttttcaattaaaagtgcatgatatataatatatatatatatatatatgtgtgtgtgtatatggtcaaagaaattcttatacaaatatacacgaacacatatatttgacaaaatcaaagtattacactaaacaatgagttggtgcatggccaaaacaaatatgtagattaaaaattccagcctccaaaaaaaaatccaagtgttgtaaagcattatatatatatagtagatcccaaatttttgtacaattccacactgatcgaatttttaaagttgaatatctgacgtaggatttttttaatgtcttacctgaccatttactaataacattcatacgttttcatttgaaatatcctctataattatattgaatttggcacataataagaaacctaattggtgatttattttactagtaaatttctggtgatgggctttctactagaaagctctcggaaaatcttggaccaaatccatattccatgacttcgattgttaaccctattagttttcacaaacatactatcaatatcattgcaacggaaaaggtacaagtaaaacattcaatccgatagggaagtgatgtaggaggttgggaagacaggcccagaaagagatttatctgacttgttttgtgtatagttttcaatgttcataaaggaagatggagacttgagaagttttttttggactttgtttagctttgttgggcgtttttttttttgatcaataactttgttgggcttatgatttgtaatattttcgtggactctttagtttatttagacgtgctaactttgttgggcttatgacttgttgtaacatattgtaacagatgacttgatgtgcgactaatctttacacattaaacatagttctgttttttgaaagttcttattttcatttttatttgaatgttatatatttttctatatttataattctagtaaaaggcaaattttgcttttaaatgaaaaaaatatatattccacagtttcacctaatcttatgcatttagcagtacaaattcaaaaatttcccatttttattcatgaatcataccattatatattaactaaatccaaggtaaaaaaaaggtatgaaagctctatagtaagtaaaatataaattccccataaggaaagggccaagtccaccaggcaagtaaaatgagcaagcaccactccaccatcacacaatttcactcatagataacgataagattcatggaattatcttccacgtggcattattccagcggttcaagccgataagggtctcaacacctctccttaggcctttgtggccgttaccaagtaaaattaacctcacacatatccacactcaaaatccaacggtgtagatcctagtccacttgaatctcatgtatcctagaccctccgatcactccaaagcttgttctcattgttgttatcattatatatagatgaccaaagcactagaccaaacctcagtcacacaaagagtaaagaagaacaatggcttcctctatgctctcttccgctactatggttgcctctccggctcaggccactatggtcgctcctttcaacggacttaagtcctccgctgccttcccagccacccgcaaggctaacaacgacattacttccatcacaagcaacggcggaagagttaactgcatgcaggtgtggcctccgattggaaagaagaagtttgagactctctcttaccttcctgaccttaccgattccggtggtcgcgtcaactgcatgcaggccatggacaacaacccaaacatcaacgaatgcattccatacaactgcttgagtaacccagaagttgaagtacttggtggagaacgcattgaaaccggttacactcccatcgacatctccttgtccttgacacagtttctgctcagcgagttcgtgccaggtgctgggttcgttctcggactagttgacatcatctggggtatctttggtccatctcaatgggatgcattcctggtgcaaattgagcagttgatcaaccagaggatcgaagagttcgccaggaaccaggccatctctaggttggaaggattgagcaatctctaccaaatctatgcagagagcttcagagagtgggaagccgatcctactaacccagctctccgcgaggaaatgcgtattcaattcaacgacatgaacagcgccttgaccacagctatcccattgttcgcagtccagaactaccaagttcctctcttgtccgtgtacgttcaagcagctaatcttcacctcagcgtgcttcgagacgttagcgtgtttgggcaaaggtggggattcgatgctgcaaccatcaatagccgttacaacgaccttactaggctgattggaaactacaccgaccacgctgttcgttggtacaacactggcttggagcgtgtctggggtcctgattctagagattggattagatacaaccagttcaggagagaattgaccctcacagttttggacattgtgtctctcttcccgaactatgactccagaacctaccctatccgtacagtgtcccaacttaccagagaaatctatactaacccagttcttgagaacttcgacggtagcttccgtggttctgcccaaggtatcgaaggctccatcaggagcccacacttgatggacatcttgaacagcataactatctacaccgatgctcacagaggagagtattactggtctggacaccagatcatggcctctccagttggattcagcgggcccgagtttacctttcctctctatggaactatgggaaacgccgctccacaacaacgtatcgttgctcaactaggtcagggtgtctacagaaccttgtcttccaccttgtacagaagacccttcaatatcggtatcaacaaccagcaactttccgttcttgacggaacagagttcgcctatggaacctcttctaacttgccatccgctgtttacagaaagagcggaaccgttgattccttggacgaaatcccaccacagaacaacaatgtgccacccaggcaaggattctcccacaggttgagccacgtgtccatgttccgttccggattcagcaacagttccgtgagcatcatcagagctcctatgttctcttggatacatcgtagtgctgagttcaacaacatcatcgcatccgatagtattactcaaatccctgcagtgaagggaaactttctcttcaacggttctgtcatttcaggaccaggattcactggtggagacctcgttagactcaacagcagtggaaataacattcagaatagagggtatattgaagttccaattcacttcccatccacatctaccagatatagagttcgtgtgaggtatgcttctgtgacccctattcacctcaacgttaattggggtaattcatccatcttctccaatacagttccagctacagctacctccttggataatctccaatccagcgatttcggttactttgaaagtgccaatgcttttacatcttcactcggtaacatcgtgggtgttagaaactttagtgggactgcaggagtgattatcgacagattcgagttcattccagttactgcaacactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgcctcgacgagaagcgtgaactctccgagaaagttaaacacgccaagcgtctcagcgacgagaggaatctcttgcaagactccaacttcaaagacatcaacaggcagccagaacgtggttggggtggaagcaccgggatcaccatccaaggaggcgacgatgtgttcaaggagaactacgtcaccctctccggaactttcgacgagtgctaccctacctacttgtaccagaagatcgatgagtccaaactcaaagccttcaccaggtatcaacttagaggctacatcgaagacagccaagaccttgaaatctactcgatcaggtacaatgccaagcacgagaccgtgaatgtcccaggtactggttccctctggccactttctgcccaatctcccattgggaagtgtggagagcctaacagatgcgctccacaccttgagtggaatcctgacttggactgctcctgcagggatggcgagaagtgtgcccaccattctcatcacttctccttggacatcgatgtgggatgtactgacctgaatgaggacctcggagtctgggtcatcttcaagatcaagacccaagacggacacgcaagacttggcaaccttgagtttctcgaagagaaaccattggtcggtgaagctctcgctcgtgtgaagagagcagagaagaagtggagggacaaacgtgagaaactcgaatgggaaactaacatcgtttacaaggaggccaaagagtccgtggatgctttgttcgtgaactcccaatatgatcagttgcaagccgacaccaacatcgccatgatccacgccgcagacaaacgtgtgcacagcattcgtgaggcttacttgcctgagttgtccgtgatccctggtgtgaacgctgccatcttcgaggaacttgagggacgtatctttaccgcattctccttgtacgatgccagaaacgtcatcaagaacggtgacttcaacaatggcctcagctgctggaatgtgaaaggtcatgtggacgtggaggaacagaacaatcagcgttccgtcctggttgtgcctgagtgggaagctgaagtgtcccaagaggttagagtctgtccaggtagaggctacattctccgtgtgaccgcttacaaggagggatacggtgagggttgcgtgaccatccacgagatcgagaacaacaccgacgagcttaagttctccaactgcgtcgaggaagaaatctatcccaacaacaccgttacttgcaacgactacactgtgaatcaggaagagtacggaggtgcctacactagccgtaacagaggttacaacgaagctccttccgttcctgctgactatgcctccgtgtacgaggagaaatcctacacagatggcagacgtgagaacccttgcgagttcaacagaggttacagggactacacaccacttccagttggctatgttaccaaggagcttgagtactttcctgagaccgacaaagtgtggatcgagatcggtgaaaccgagggaaccttcatcgtggacagcgtggagcttctcttgatggaggaataatgagatcccgtcctttgtcttcaattttgagggctttttactgaataagtatgtagtactaaaatgtatgctgtaatagctcatagtgagcgaggaaagtatcgggctatttaactatgacttgagctccatctatgaataaataaatcagcatatgatgcttttgttttgtgtacttcaactgtctgcttagctaatttgatatggttggcacttggcacgtataaatatgctgaagtaatttactctgaagctaaattaactagattagatgagtgtattatatacaaaaggcattaaatcagatacatcttagacaaattgtcacggtctaccagaaaagaaattgcatttgtttttgggtctttcagactgacaagatcgatctgaagtctaaacaattctaagaggtatcatgtagcaatgtcctgccacaatattgaattgacctgcagcccgggcggccgcatcgatcgtgaagtttctcatctaagcccccatttggacgtgaatgtagacacgtcgaaataaagatttccgaattagaataatttgtttattgctttcgcctataaatacgacggatcgtaatttgtcgttttatcaaaatgtactttcattttataataacgctgcggacatctacatttttgaattgaaaaaaaattggtaattactctttctttttctccatattgaccatcatactcattgctgatccatgtagatttcccggacatgaagccatcaaaaagtaggactaatttaggaaagcaagctaattcaagaaagtgaaggcacgcttagtgtgagacacgtgttgagcgcgattactgccactcactaaccacacaagtgcactcagtgcgaaggttgcttaaaaattaagttgattcgcacttataaaagaaggatagagatgaaggaaaaaacacagaaaatacaattccttatagaagacaaaggctagaagaagcaaacgcaaacattagaagtcattccttccctcaattccctttttcaatttccccttttactaaatattctcctcttgcaattataaagcctcctatgacaatgacaagctaaactctcctttgttgggaacttatcagtcaactgctcttaatataatttctcttcctatctattatgaatattcactacaagaaatatgcccatttgccagggatttttgacagggacattaacccctggcaaatttcccagggactaagccaaggaaacccctggcaaaatgacatttgagaaggctgggaccacttacatttacacaggggtttgtccctcgcaaaaatacaaaagccttggcaaaaaaaagagcgggaaatgaattttaaaacagcatgttgttttcacacagccaaacacacgggtatgccctcgttttctgtaaagctgacggaatcttcccataagtcaacacgacatgaccatgcactgcaaaaagctgtgcggcccagacgtgacaggggtgttacccctcggaaatggcttgcagcccctggcaaaaaggaatccctgctttcctagctacaccgttctgctcatatagctgaagctaggaggttagcctttgactctgttgttttgcgaggggcattccgtgagttattccctgggtttttttacactatatagccaaaccgcgtgtttatcctcatgctcagtgttgtgtttttgaaacttagaaaaattttcggtttccatttccatcctcaccagttcattttcagtccattatcattcagttcatacacttgttctataatttggtaacactcttttcacttattatatttttctgtttttatttgttactacttattaacataaatattttttattgtatcagtgtccaaatttgcctcctcctgctgctccttgctctctgaatttgttctcttaagcttcaacaagttagtaatttttctacttataattttagatatatgatgtttatatatatgatgttataattttgcatgatctgtcaaagaaaatatgatgtttctacttgcatgatgtgttataatatatgatgtttatatatatttcgaattttgttgttaataaaactgtttaattagaaactgtataatttttttgtttaataaaactgtttaattttgcatgatctgtttaataaaactgtttatataaaactgtttatatataatatatgatgttaacatttttaaaactgtttataaaacagtttagttagaaaaaatgttaaaactagagaaaaaaatgtataataaaactgtgtcagtacagcagcgcgtcagaaaagtgtgcagatgcgtcagtgagaagacaggggctaagacagggattttgacagggaattttgccagggattttgccagggtcagcccctcgtttttttgccaggggtgaaatccctggcaaactgatttgcgatgggcgtttttcccagggattcagcccctggcaaaatccctggcaaacgtccatttcccagggctttttgttcttttcccagggaatccgcccctggcaaacgagcttgtttcttgtagtgattacttttgcattagtttttcctgtatttaattttattgtttatggcttgattacccatttgcattataagttttaggggtagcgttgaaaagtgttattctctaatagaactggaaaagagtatttaaataacttcatcactagggatacattgattttatttagcttattatatatctctattattaatgtaatttaactattttatctctgcaaagtgatttgggagagaagatagataagttagactctttcactcgaggctgagtacaaccttgagagagcccagaaggctgtgaacgccctctttacctccaccaatcagcttggcttgaaaactaacgttactgactatcacattgaccaagtgtccaacttggtcacctaccttagcgatgagttctgaaggg